(19) United States
(12) Patent Application Publication
(10) Pub. No.: US 2020/0187504 A1
(43) Pub. Date: Jun. 18, 2020

(54) ENVIRONMENTALLY FRIENDLY COMPOSITIONS FOR FOLIAR AND GRANULAR CONTROL OF WEEDS

(71) Applicant: Stuart Jennings, Bozeman, MT (US)

(72) Inventor: Stuart Jennings, Bozeman, MT (US)

(21) Appl. No.: 16/714,177

(22) Filed: Dec. 13, 2019

Related U.S. Application Data
(60) Provisional application No. 62/779,250, filed on Dec. 13, 2018.

(51) Int. Cl. A01N 59/14; C05C 11/00

(52) U.S. Cl. CPC A01N 59/14; C05C 11/00

(57) ABSTRACT

This present disclosure provides compositions of phytotoxic micronutrients and/or combinations of phytotoxic micronutrients and agricultural compositions and their use for selectively and effectively controlling invasive plants. Also, provided herewith is methods of controlling weeds in a plant community by applying granular and/or liquid formulations of said compositions and/or said combinations to soil and/or foliar portions of the plant.

### CROSS-REFERENCE TO RELATED APPLICATIONS

This application claims the benefit of U.S. provisional application No. 62/779,250 filed on Dec. 13, 2018, which is hereby incorporated by reference in its entirely for all purposes.

### FIELD OF THE DISCLOSURE

This disclosure relates to compositions, combinations, process, systems, and kits comprising a phytotoxic micronutrient and an agricultural composition, and their use for the control and eradication of invasive plant species (i.e., weeds) (e.g., dandelion, spotted knapweed, cheatgrass and others) in an environmentally friendly manner.

### BACKGROUND OF THE DISCLOSURE

Invasive weeds are a serious worldwide problem and about 5% of the world economy 01.4 trillion) is spent annually on control. A weed refers to a plant growing where it is not wanted. In some contexts, a weed is an unwanted plant competing with a wanted, cultivated plant (i.e., a plant being grown for its beneficial attributes). Invasive species generally means an alien species whose introduction does or is likely to cause economic or environmental harm or harm to human health (U.S. Executive Order 13112-1. Definitions; Beck et al. 2006. Invasive Species Defined in a Policy Context: Recommendations from the Federal Invasive Species Advisory Committee. Invasive Plant Science and Management 1(4):414-421).

The approach to weed control currently used is ineffective, expensive and causes excessive harm to the environment. The current global practice for weed control involves spraying chemical weed control formulations, including synthetic herbicides derived from petrochemicals, on the live, above ground tissue of growing plants to selectively disrupt the physiological processes of the plant.

Invasive species are adapted to nutrient-poor soils and out-compete desirable native vegetation once established. As the human population has swelled from 1 billion to more than 7 billion people over the past 200 years, no corner of the globe has been spared from land disturbances including grazing, mining, logging, fires, road building, urbanization, and crop production. In many cases, land disturbances are severe and native soils have become depleted of nutrients (i.e. disturbed) resulting in a net ecological shift away from soils in geochemical equilibrium with the occupying plant community toward invasive species dominated soils with low fertility.

Plant-soil equilibrium exists through recycling of soil nutrients by decay of above ground biomass. Disequilibrium occurs when the above ground biomass is removed (e.g. heavy grazing or fire) and return of nutrients to the soil greatly reduced. The net condition of global soil is one of declining health and mining of soil nutrients without replacement. Declining soil health, declining plant production and invasion by weeds are the result. Agrarian societies dependent on agriculture output are diminished and made less secure.

Thus, this is a long-felt need for controlling invasive plant species on disturbed lands in an environmentally friendly manner, the present disclosure provides environmentally friendly, cost-effective compositions and combinations comprising phytotoxic micronutrients as well as processes and systems for the controlling invasive species using the phytotoxic micronutrient compositions and combinations.

### SUMMARY OF THE DISCLOSURE

The present disclosure teaches a method for controlling at least one invasive plant growing in a perennial grass plant community. In some embodiments, the method comprises applying (i) a phytotoxic micronutrient and/or (ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant. In some embodiments, the phytotoxic micronutrient is selected from the group consisting of boron, copper, iron, chlorine, manganese, molybdenum and zinc. In some embodiments, wherein the phytotoxic micronutrient is absorbed systemically by the plant, thereby inducing systemic phytotoxicity in the plant. In some embodiments, the phytotoxic micronutrient comprises boron. In some embodiments, the phytotoxic micronutrient is applied at a rate of about 10 pounds to about 150 pounds of elemental boron per one acre. In some embodiments, the phytotoxic micronutrient is applied at a rate of about 20 pounds to about 100 pounds of elemental boron per one acre. In some embodiments, the boron in the phytotoxic micronutrient is phytotoxic to the at least one invasive plant species while maintaining or increasing the growth and vigor of the perennial grass.

In some embodiments, the at least one invasive species is listed in Tables 1 and 2. In some embodiments, the at least one invasive species is selected from the group consisting of cheatgrass, dandelion, Canadian thistle, kochia, knotweed, poison ivy and spotted knapweed. In some embodiments, said perennial grass plant community comprises bluebunch wheatgrass, Western wheatgrass, slender wheatgrass, Idaho fescue, sheep fescue, orchard grass, smooth brome, timothy or Kentucky bluegrass.

In some embodiments, the micronutrient in the agricultural composition is selected from boron, copper, zinc, iron, manganese, molybdenum, or chlorine. In some embodiments, the macronutrient in the agricultural composition is selected from nitrogen, phosphorous, or potassium. In some embodiments, the biological compound and related carbon-based organic compound in the agricultural composition is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal. In some embodiments, the inorganic compound in the agricultural composition is selected from lime, silica, aluminosilicate, gypsum, or sulfur compound. In some embodiments, the inorganic compound in the agricultural composition is selected from calcium carbonate, calcium magnesium carbonate, calcium oxide, calcium hydroxide, cementitious waste product, or calcium sulfate. In some embodiments, the agricultural composition further comprises an organic fertilizer or an inorganic fertilizer. In some embodiments, the organic fertilizer or the inorganic fertilizer comprises calcium, magnesium, sulfur, carbon, hydrogen or oxygen elements. In some embodiments, the agricultural composition further comprises an adjuvant. In some embodiments, the adjuvant is selected from a wetting agent, an activator, a crop oil concentrate, a buffer, a marker dye or a surfactant.

In some embodiments, the phytotoxic micronutrient and the agricultural composition is in a dry formulation. In some embodiments, the phytotoxic micronutrient and the agricultural composition is in a liquid formulation. In some embodiments, the phytotoxic micronutrient is in a dry formulation and the agricultural composition is in a liquid formulation. In some embodiments, the phytotoxic micronutrient is in a liquid formulation and the agricultural composition is in a dry formulation. In some embodiments, the phytotoxic micronutrient and the agricultural composition are applied simultaneously or sequentially. In some embodiments, applying the phytotoxic micronutrient and the agricultural composition provides a synergistic effect in controlling the growth of at least one invasive plant, compared to when the phototoxic micronutrient or the agricultural composition is applied alone.

The present disclosure also teaches a method for controlling at least one invasive plant growth in a perennial grass plant community. In some embodiments, the method comprises applying a composition comprising: (i) a phytotoxic micronutrient and (ii) a macronutrient. In some embodiments, the phytotoxic micronutrient is selected from the group consisting of boron, copper, iron, chlorine, manganese, molybdenum and zinc. In some embodiments, the phytotoxic micronutrient is absorbed systemically by the plant, thereby inducing systemic phytotoxicity in the plant. In some embodiments, the composition further comprises one or more ingredients selected from: an agricultural composition comprising one or more ingredients selected from a) a micronutrient; b) a biological compound or a related carbon-based organic compound; c) an inorganic compound; or d) a seed, a seed coating, or a seed inoculant. In some embodiments, the phytotoxic micronutrient comprises boron. In some embodiments, the phytotoxic micronutrient is applied at a rate of about 10 pounds to about 150 pounds of elemental boron per one acre. In some embodiments, the phytotoxic micronutrient is applied at a rate of about 20 pounds to about 100 pounds of elemental boron per one acre. In some embodiments, the boron in the phytotoxic micronutrient is phytotoxic to the at least one invasive plant species while maintaining or increasing the growth and vigor of the perennial grass.

The present disclosure provides a method for inducing phytotoxicity in a plant. In some embodiments, the method comprises applying boron in a liquid formulation to foliar portions of the plant. In some embodiments, the liquid formulation comprises about 14.0 g of boron per liter to about 20.0 g of boron per liter, wherein the liquid formulation is absorbed systemically by the plant, thereby inducing systemic phytotoxicity in the plant. In some embodiments, the liquid formulation is applied at a rate of about 10 pounds to about 150 pounds of elemental boron per one acre. In some embodiments, the plant is listed in Tables 1 and 2. In some embodiments, the plant is selected from the group consisting of cheatgrass, dandelion, Canadian thistle, kochia, knotweed, poison ivy and spotted knapweed. In some embodiments, the plant is selected from the group consisting of bluebunch wheatgrass, Western wheatgrass, slender wheatgrass, Idaho fescue, sheep fescue, orchard grass, smooth brome, timothy or Kentucky bluegrass.

The present disclosure teaches a method for inducing non-selective phytotoxicity (NSP) in a plant. In some embodiments, the method comprises applying a phytotoxic micronutrient to the plant. In some embodiments, the phytotoxic micronutrient comprises boron. In some embodiments, the phytotoxic micronutrient is applied at a rate of about 100 pounds to about 200 pounds of elemental boron per one acre. In some embodiments, the phytotoxic micronutrient is absorbed systemically by the plant, thereby resulting in non-selective phytotoxicity in the plant. In some embodiments, the phytotoxic micronutrient is applied at a rate of about 100 pounds to about 160 pounds of elemental boron per one acre. In some embodiments, the phytotoxic micronutrient in a dry formulation. In some embodiments, the phytotoxic micronutrient in a liquid formulation.

In some embodiments, a composition comprises a phytotoxic micronutrient and an agricultural composition. In some embodiments, the agricultural composition comprises one or more ingredients selected from: a) a micronutrient; b) a macronutrient; c) an adjuvant; d) a biological compound or a related carbon-based organic compound; e) an inorganic compound; or f) a seed, a seed coating, or a seed inoculant. In some embodiments, the phytotoxic micronutrient comprises boron or a copper. In some embodiments, the phytotoxic micronutrient comprises boron. In some embodiments, the phytotoxic micronutrient comprises boron in about 25% to about 90% by weight of the composition. In some embodiments, the micronutrient in the agricultural composition is selected from boron, copper, zinc, iron, manganese, molybdenum, or chlorine. In some embodiments, the macronutrient in the agricultural composition is selected from nitrogen, phosphorous, or potassium. In some embodiments, the composition is in a dry formulation or in a liquid formulation.

### BRIEF DESCRIPTION OF THE DRAWING

FIG. 1A illustrates the phytotoxic effect of liquid B1300 formulation on dandelion and granular B fertilizer on clover at a rate of 50 lbs B/acre. The upper panels show dandelion (left) and clover (right) in a turf field prior to the treatment application, while the lower panels show dandelions (left) and clovers (right) after the treatment application. FIGS. 1B and 1C illustrates the phytotoxic effect of liquid B1300 formulation on knotweeds (FIG. 1B) and Canadian thistles (FIG. 1C) in perennial grasses after the liquid B1300 application.

FIGS. 2A-2B illustrate the phytotoxic effect of liquid B1440 formulation on Canadian thistles. The left panel shows the Canadian thistles at day 1 prior to a liquid B1440 application (FIG. 2A), while the right panel shows the senescent/dried Canadian thistles at day 12 after the liquid B1440 application (FIG. 2B). FIG. 2C illustrate the close-up view of the untreated (left) and treated (right) Canadian thistles in FIGS. 2A-2B. FIG. 2D illustrates a close-up view of the Canadian thistle after the B1440 treatment.

FIG. 3 illustrates comparison between varying rates of foliar/liquid B1300 application over 10-month period after treatment. FIG. 3 summarizes the results from FIG. 14A-14D to FIG. 17A-17D. Label: B1300-47 pounds B/acre corresponds to plot no. 7 in Table 4 (FIGS. 14A-14D); B1300-62 pounds B/acre corresponds to plot no. 8 (FIGS. 15A-15D); B1300-75 pounds B/acre corresponds to plot no. 9 in Table 4 (FIGS. 16A-16D); B1300-93 pounds B/acre corresponds to plot no. 11 in Table 4 (FIGS. 17A-17D); and control corresponds to plot no. 24 in Table 4 (FIGS. 25A-25D).

FIG. 4A illustrates aspen root suckers showing sprouts (suckers) above (untreated) and treated (below). Black tissue on treated stem below was caused by B1300. The liquid application was applied on the leaf tissue and with sufficient excess to cause soil infiltration.

FIG. 4B illustrates Canadian thistle phytotoxicity caused by micronutrient foliar application with B1300. No damage to adjacent pasture grasses resulted from overspray. This particular plant did not regrow in the following season suggesting translocation of solution into the roots.

FIG. 4C illustrates Birdsfoot trefoil phytotoxicity caused by micronutrient foliar application with B1300 (left half of plant) along a gravel foot path.

FIG. 4D illustrates spotted knapweed rosette sprayed with B1300 foliar micronutrient spray early in the growing season with sufficient excess to cause soil infiltration.

FIG. 4E illustrates white clover sprayed with foliar micronutrient solution B1300.

FIG. 4F illustrates houndstongue sprayed with foliar micronutrient solution B1300 with sufficient excess to cause to soil infiltration and root uptake.

FIG. 4G illustrates prostrate knotweed (polygonum sp) growing as an invasive species in a driveway slab and sprayed with B1300 foliar micronutrient spray.

FIG. 411 illustrates cheatgrass (Bromus tectorum) treated with foliar micronutrient spray B1300 (left) and untreated (right).

FIG. 41 illustrates poison ivy sprayed with foliar B1300 micronutrient solution. No damage to adjacent pasture grasses resulted from overspray.

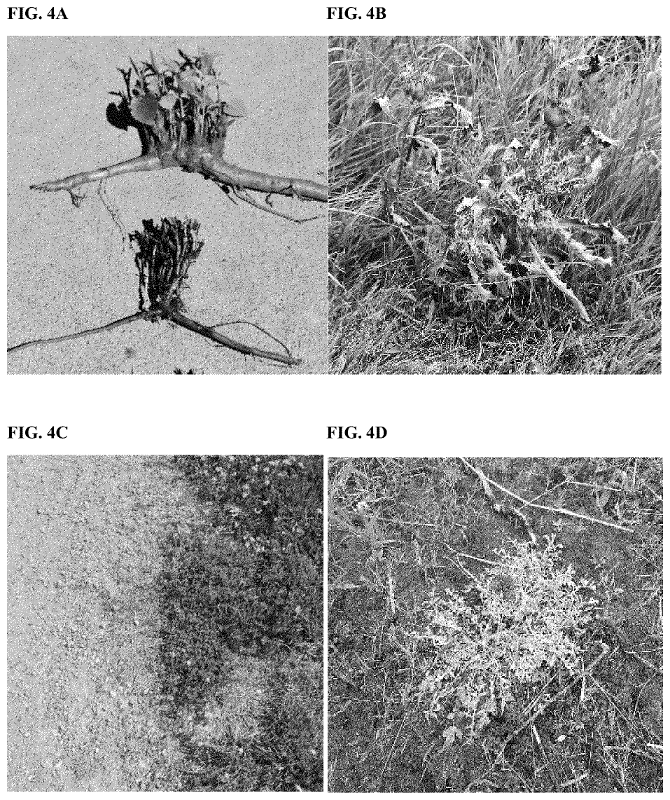

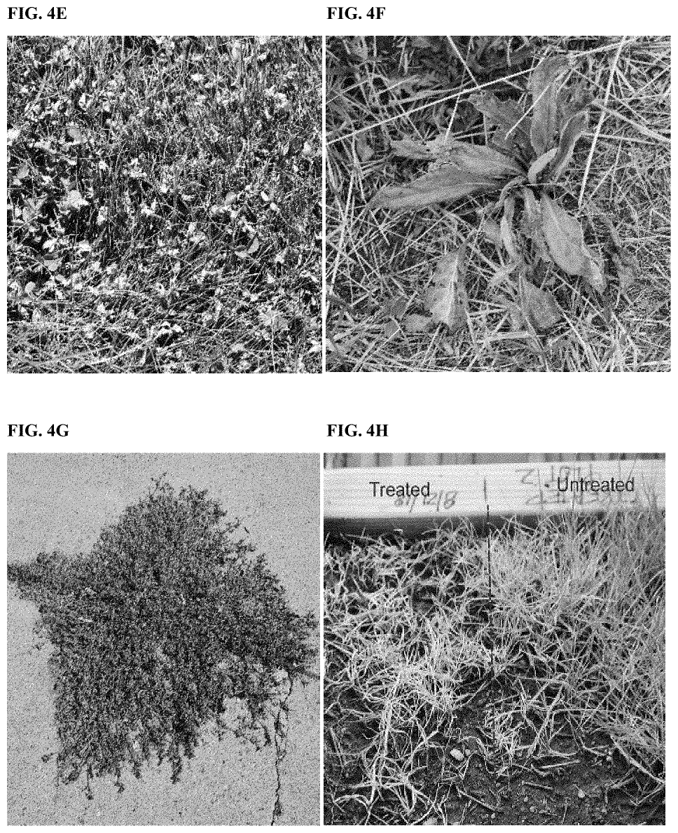

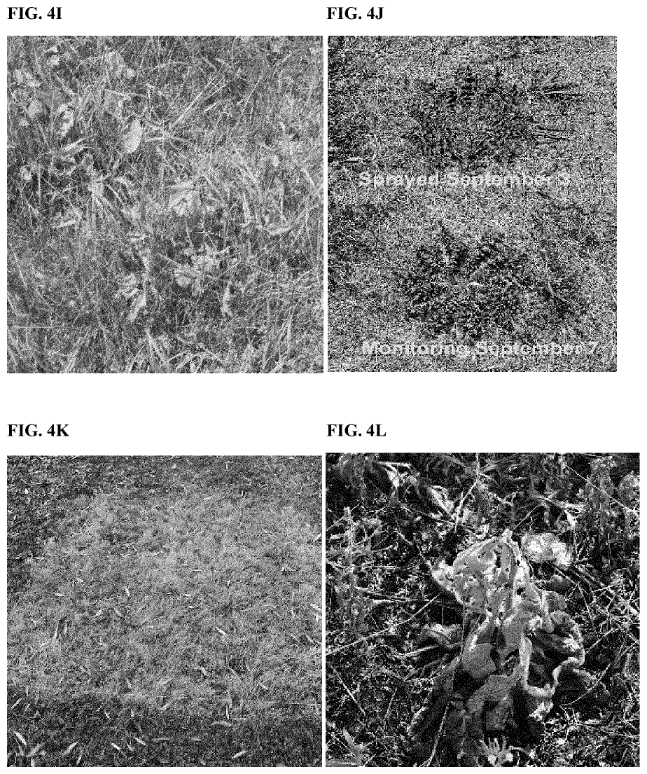

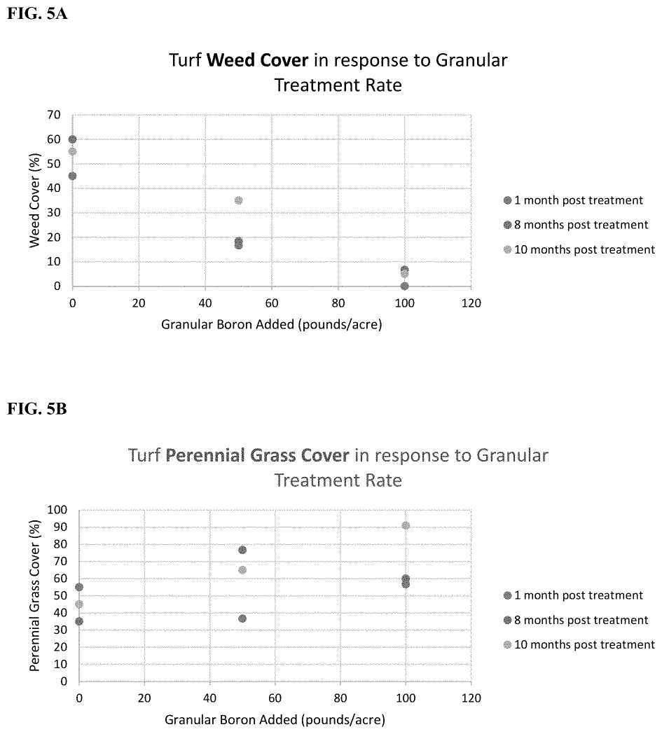

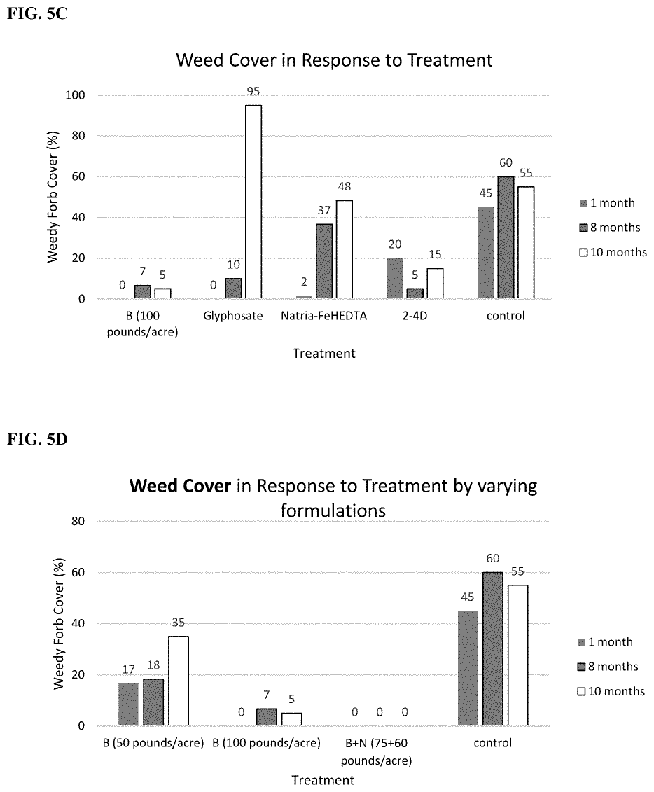

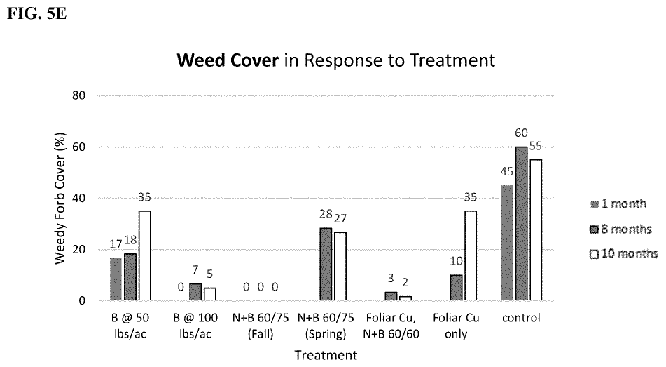

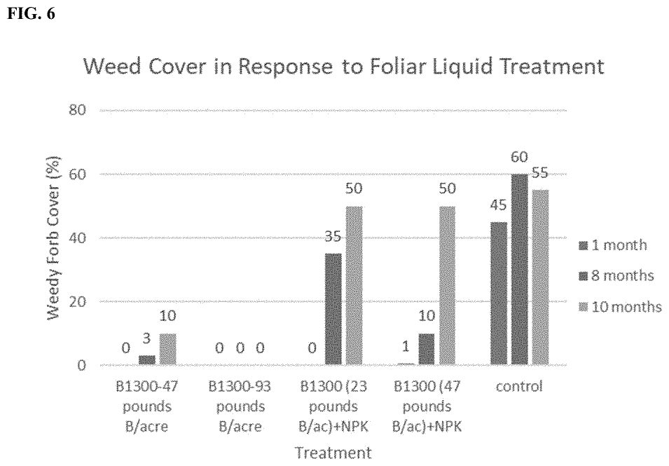

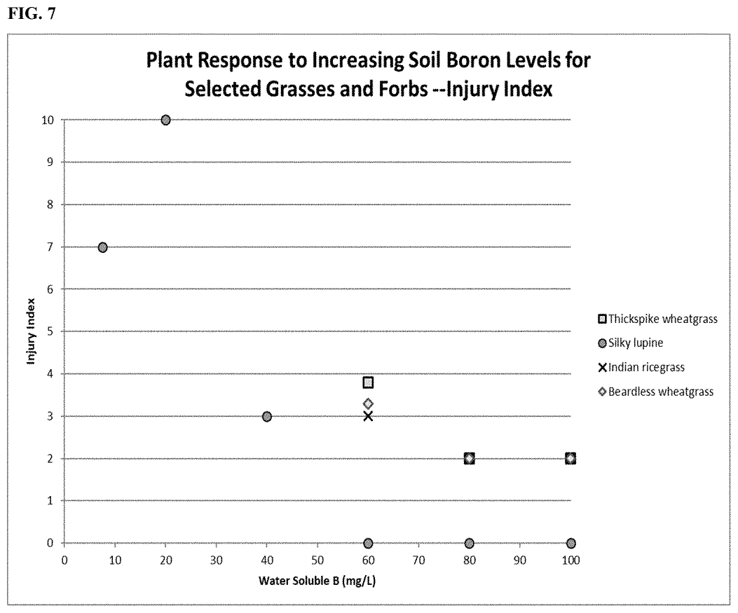

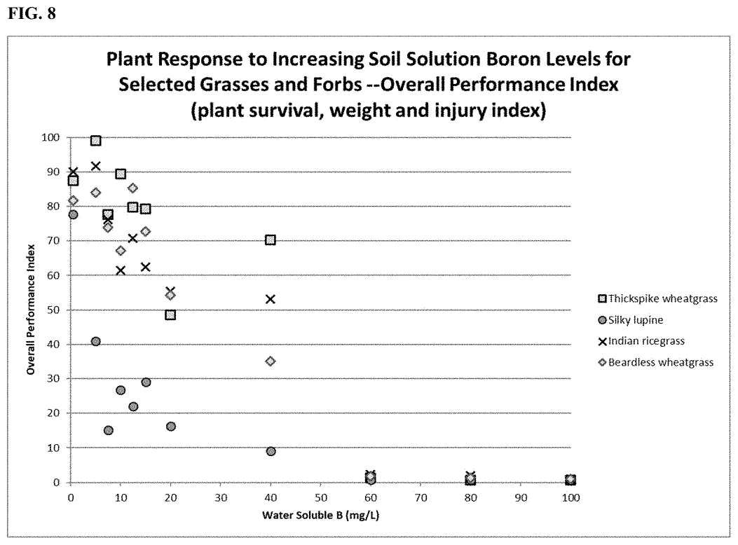

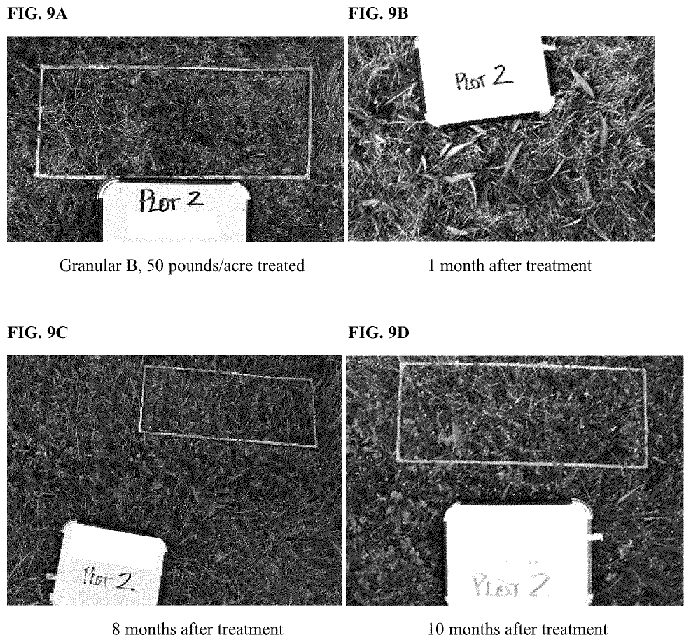

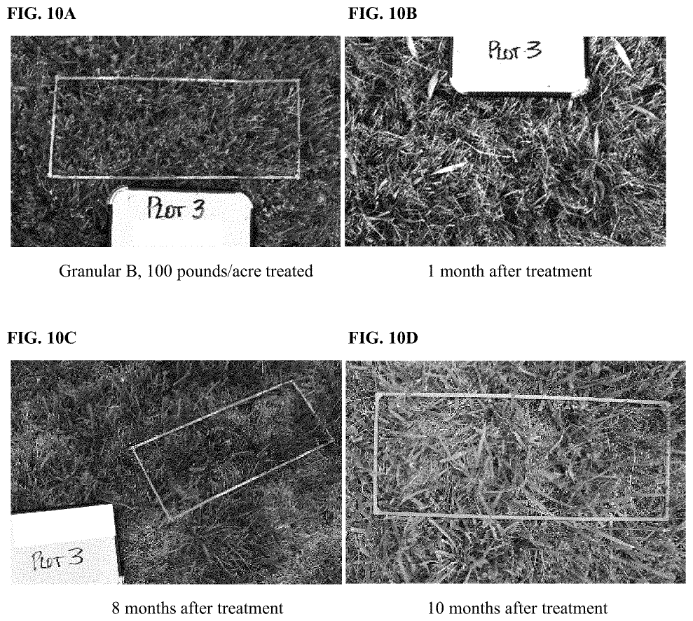

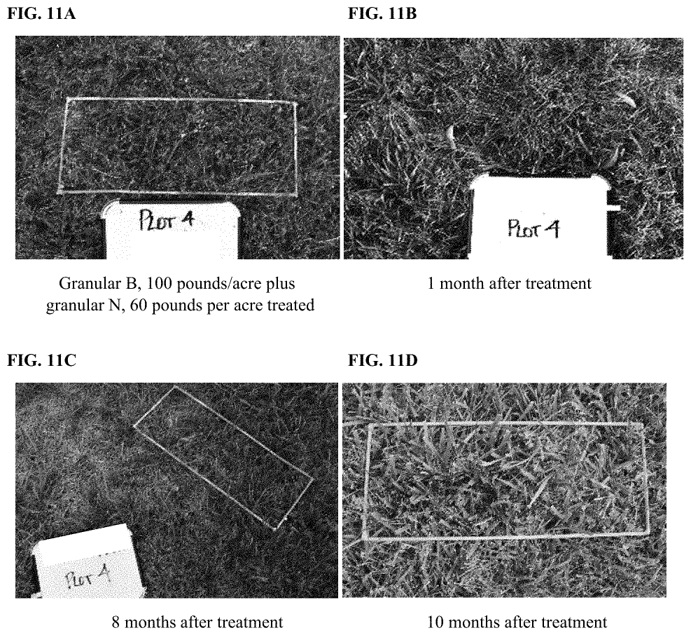

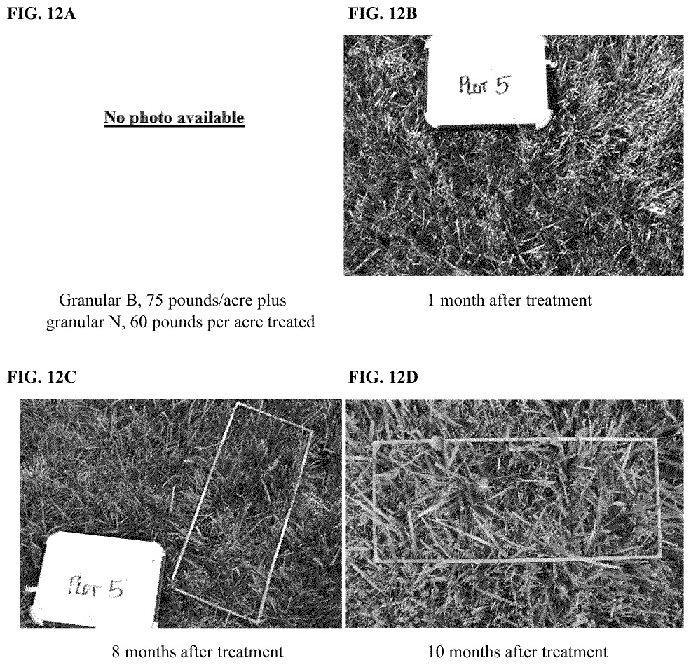

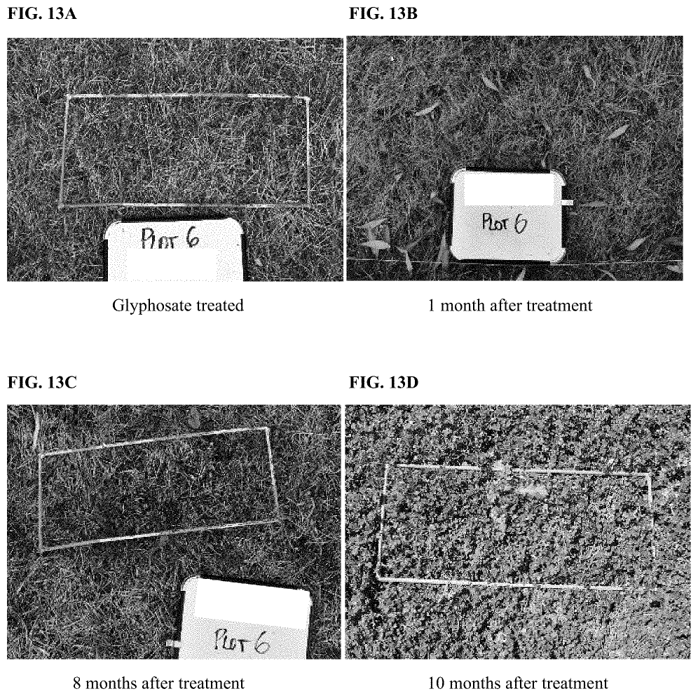

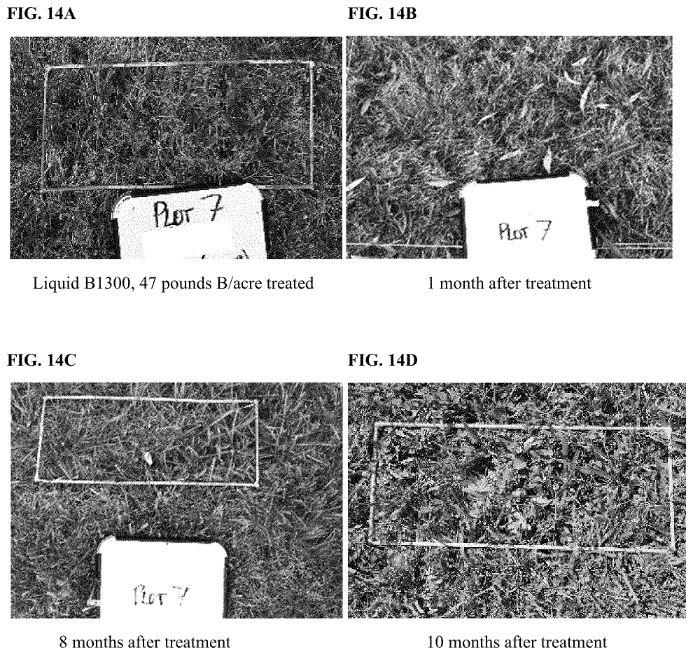

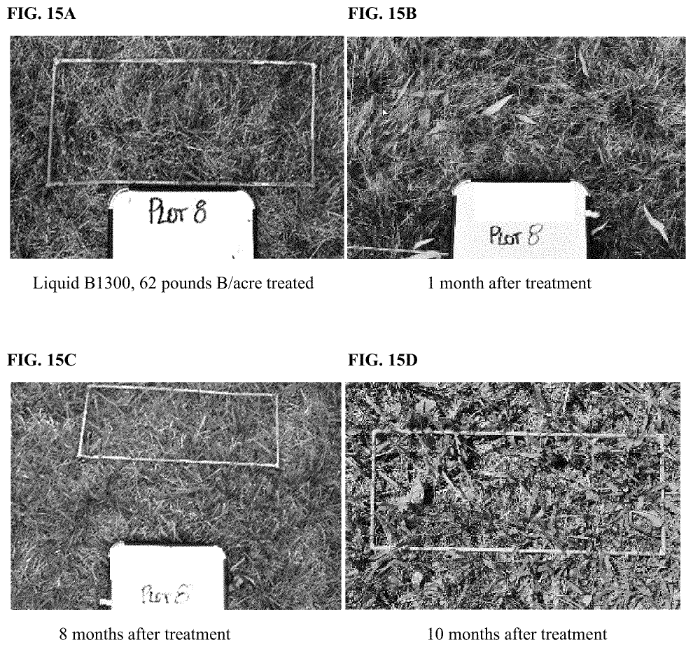

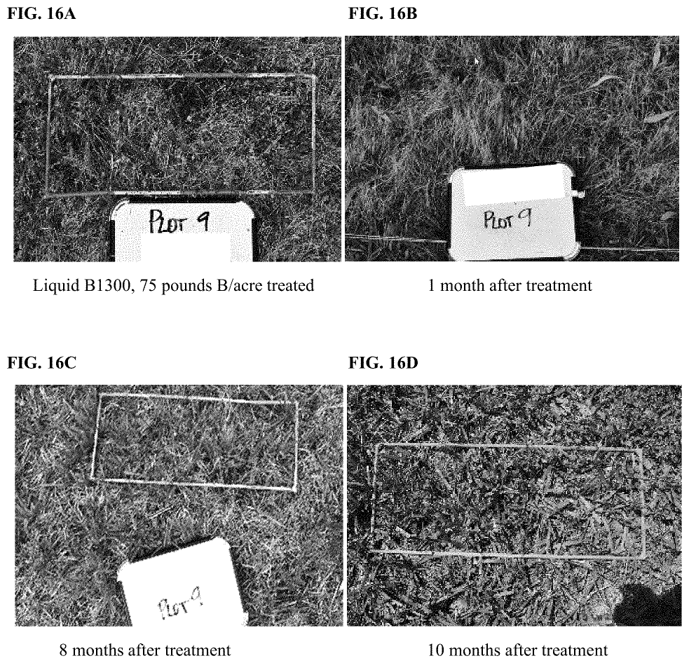

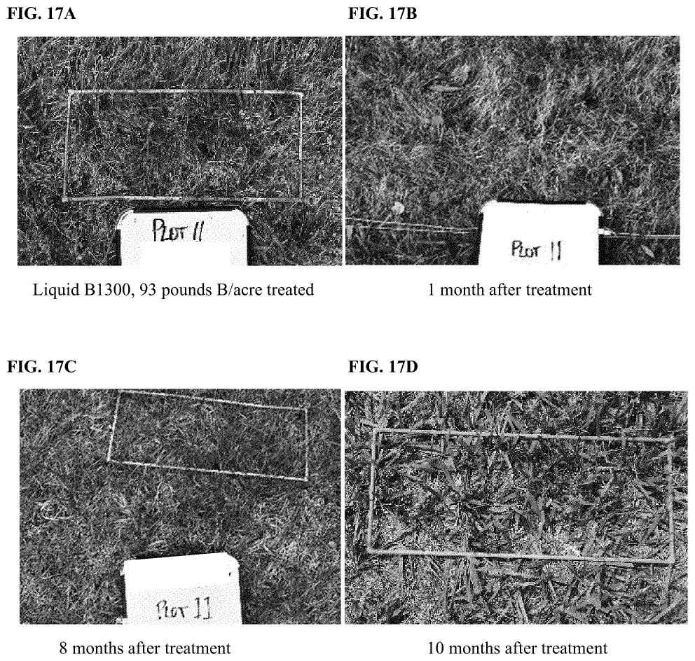

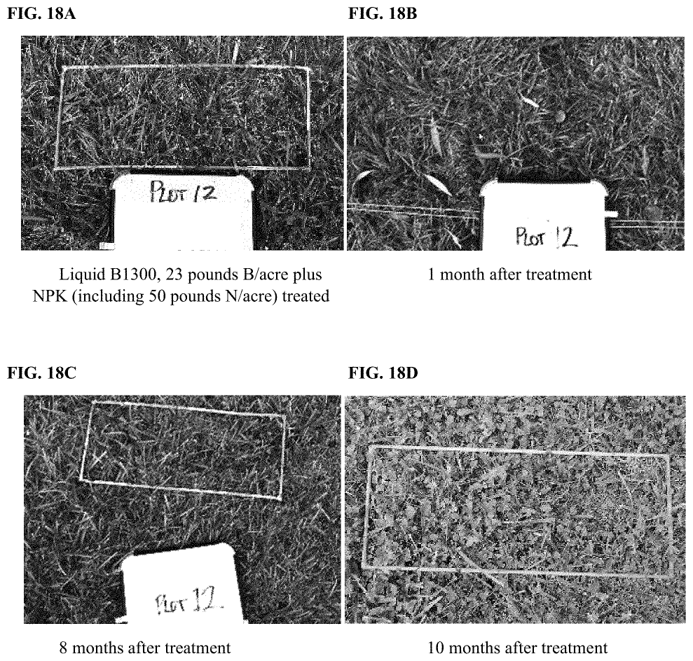

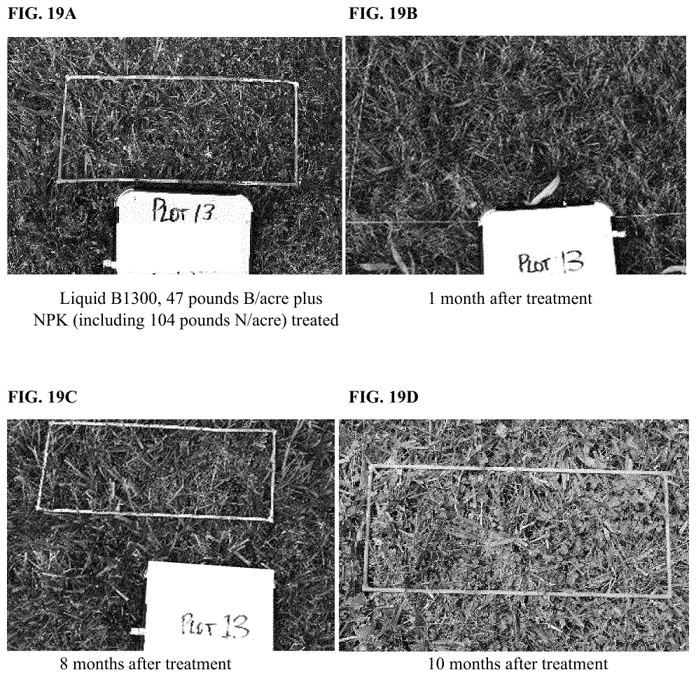

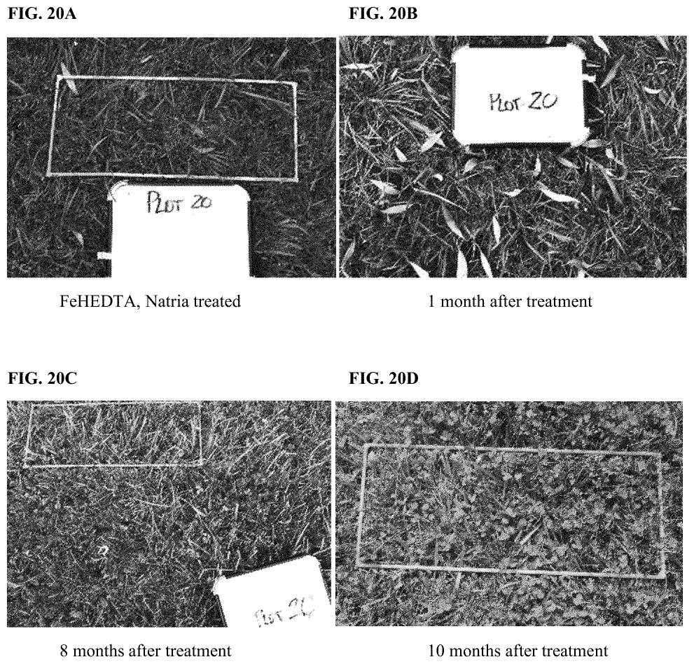

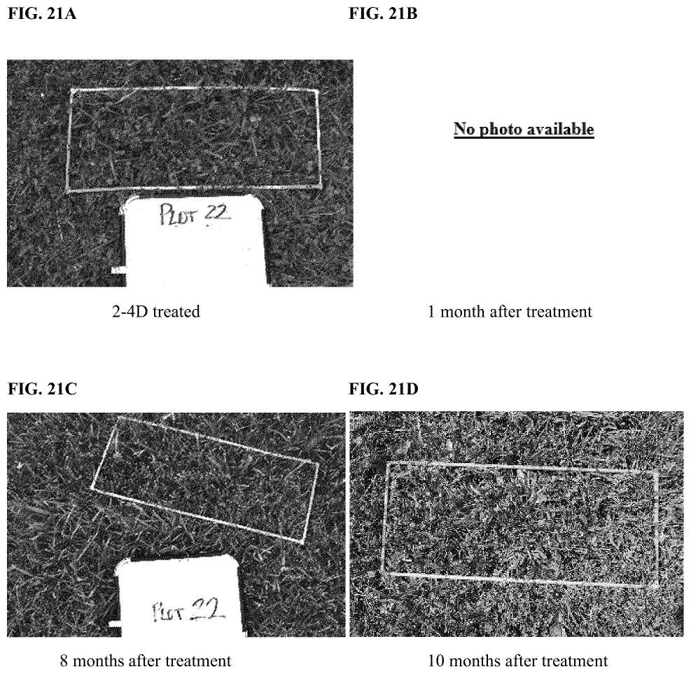

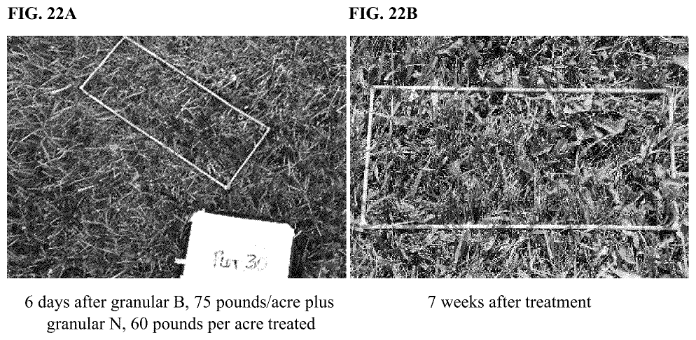

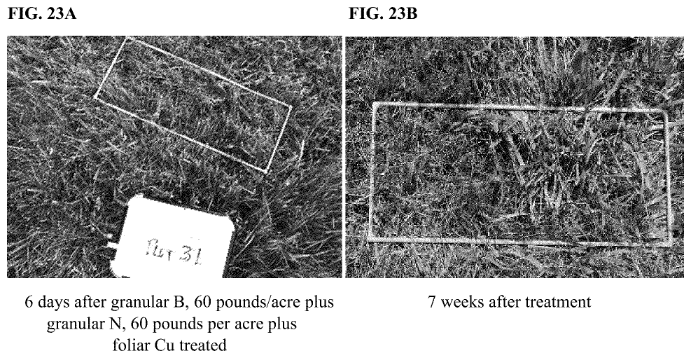

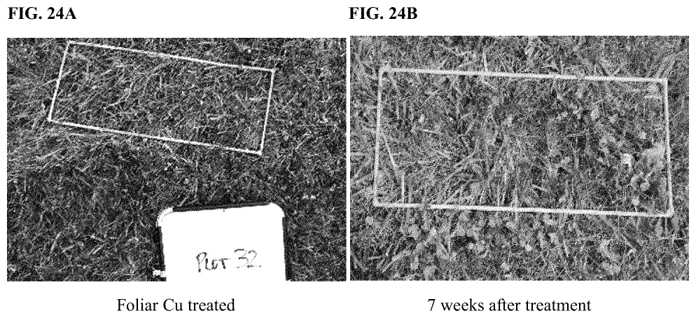

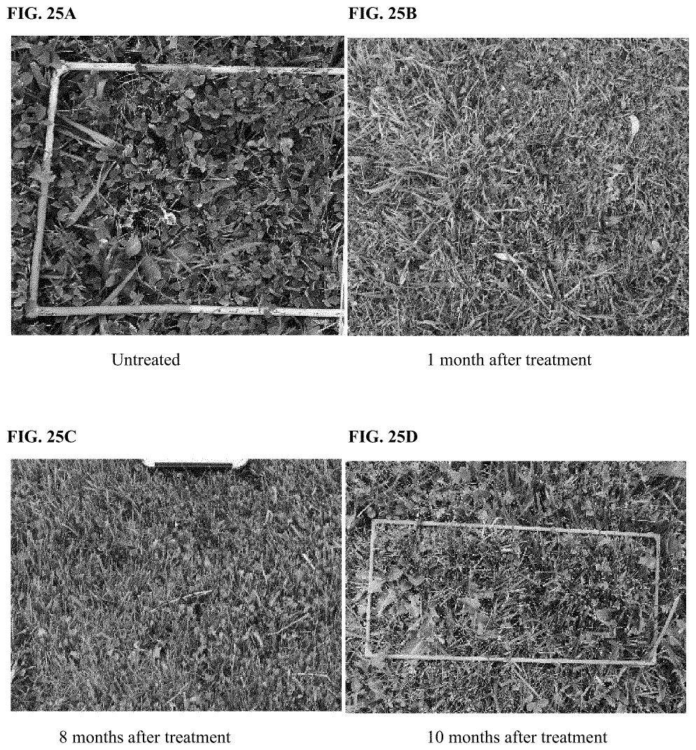

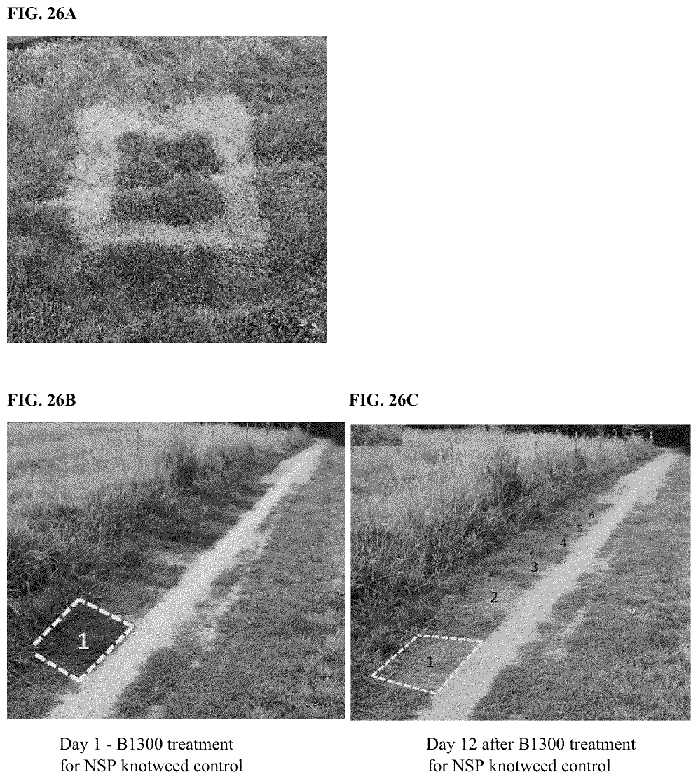

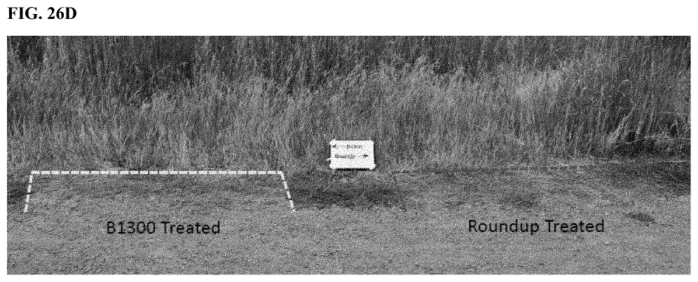

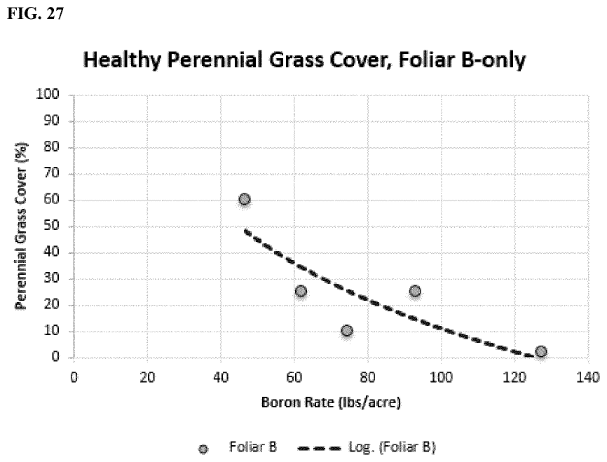

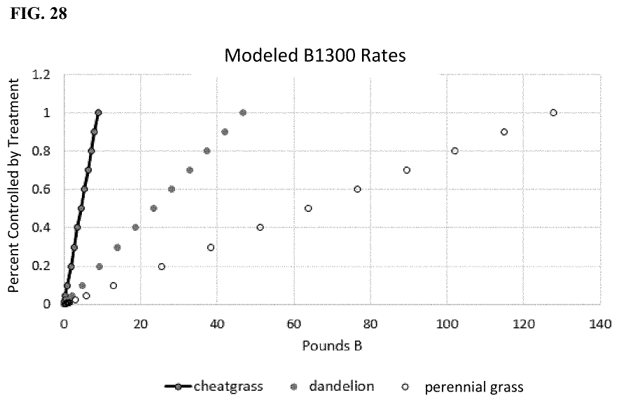

FIG. 4J illustrates biennial bull thistle rosette sprayed with B1300 foliar micronutrient solution. No damage to adjacent pasture grasses resulted from overspray.

FIG. 4K illustrates non-selective phytotoxicity (NSP) response to all species in treated plot with high B1300 foliar micronutrient solution application rate.

FIG. 4L illustrates common mullein treated with B1300 foliar micronutrient spray with soil infiltration.

FIG. 5A illustrates results of dry granular boron fertilizer application in controlling broadleaf weeds in turf grass.

FIG. 5B illustrates results of dry granular boron fertilizer application in maintaining or improving the growth of perennial grasses.

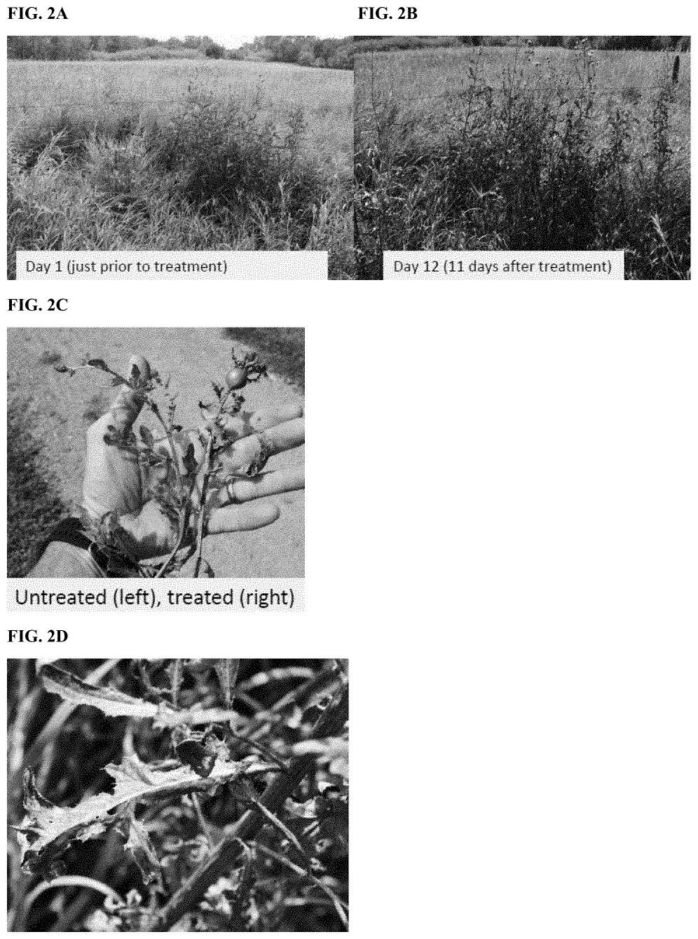

FIG. 5C illustrates comparison of application of dry granular boron (100 pounds B/acre; plot no. 3 corresponding to FIGS. 10A-10D) to glyphosate (plot no. 21), FeHEDTA (plot no. 20 corresponding to FIGS. 20A-20D), 2-4 D (plot no. 22 corresponding to FIGS. 21A-21D) and an untreated control (plot no. 24 corresponding to FIGS. 25A-25D).

FIG. 5D illustrates comparison of Boron and Nitrogen fertilizer addition compared to Boron alone. Label: B(50 pounds/acre) corresponds to plot no. 2 in Table 4 (FIGS. 9A-9D); B(100 pounds/acre) corresponds to plot no. 3 in Table 4 (FIGS. 10A-10D); B+N (75+60 pounds/acre) corresponds to plot no. 5 in Table 4 (FIGS. 12A-12D); and control corresponds to plot no. 24 in Table 4 (FIGS. 25A-25D).

FIG. 5E illustrates comparison between spring and fall B+N applications and effect of foliar Cu. Label: B @ 50 lbs/ac) corresponds to plot no. 2 in Table 4 (FIGS. 9A-9D); B @ 100 lbs/ac corresponds to plot no. 3 in Table 4 (FIGS. 10A-10D); B+N 75/60 (Fall) corresponds to plot no. 5 in Table 4 (FIGS. 12A-12D); B+N 75/60 (Spring) corresponds to plot no. 30 in Table 4 (FIGS. 22A-22B); Foliar Cu, B+N 60/60 corresponds to plot no. 31 in Table 4 (FIGS. 24A-24B); Foliar Cu only corresponds to plot no. 32 in Table 4 (FIGS. 24A-24B); and control corresponds to plot no. 24 in Table 4 (FIGS. 25A-25D).

FIG. 6 illustrates comparison between weed cover in plots treated with foliar liquid containing B alone and in plots with B plus NPK. Label: B1300-47 pounds B/acre corresponds to plot no. 7 in Table 4 (FIGS. 14A-14D); B1300-93 pounds B/acre corresponds to plot no. 11 in Table 4 (FIGS. 17A-17D); B1300 (23 pounds B/ac)+NPK corresponds to plot no. 12 in Table 4 (FIGS. 18A-18D); B1300 (47 pounds B/ac)+NPK corresponds to plot no. 13 in Table 4 (FIGS. 19A-19D); and control corresponds to plot no. 24 in Table 4 (FIGS. 25A-25D).

FIG. 7 illustrates response of grasses and forbs to increasing solution boron concentrations and resulting plant injury observed. (Data obtained from Munshower et al. 2006)

FIG. 8 illustrates response of grasses and forbs to increasing solution boron concentrations and overall performance index. (Data obtained from Munshower et al. 2006)

FIGS. 9A-9D illustrate a research site (plot no. 2 in Table 4) over a 10-month study period in response to an application rate of 50 pounds/acre of granular boron. FIG. 9A—Granular B, 50 pounds/acre treated. FIG. 9B—1 month after the treatment. FIG. 9C—8 months after the treatment.

FIG. 9D—10 months after the treatment. This application rate of B (50 lbs/acre) shows an adequate weed control.

FIGS. 10A-10D illustrate a research site (plot no. 3 in Table 4) over a 10-month study period in response to an application rate of 100 pounds/acre of granular boron. FIG. 10A—Granular B, 100 pounds/acre treated. FIG. 10B—1 month after the treatment. FIG. 10C—8 months after the treatment. FIG. 10D—10 months after the treatment. This plot shows exceptional control of invasive plant species but also lots of turf stress. Kentucky bluegrass (important turf species) was highly stressed after treatment and essentially nearly all dead 8 months later. However, the wide-blade grass smooth brome (a common pasture grass) was unaffected and became dominant 10 months later. Bare patches of Kentucky bluegrass can be seen in FIG. 10C. Not all perennial grasses are equally tolerant of applied boron. At the high 100 pound/acre B application rate only the most tolerant perennial grass survives.

FIGS. 11A-11D illustrate a research site (plot no. 4 in Table 4) over a 10-month study period in response to an application rate of 100 pounds/acre of granular boron plus 60 pounds per acre of granular nitrogen. FIG. 11A—Granular B, 100 pounds/acre plus granular N, 60 pounds per acre treated. FIG. 11B—1 month after the treatment. FIG. 11C—8 months after the treatment. FIG. 11D—10 months after the treatment. This plot shows the highly effective control of invasive weeds by the 100 pound/acre B rate similar to plot no. 3, however it shows the effect of ameliorating turf stress by including granular N in the formulation.

FIGS. 12A-12D illustrate a research site (plot no. 5 in Table 4) over a 10-month study period in response to an application rate of 75 pounds/acre of granular boron plus 60 pounds per acre of granular nitrogen. FIG. 12A (Image not available)—Granular B, 75 pounds/acre plus granular N, 60 pounds per acre treated. FIG. 12B—1 month after the treatment. FIG. 12C—8 months after the treatment. FIG. 12D—10 months after the treatment. This plot shows the highly effective control of invasive weeds and concurrently limited stress on perennial turf grasses including both Kentucky bluegrass and smooth brome. This B+N plot was the best granular plot implemented among other plots.

FIGS. 13A-13D illustrate a research site (plot no. 6 in Table 4) over a 10-month study period in response to glyphosate (a.k.a Roundup®). FIG. 13A—Glyphosate treated. FIG. 13B—1 month after the treatment. FIG. 13C—8 months after the treatment. FIG. 13D—10 months after the treatment. This plot was included to show the effectiveness of the commercial herbicide Roundup® as a control. The non-selective herbicide killed both grasses and forbs in Fall and its effect lasted until 1 month after treatment. After the winter, very little plant growth was observed in next Spring (8 months after the treatment), however the plot was dominated by weeds by mid-summer (10 months after the treatment) and has no perennial grasses. This is worse than the untreated control that has around 50% weeds and 50% grass. It underscores the short-term efficacy of Roundup in controlling invasive plants yet long-term ineffectiveness due to invasive plant germination from the soil seedbank. Roundup only works on the actively growing leaf tissue.

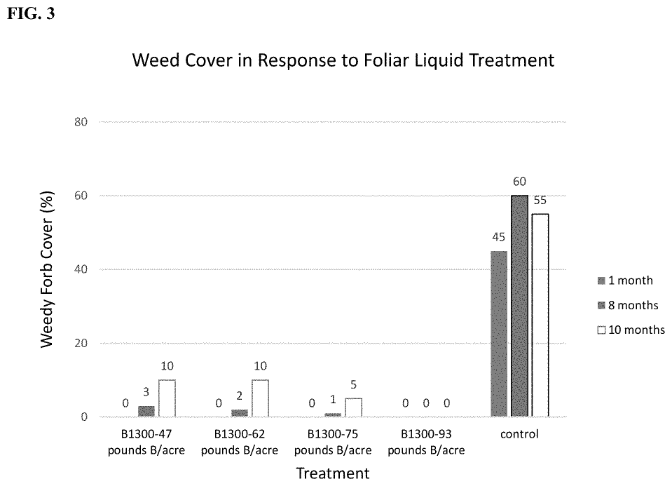

FIGS. 14A-14D illustrate a research site (plot no. 7 in Table 4) over a 10-month study period in response to an application rate of 47 pounds B/acre of liquid B1300. FIG. 14A—Liquid B1300, 47 pounds B/acre treated. FIG. 14B—1 month after the treatment. FIG. 14C—8 months after the treatment. FIG. 14D—10 months after the treatment. This plot was tested for weed control effect by liquid B1300 application. Increasing rates of liquid B application from FIG. 14A-14D to FIG. 17A-17D are similar to trends of granular boron application, which increases stress on perennial grasses (especially Kentucky bluegrass) that are observed across this range. FIG. 3 summarizes the results from FIG. 14A-14D to FIG. 17A-17D.

FIGS. 15A-15D illustrate a research site (plot no. 8) over a 10-month study period in response to an application rate of 62 pounds/acre of liquid B1300 boron. FIG. 15A—Liquid B1300, 62 pounds B/acre treated. FIG. 15B—1 month after the treatment. FIG. 15C—8 months after the treatment. FIG. 15D—10 months after the treatment.

FIGS. 16A-16D illustrate a research site (plot no. 9 in Table 4) over a 10-month study period in response to an application rate of 75 pounds B/acre of liquid B1300. FIG. 16A—Liquid B1300, 75 pounds B/acre treated. FIG. 16B—1 month after the treatment. FIG. 16C—8 months after the treatment. FIG. 16D—10 months after the treatment.

FIGS. 17A-17D illustrate a research site (plot no. 11 in Table 4) over a 10-month study period in response to an application rate of 93 pounds B/acre of liquid B1300. FIG. 17A—Liquid B1300, 93 pounds B/acre treated. FIG. 17B—1 month after the treatment. FIG. 17C—8 months after the treatment. FIG. 17D—10 months after the treatment. The turf stress at this highest foliar rate led to removal of the fine blade turf grass Kentucky bluegrass and persistence of the wide blade grass smooth brome. This series of increasing rates of liquid B from FIG. 14A-14D to FIG. 17A-17D corroborates the same effects observed with increasing granular rates.

FIGS. 18A-18D illustrate a research site (plot no. 12 in Table 4) over a 10-month study period in response to an application rate of 23 pounds B/acre of liquid B1300 boron plus water soluble NPK (including 50 pounds N/acre dissolved in solution). FIG. 18A—Liquid B1300, 23 pounds B/acre plus NPK, 50 pounds N/acre. FIG. 18B—1 month after the treatment. FIG. 18C—8 months after the treatment. FIG. 18D—10 months after the treatment. This combination application is excellent at invasive weed control for a short term with limited or no turf stress. However it does not have the long-lasting effect of weed control as shown by granular N and N plus B (N+B) treatments.

FIGS. 19A-19D illustrate a research site (plot no. 13 in Table 4) over a 10-month study period in response to an application rate of 47 pounds B/acre of liquid B1300 plus water soluble NPK (including 104 pounds N/acre). FIG. 19A—Liquid B1300, 47 pounds B/acre plus NPK, 104 pounds N/acre. FIG. 19B—1 month after the treatment. FIG. 19C—8 months after the treatment.

FIG. 19D—10 months after the treatment. Similar to FIG. 18A-18D (plot no. 12 in Table 4), this combination application is a short-term treatment for weed control.

FIGS. 20A-20D illustrate a research site (plot no. 20 in Table 4) over a 10-month study period in response to FeHEDTA. FIG. 20A—FeHEDTA, Natria treated. FIG. 20B—1 month after the treatment. FIG. 20C—8 months after the treatment. FIG. 20D—10 months after the treatment. This is the commercially available Bayer Natria product. This commercial herbicide worked well to control weeds for a short term, but did not provide long-lasting weed control.

FIGS. 21A-21D illustrate a research site (plot no. 22 in Table 4) over a 10-month study period in response to 2-4 D. FIG. 21A—2-4 D treated. FIG. 21B (Image not available)—1 month after the treatment. FIG. 21C—8 months after the treatment. FIG. 21D—10 months after the treatment. The 2-4 D treatment can be used for a short-term treatment effect but was not as effective as the innovative treatments discussed herein.

FIGS. 22A-22B illustrate a research site (plot no. 30 in Table 4) over a 7-week study period in response to an application rate of 75 pounds/acre of granular boron plus 60 pounds per acre of granular nitrogen in Spring. FIG. 22A—6 days after granular B, 75 pounds/acre plus granular N, 60 pounds per acre treated. FIG. 22B—7 weeks after the treatment. Based on the success of plot no. 5 implemented in Fall, the same application rate of the B+N combination treatment was implemented in Spring to compare spring/fall applications. FIG. 5E shows the treatment effectiveness between the fall and spring applications of the B+N combination treatment. The Spring applications (FIGS. 22A-22B) are worse than the fall implemented treatment. This suggests that fall is a better time to apply but that spring treatment has some effect in 7 weeks.

FIGS. 23A-23B illustrate a research site (plot no. 31 in Table 4) over a 7-week study period in response to an application rate of 60 pounds/acre of granular boron plus 60 pounds per acre of granular nitrogen plus foliar Cu in Spring. FIG. 23A—6 days after granular B, 60 pounds/acre plus granular N, 60 pounds per acre plus foliar Cu treated. FIG. 23B—7 weeks after the treatment. This is the best spring treatment. In addition to the granular B+N used in plot no. 30 in Table 4 (FIGS. 22A-22B), an additional foliar Cu liquid spray was added in plot no. 31. FIG. 23A (6 days after application) shows that the weedy broadleaf plants are highly stressed. As shown in FIG. 23B, 7 weeks after the treatment, weeds are essentially gone compared to either B+N alone (plot no. 30—FIGS. 22A-22B) or foliar Cu alone (plot no. 32 in Table 4—FIGS. 24A-24B).

FIGS. 24A-24B illustrate a research site (plot no. 32 in Table 4) over a 7-week study period in response to foliar Cu in Spring. FIG. 24A—6 days after foliar Cu treated. FIG. 24B—7 weeks after the treatment. The foliar copper spray was highly effective initially at harming the weeds as shown in FIG. 24A (6 days after treatment). However, as shown in FIG. 24B, 7 weeks after the treatment, the weeds have grown back. The foliar copper was essentially only a defoliant and did not kill the plants. This foliar Cu application is different from plot no. 31 (FIGS. 23A-23B) where foliar Cu is combined with granular B+N.

FIGS. 25A-25D illustrate a research site (plot no. 24 in Table 4) over a 10-month study period as an untreated control. FIG. 25A—Untreated. FIG. 25B—1 month later. FIG. 25C—8 months later. FIG. 25D—10 months later. In the untreated areas around the plot there is consistently about 50% weed cover comprised primarily of clover but with substantial amount of dandelion. Also present at percent levels are oxeye daisy, Canadian thistle and black medic. The black medic and clover have similar leaves so they are hard to distinguish until they flower.

FIG. 26A illustrates the Roundup-like effect of liquid B1300 formulation sprayed in a square shape onto the turf grasses. FIG. 26A shows the sharp boundaries between the treated and untreated grasses. The Roundup-like “non-selective phytotoxicity” outcome was observed when the liquid B1300 is sprayed at a high rate (such as about 100-160 lbs B/acre).

FIGS. 26B-26C illustrates knotweed phytotoxicity caused by micronutrient foliar application with liquid B1300 formulation. The left panel (FIG. 26B) shows location 1 (dotted rectangle) with knotweed on the side of the road at day 1 of B1300 spray and the right panel (FIG. 26C) shows the same location 1 (dotted rectangle) at day 12 after the liquid B1300 spray.

FIG. 26D illustrates a comparison between liquid B1300 and Roundup® (check/control) treatment on prostrate knotweed along a gravel trail. Both were highly effective, however B1300 worked faster.

FIG. 27 illustrates healthy perennial grass coverage in plot Nos. 7, 8, 9, 11, 21 (Table 4) by foliar application. Increasing perennial grass stress is observed with increasing amounts of foliar B treatment showing that a non-selective effect is observed while perennial grasses are more tolerant of applied foliar B at high application rates (>120 lbs/acre).

FIG. 28 illustrates varying modeled rates of liquid B1300 application for three different vegetation types with differing tolerance to applied boron. Y axis shows Percent controlled by treatment where 0.2 signifies 20%, 0.4 signifies 40%, 0.6 signifies 60%, 0.8 signifies 80%, and 1.0 signifies 100%. Annual grasses, shown by the cheatgrass series, is most sensitive. Weedy forbs are moderately sensitive to applied boron as shown by the dandelion series. And perennial grasses are most tolerant of applied boron as shown by the perennial grass series.

### DETAILED DESCRIPTION OF THE DISCLOSURE

Weed control has been accomplished over recent decades by proprietary synthetic herbicides derived from petrochemicals and distributed by major agri-business entities. Companion fertilization is routinely performed in crop, range, pasture, turf grass and other applications. Many invasive plant species can be selectively controlled by adding phytotoxic levels of micronutrient fertilizers. The present disclosure provides the basis for using phytotoxic granular and liquid micronutrient fertilizers applied to the soil or vegetation leading to the selective or non-selective inhibition, control or death of undesirable invasive (weedy) species. Also, the present disclosure provides the companion addition of nitrogen fertilizer as an ameliorative additive for preventing stress on desirable species, and in particular, the species comprising the perennial grass family. In some embodiments, phytotoxic micronutrient compounds are applied to soil or plant tissue of differential responses by unique plant species. Of primary importance to the disclosure is the dissimilar response of many invasive plant species (i.e. weeds) to relatively low concentrations of phytotoxic micronutrient compounds. Many of these invasive species are from the plant families including annual grasses, annual forbs and perennial forbs. Concurrent with application of phytotoxic micronutrient compounds to plants and soils that are harmful to invasive plants, the later successional and desired plant species are commonly unharmed and in some cases beneficially stimulated by the addition of micronutrients. The selective injury to invasive plant species by phytotoxic micronutrient compounds is the basis for the disclosure since this is accomplished using unconventional methods and formulations that do not include synthetic herbicides commonly in use for the same purpose. Further disclosed is the severe restriction of growth of all plant species, including some grasses, by application of relatively high rates of phytotoxic micronutrient compounds non-selective phytotoxicity (NSP) to all plants may be accomplished.

Micronutrient additions to soil serve to replace soil resources (e.g. soil restoration) caused by land disturbing activities and climate change resulting in soil nutrient deficiency, carbon loss and companion hazard of weed invasion. Soil improvements in nutritional status facilitate the growth of later successional plant species (perennial species) and diminish the vigor of early successional plants (weeds) through biogeochemical processes that also increase later successional plant tolerance to abiotic stress, facilitate nutrient assimilation, improve water use efficiency and enhance soil fertility by endemic soil microorganisms. Micronutrients are comprised of naturally occurring products primarily derived from rock-forming minerals that are mined, crushed and sold as fertilizer. Cycling of plant micronutrients in soil furthers the growth of desirable plant species and is a primary function soil organisms which may number 10,000 unique species in a gram of soil most of which are specialists in breaking down carbon into plant available nutrients and mobilizing micronutrients. When micronutrients are lost due to soil disturbance soil function is impaired and invasive plants may become established in the nutrient-depleted soil. Micronutrient fertilization restores the basic geochemical building blocks required for soil health and restores the soil's native ability to retard invasion by weeds by causing selective phytotoxicity to early successional invading weedy plant species.

Invasive plants (i.e. weeds) are well established across the globe and contribute to economic losses, habitat degradation, losses in land productivity and value. Weeds have become established through a variety of landscape changes including, but not limited to, fire, grazing, land clearing, tillage, urbanization, and other land disturbing activities. Weed seeds have also traveled the globe becoming established as exotic species on continents on opposite sides of the world. Many of the noxious weeds found in the U.S. evolved naturally elsewhere, become established, and proliferate in the absence of natural controls.

Billions of dollars are spent annually controlling weeds. The Nature Conservancy Global Invasive Species Team reports worldwide damage from invasive species amounts to $1.4 trillion annually, or five percent of the global economy (Pimentel et al. 2001). In the U.S., impacts from invasive species amount to $120 billion annually with more than 100 million acres affected (Pimental et al. 2005). For example, leafy spurge (Euphorbia esula) infestations in the northern Great Plains costs ranchers $120 million annually (Bangsund et al. 1991).

Herbicides are the principal strategy for controlling weeds including synthetic formulations such as glyphosate (ROUNDUP®/Monsanto, and others), PLATEAU® (imazapic, BASF), JOURNEY® (imazapic+glyphosate, BASF), MATRIX® (sulfonylurea, DuPont), LANDMARK XP® (sulfometuron and chlorsulfuron, Dupont), OUST® (sulfometuron, DuPont) and other formulations are sold to control weeds. Effectiveness of conventional herbicide applications is highly dependent on timing of herbicide application relative to both plant physiology/growth stage, specific contact with growing vegetation, and complimenting rainfall conditions. Land managers often rule out the use of herbicides for control of weeds due to high cost, low effectiveness and damage to desirable species. Effective weed control methods, which do not harm desirable species, are available, but often have limitations related to cost, need for repeated application and a general concern for the hazards associated with the application of organic chemicals in the environment. Most herbicides used for control of invasive species are organic liquid chemicals applied to the leaf tissue, which result in disruption of plant metabolic processes. These same organic chemicals are not naturally derived and may be harmful to water quality, wildlife and humans. Additionally, research suggests that some invasive plant species are developing resistance to herbicides (Maxwell et al. 1990; Heap 2006) and the widespread use of herbicides worldwide (i.e. glyphosate) may cause unintended consequences including limiting micronutrient availability (Yamada et al. 2009), as well as broad endocrine disruption.

Of the sixteen chemical elements known to be important to a plant's growth and survival, thirteen of those elements come from the soil and can be dissolved in water and absorbed through a plant's root system. In some instances, there are insufficient levels of these elements to sustain normal plant growth and development. Agriculturalists rely on the application of fertilizer to ameliorate elemental nutritional deficiencies, with the expectation of a positive, ‘desirable’ plant response to the added nutrient. It is known that all plant species have definable nutrient requirements and many plant species have unique sensitivities to trace elements, otherwise known as micronutrients. Some combinations and concentrations of these nutrients, particularly the micronutrients, can be detrimental or toxic to some plants. Sensitivities to low or high micronutrient levels can be expressed in plants as depressed or stunted growth, delayed maturity, incomplete physiological development, cell necrosis, or premature death (Kabata-Pendias and Pendias, 2001). The range of micronutrients required for optimal plant growth for each species may be broad or narrow. Soils have unique geochemical characteristics related to climate and parent material. Native plant communities have adapted to these unique conditions over thousands of years. Under natural conditions, these plant-soil systems maintain an equilibrium level of nutrient availability until disturbed by natural or anthropogenic forces causing a geochemical disequilibrium, which makes these plant-soil systems susceptible to invasive species colonization.

The term “phytotoxicity” as used herein, is implied to reflect plant death or dramatic reduction in plant viability of ˜90% taken as the plant size (biomass and height) and vigor. The cause of phytotoxic responses to invasive plants is unknown but may relate to naturally occurring edaphic processes, cycling of nutrients by microorganisms in the rhizosphere or mechanisms used by late successional plant species retard invasion such as allelopathy (Mohaammadkani and Servati, 2018).

Phytotoxic levels of trace elements in soils are known to occur naturally. Acid-sulfate soil systems are known to mobilize metals resulting in phytotoxic soil conditions for plant species not tolerant of soil acidity. Saline soil conditions are also known to occur in arid climates resulting in phytotoxic conditions for plant species not tolerant of elevated salinity. Anthropogenic releases of contaminants to the natural environment are also known to cause phytotoxic soil conditions. Mining and smelting are both known to cause acidic and metalliferous soil conditions, while agricultural practices such as fallow farming may lead to salinization of the soil resource.

Farmers may add fertilizers or soil amendments to increase the yield of crops and overcome any geochemical limitations of the soil, which affects crop yield. Plant macronutrients such as nitrogen, phosphorous and potassium are routinely added to soil to maximize crop yield. In some cases trace elements such as copper, zinc or boron may be added to the soil if the crop grown has unique trace element fertilization needs. Farmers may also add soil amendments such as lime (such as CaCO₃) to control soil acidity. Similarly, land reclamation scientists may add soil amendments and fertilizers to control undesirable soil geochemistry at disturbed sites. Seeding of plant species, which are tolerant of site-specific conditions, is also a common practice for revegetation of disturbed sites.

According to the present disclosure, minute concentrations of the plant micronutrients boron, copper, zinc, manganese, chlorine and molybdenum when applied to the soil, directly to weed seed, or to soil containing weed seed, result in seed death, failure of weed seed to germinate, and premature mortality of emerging seedlings through micronutrient induced phytotoxicity.

The present disclosure provides high concentration of phytotoxic micronutrients or micronutrient fertilizer, and also teaches combinations of 1) one or more micronutrients or micronutrient fertilizers and 2) one or more macronutrients or macronutrient fertilizers. The present disclosure provides method of using the phytotoxic micronutrient and combinations of the phytotoxic micronutrient and/or macronutrient compositions for selective control of the invasive species.

According to the present disclosure, soil conditions phytotoxic to weed species yet not phytotoxic to desirable plant species are made possible through knowledge of the dose-response curve for each unique micronutrient-plant interaction. The resulting modified geochemical soil conditions cause selective phytotoxic control of invasive plant species while allowing establishment and persistence of desirable plant species. Timing of application of the micronutrient is targeted to elevate soluble soil micronutrient concentrations in soil containing weed seed prior to seed germination. Thus, micronutrient application can be made any time following weed seed drop and before weed seed germination. The timing of micronutrient application is unique to the invasive species targeted and its growth cycle. Fundamentally, the elevated soil micronutrient conditions must exist while the plant is actively growing (whether seed is germinating below the soil surface or producing leaf tissue above the soil surface). The period of micronutrient application may encompass the entire calendar year, depending on the plant species and unique phenological needs for nutrients and site conditions including composition of desirable plant species present. Annual weeds growing from seed every year will require dissimilar timing strategies for phytotoxic micronutrient compound application compared to perennial weed species with extensive and long-lived root systems.

According to the present disclosure, mature growing invasive species can also be controlled by micronutrient addition. For example, weeds commonly grow to maturity early in the growing season and may produce and drop seed in late spring to mid-summer.

For reasons of convenience or performance, combinations of products for control of invasive plant species may be advantageous. In part, combination products are driven by the high labor and equipment costs associated with crop/pasture/landscape management across large acreage where it makes more sense to apply two or more beneficial ingredients at the same time. In part, combination products are driven by performance where the outcome of adding two or more beneficial ingredients is synergistic and product performance is accelerated or augmented by combinations of products for control of invasive plant species.

The present disclosure teaches simultaneous and/or sequential applications of phytotoxic micronutrients and macronutrients such as nitrogen, phosphorous and potassium, as combination in varying percentages.

### I. Phytotoxic Micronutrients

Of the sixteen chemical elements known to be important to a plant's growth and survival, thirteen come from the soil, are dissolved in water and absorbed through a plant's roots through mediation by soil organisms in the rhizosphere. In some instances, there are not always enough of these nutrients in the soil for a plant to grow healthy. In other instances, some combinations and concentrations of these nutrients, particularly the micronutrients, can be detrimental or toxic to some plants. Micronutrients, those elements essential for plant growth and which are needed in only very small (micro) quantities, are boron (B), copper (Cu), iron (Fe), chlorine (Cl), manganese (Mn), molybdenum (Mo) and zinc (Zn). These micronutrients play critical roles in carbohydrate transport, metabolic regulation, osmosis and ionic balance, enzyme and chlorophyll synthesis and function, internal chemical transformations, and cell reproduction/division.

According to one exemplary embodiment the present disclosure, the phytotoxic micronutrients comprise boron, copper, zinc, manganese, chlorine, and/or molybdenum. In one embodiment, the phytotoxic micronutrients comprise a boron source, a copper source, a zinc source, a manganese source, a chlorine source, and/or molybdenum source. As used herein the “source” for elemental micronutrients include organic and inorganic compounds and complexes that can provide soluble micronutrients (boron, copper, zinc, manganese, chlorine, molybdenum, etc.) in the soil.

In some embodiments, a boron source can include, but are not limited to, boric acid, sodium borate, sodium tetraborate, and disodium tetraborate.

In some embodiments, a copper source can include, but are not limited to, chelated copper such as Na₂CuEDTA, copper sulfate such as CuSO₄.5H₂O, cupric oxide (CuO), and cuprous oxide (Cu₂O).

In one embodiment, the phytotoxic micronutrients are useful in increasing the growth of desirable plant species (such as bluebunch wheatgrass and Kentucky bluegrass) while controlling invasive plant species (such as cheatgrass, dandelion and spotted knapweed). In one embodiment, the phytotoxic micronutrients comprise boron or a boron source.

In another embodiment, boron is useful in increasing the growth of desirable plant species (such as bluebunch wheatgrass and Kentucky bluegrass) while controlling invasive plant species (such as cheatgrass, dandelion and spotted knapweed).

As used herein, the phrases “desirable plant species” and “desirable plants” refer to plants that are present in a specific location where they are wanted. As used herein, the phrases “invasive plant species” and “invasive plants” refer to plants that are present in a specific location where they are unwanted. Thus, according to the present disclosure, whether a plant is considered a desirable or an invasive plant in a particular situation depends on the specific location involved and the desires of the manager or owner of that location. For example, a certain grass species may be considered a desirable plant in a mixed alfalfa/grass field used for forage production or livestock grazing. That same grass species, however, may be considered an invasive plant in an alfalfa field to be used for certified alfalfa seed production. In the latter situation, the grass species would be classified a weed and if too many seeds or other parts of the grass species were harvested with the alfalfa seed that may result in the seed from that alfalfa production field being denied certification. On an un-tilled landscape occupied by native vegetation the colonization of the site by non-native or exotic plants is illustrative in that the native vegetation would be the “desirable species” and the non-native and exotic colonizing species would be an “invasive species”.

According to other embodiments of the present disclosure, the control of invasive plant species shown herein by using various boron solutions is also applicable and demonstrated using other micronutrients and other species and combinations of species. A partial list of known invasive species would include, but not be limited to: cheatgrass (Bromus) (such as Downy brome (Bromus tectorum), Japanese brome (bromus Japonicus), etc.), dandelion (Taraxacum officinale), knapweeds (Centaurea) (such as spotted (C. maculosa)), diffuse (C. diffusa), Russian (C. repens), etc.), bindweed (Convolvulus), chickweed (Stellaria media), ground ivy (Glechoma hederacea), poison ivy (Toxicodendron radicans), Canada thistle (Cirsium arvense), burdock (Arctium), houndstongue (Cynoglossum), yellow star thistle (Centaurea solstitialis), Himalayan bush clover (Lespedeza cuneata), privet (Ligustrum), Russian thistle (Salsola), kochia (Bassia), halogeton (Halogeton), Japanese knotweed (Fallopia japonica) and related knotweeds (Fallopia), leafy spurge (Euphorbia), St. Johnswort (Hypericum perforatum), toadflax (Linaria) (such as yellow toadflax (Linaria vulgaris) and Dalmation toadflax (Linaria dalmatica)), tansy (Tanacetum vulgare), whitetop (Lepidium draba), hawkweed (Hieracium), cinquefoil (Potentilla), ox-eye daisy (Leucanthemum vulgare) and others either known to be a problematic invasive species and also those not yet determined to be such. For additional information on weeds see, e.g., R. Dickinson and F. Royer, Weeds of North America, 2014, University of Chicago Press, 656 pages; Invasive Weeds of North America: A Folding Pocket Guide to Invasive & Noxious Species (Wildlife and Nature Identification), 1^{st} Edition, 2017; Thurlow Merrill Prentice, Weeds & Wildflowers of Eastern North America, First Edition, 1973, Peabody Museum of Salem; U.S. Dept. of Agriculture, Common Weeds of the United States, Revised Edition, 1971, Dover Publications, 480 pages; Weeds, 2001, Golden Guides from St. Martin's Press, 160 pages; R. L. Sheley and J. K. Petroff (eds.), Biology and Management of Noxious Rangeland Weeds, 1999, Barnes & Noble, 438 pages; U.S. Pat. Nos. 5,180,415; 9,416,363; and, R. P. Randall, A Global Compendium of Weeds, Third Edition, 2017, 3654 pages.

The list of known invasive species can also include annuals: pigweed (Amaranthus), lambsquarters (Chenopodium berlandien), foxtail (Setaria), crabgrass (Digitus), wild mustard (Sinapis arvensis), field pennycress (Thlaspi arvense), ryegrass (Lolium), goosegrass (Galium aparine), chickweed, wild oats (Avena fatua), velvet leaf (Abutilon theophrasti), purslane (Portulaca oleracea), barnyard grass (Echinochloa), smartweed (Polygonum pensylvanicum), knotweed, cocklebur (Xanthium), wild buckwheat (Fallopia convolvulus), kochia, medic (Medicago), corn cockle (Agrostemma githago), ragweed (Ambrosia), sowthistle (Sonchus), coffeeweeds (common chicory (Cichorium intybus), Chinese senna or sicklepod (Senna Obtusifolia), coffee senna (Senna occidentalis), Colorado River hemp (Sesbania herbacea), croton (Croton), cuphea (Cuphea), dodder (Cuscuta), fumitory (Fumaria), groundsel (Senecio), hemp nettle (Galeopsis), knawel (Scleranthus annuus), spurge (Euphorbia), spurry (Spergula), jungle rice (Echinochloa colona), pondweed (Potamogeton), dog fennel (Eupatorium capillifolium), carpetweed (Mollugo verticillata), morning glory (Convolvulaceae), bedstraw (Galium aparine), or ducksalad (Heteranthera limosa); biennials such as wild carrot (Daucus carota), matricaria (Matricaria), wild barley (Hordeum leporinum), campion (Silene), chamomile (Matricaria discoidea), mullein (velvet plant), roundleaved mallow (Malva), bull thistle (Cirsium vulgare), moth mullein (Verbascum blattaria), and purple star thistle (Centaurea calcitrapa); or perennials such as white perennial ryegrass (Lolium perenne), quackgrass (Elymus repens), Johnson grass (Sorghum halepense), hedge bindweed (Calystegia sepium), Bermuda grass (Cynodon dactylon), sheep sorrel (Rumex acetosella), curly dock (Rumex crispus), nutgrass (Cyperus rotundus), field chickweed (Cerastium arvense), campanula (Campanula), field bindweed (Convolvulus arvensis), mesquite (Prosopis), toadflax, yarrow (Achillea millefolium), aster (Aster), gromwell (Lithospermum), horsetail (Equisetum arvense), ironweed (Vernonia), sesbania (Sesbania), bulrush (Schoenoplectus), cattail (Typha) or wintercress (Barbarea).

Cheatgrass, a non-native, invasive, Euro-Asian winter annual grass species, is present or dominant on some 100 million acres in the Great Basin and Intermountain West. Several thousand new acres are invaded by cheatgrass every day, with each plant producing upwards of 1,000 seeds. Cheatgrass is a principal driving force behind epidemic wildfires occurring continually and with greater frequency across the western U.S. and is largely responsible for decline of the sagebrush-steppe ecosystem, home to more than 1500 species of birds, vertebrate, and invertebrate species including iconic western ungulates deer, elk, antelope, and the endangered sage grouse; all of which are dependent on the habitat and health of this rapidly declining ecosystem.

In one embodiment, the present disclosure provides a granular and/or dry application of a of boron, or other solid sources of boron, applied to field sites to control invasive species including non-desirable annual grass species and/or perennial grass species.

In another embodiment, the present disclosure provides a foliar application of a liquid spray mixture of boric acid, sodium borate, sodium tetraborate, or disodium tetraborate, or other soluble sources of boron, applied to field sites to control invasive species including non-desirable annual grass species and/or perennial grass species.

This disclosure demonstrates that fertilization by micronutrients is selectively harmful to invasive plants while desirable species are either stimulated or tolerant of the same levels shown to be phytotoxic to the weedy species. This makes ecological sense as later successional plant communities have more highly evolved nutrient cycling and elevated levels of fertility. The desirable plants characteristic of the late successional plant communities are tolerant and benefit from higher levels of soil fertility and especially adequate amounts of trace elements (also known as micronutrients). Invasive species are intolerant of elevated micronutrient levels and thrive in low nutrient soils, thus, low nutrient soil are unable to retard weedy colonizers. The recycling of trace elements by later successional plant communities may have been a primary natural control on preventing weed invasion. Upon disturbance and loss of pre-disturbance fertility native plant communities become susceptible to weed invasion. The recovery of these systems through natural soil building and plant succession is likely to occur over long periods of time (hundreds to thousands of years) absent repeated disturbance.

Without bound to any theory, micronutrients translocated into the plant shoots and subsequent surface decay provides a weed-inhibiting function through nutrient cycling. The phytotoxic micronutrients fixes the soil required to create conditions conducive to perennial plants, so that means creating soil conditions favorable to late-successional ‘old growth’ rangeland plants rather than colonizers, while being phytotoxic to invasive species. The abiotic change constituted by addition of mineral fertilizers is further enhanced by the biotic function of the soil rhizosphere in cycling the soil nutrients (e.g. the soil food web) to make them available to the roots and may employ bacteria, algae, fungi, protozoa, nematodes, arthropods, worms, insects and small vertebrates. The delivery of nutrition to plants is therefore the combined contributions of the inorganic mineral soil components and the complex endemic biological delivery system of nutrients to the plant. The resultant biogeochemical soil signature imparts an unmistakable and powerful influences on the plant community by mirroring the micronutrient status of late successional plant communities absent of invasives.

For example, when considering a logging road built through a mountain meadow, the pre-disturbance desirable diverse vegetation exists on both sides of the road while the roadbed and cut/fill slopes become colonized by invasive species. Of relevance to the disclosure is that while the invasive species produce large amounts of seed that fall on the adjacent mountain meadow they fail to become established. Trace element phytotoxicity to such weed seeds is an important control on the invasion of weedy species such as dandelions beyond the roadbed. In this disclosure soil health of disturbed lands is restored by reverse engineering the inorganic trace element/micronutrient fingerprint of the pre-disturbance soil and soil micronutrients by the application of the phytotoxic micronutrients and subsequent mobilization by endemic soil organisms to control invasive species.

Weeds are negatively impacted by small quantities of micronutrients whereas more desirable species (perennial grasses, native forbs) are tolerant of these same levels. There is a differential tolerance between invasive species and desirable plants (see WO 2014/113475, which is hereby incorporated by reference in its entirety for all purposes).

In one aspect, the role of the phytotoxic micronutrients is fundamentally about mass balance—restoring appropriate amounts of soil micronutrients in soil by replacing micronutrients lost due to land disturbance. According to the present disclosure, the consequences of restoring pre-disturbance levels of soil micronutrients include making the soil inhospitable to invasive species. Different invasive weed species have different sensitivities to the micronutrients compared to species that are more desirable.

How much micronutrients to add is a function of the existing amount of micronutrients in the soil and the specific weedy and specific desirable plant species present at a site on which the disclosure is to be practiced. The amount of micronutrients present in a disturbed soil is a unique quantity that can be measured by laboratory analysis. Geologic parent material, soil formation history, land use history, climate and other factors influence the elemental levels of all inorganic constituents in the soil. The process to determine the specific micronutrients and amounts of each to be applied involves collecting samples of soil from at least two representative areas or sites: at least one sample from an undisturbed portion of the site with desirable plant species and at least one sample from a disturbed portion of the site with invasive plant species and diminished desirable plant species cover. The difference in soil micronutrient levels between the “good” site and “bad” site form the basis for calculation of fertilizer application rates. The amount of micronutrients added is the difference between the degraded site with low fertility and the reference site with natural levels of soil fertility. According to the present disclosure, site-specific phytotoxic micronutrient prescription can be developed and applied. In larger landscapes with common soil and vegetation characteristics, generalized micronutrient application strategies may be applicable. In addition, when undisturbed sites cannot be found on the larger landscape, generalized micronutrient application may be required to control the targeted invasive species.

Plant micronutrient levels in soil are generally very low (roughly a few pounds per acre of a given plant available micronutrient in the rootzone). Correspondingly, the amount of micronutrient to be added per acre would also be low and dependent on the elemental levels of micronutrient in the fertilizer to be applied. In the case where the micronutrient is impractical to apply at low rates (a few pounds per acre) due to the difficulty of applying a thin uniform amount of fertilizer using mechanical equipment, the fertilizer can be bulked up to add weight and/or volume to aid in spreading. Bulking of fertilizer can be accomplished using sand, rice hulls, corn meal, sawdust, crushed walnut shells, corn stover or equivalent. For example, if the target micronutrient application rate was 5 pounds per acre and the reasonable minimum application rate with a given piece of equipment was 10 pounds per acre an additional 5 pounds of bulking material could be added to the 5 pounds of the micronutrients (the active ingredient).

A second factor affecting the amount of micronutrients to be added is the plant species present—both desirable and invasive. In this disclosure, it is recognized that each plant species has a unique trace element requirement: too little of a given micronutrient and the plant is deficient, too much of a given micronutrient and the plant experiences phytotoxicity. In one embodiment, invasive species have lower tolerance to a given soil micronutrient concentration compared to desirable plant species (typically perennial grasses). It is this differential sensitivity to micronutrients in the soil shown by desirable plants compared to invasive plant species that is important. The phytotoxic micronutrients will include levels of one or more micronutrients above phytotoxic levels for invasive plant species and below levels harmful to desirable species for a given site. In some embodiments, perennial grass species are much more tolerant of elevated micronutrient levels compared to weeds.

Perennial grass plant community is comprised of native plant species (e.g. bluebunch wheatgrass, etc.) and/or introduced plant species (e.g. Kentucky bluegrass, etc.).

A granular and/or foliar application of micronutrients can occur at any time during the year; however, maximum affect has been observed when micronutrient fertilizer is applied in the late summer/early fall or early spring in advance of seasonal plant growth.

In western landscapes occupied by invasive weeds, winters are typically cold with snow and frozen ground. Maximum plant growth typically occurs in the spring (April-June when snow melts, ground thaws, soil temperatures warm and spring rains occur). The effect of micronutrient application during this period may not be observed for one year as plant growth occurs due to existing soil nutrients rather than the added soil nutrients (unless the micronutrient is applied early in the spring and/or unless significant rainfall occurs). Invasive plant species appear most sensitive to elevated micronutrient levels when the plants are young. Annual plant species appear most sensitive during seed germination and establishment early in the phenology of the plant. It should be noted that the effect on invasive plants from micronutrient additions to soil are dissimilar from organic chemical-based herbicides that kill plants over a period of days to weeks by regulating the rate of growth or weeds and are generally applied to the growing leaf tissue.

The phytotoxic micronutrient requires sufficient time for the fertilizer to be applied to the soil, become dissolved by rainfall or snowmelt and to change the chemistry of the soil solution such that germinating seed or young plants imbibe the applied trace element solution by root uptake. The soil solution generally refers to the film moisture in the soil together with its dissolved substances.

In another embodiment, micronutrient solutions can be delivered to invasive plants and taken up by the plant over a period of days to weeks and are generally applied to the growing leaf tissue via a foliar application. As discussed elsewhere herein, the foliar liquid application of the micronutrients may, in some instances, result in foliar nutrient uptake that could result in faster plant responses.

In one embodiments, changes to the plant community are best observed over long-periods of time (months-years) when granular formulation of the solid micronutrients is applied.

Also, foliar formulation of the liquid micronutrients is applied, the foliar applications can take affect over short periods of time.

This disclosure also should be thought of in terms of greatly reducing the prevalence of weeds by changing the soil chemistry, but not eliminating all weeds. This is an ecological approach to restoring desirable plant communities and their soil quality. This approach to weed control focuses solely on the plant and invasive species control as a one-component system. The phytotoxic micronutrients changes the soil chemistry to change the plant community as a two-component system, each dependent on the other.

In some embodiments, the phytotoxic micronutrients described herein are non-synthetic substances.

### II. Granular Application of Micronutrients

A herbicidal application of organic chemicals is often an annual process as new plants grow from seed. In some embodiments, the granular micronutrient application is a one-time application for restoring soil health, plant community composition and long-term control of weeds through natural micronutrient cycling. In other embodiments, subsequent micronutrient applications are required if target soil levels are not attained during a first application due to landscape factors, climate, grazing, fire or related land management activities. In further embodiments, multiple applications of micronutrients are also practiced by this disclosure. In some embodiments, the granular application is once per year, twice per year, three times per year, four times per year, five times per year, six times per year, every month, every other week, every week, three times per week, every other day, every day, every 12 hours, every 6 hours, every 3 hours, every 2 hours, every 1 hour, every 30 minutes, every 15 minutes, every 10 minutes, every 5 minutes, every 3 minutes, every 2 minutes, and every minute.

By creating phytotoxic soil, conditions through the application of the phytotoxic micronutrients in the uppermost soil layers (about 1 inch or 2 inches depth) weed seeds and seedlings can be selectively inhibited during or immediately following germination therein preventing the plant from growing to maturity and producing seed to sustain subsequent generation of plants. This effect may disrupt the life cycle of annual weedy plant species. Existing desirable perennial plant species are unharmed due to deeper roots, which are not exposed to phytotoxic surficial micronutrient levels. Over a period of months or years, the surface applied micronutrients will reach roots in the deeper soil at diluted concentrations, which are expected to have a long-lasting beneficial fertilization effect due to prior nutrient depletion caused by land disturbance and an inhibitory effect on perennial weeds. The application of phytotoxic micronutrient compounds to create weed-inhibitory conditions and persisting soil residual fertility are intended. Many disturbed sites are both water limited due to climate and nutrient limited due to soil depletion. The resulting ecological lift is caused by the combined effect of enhancing existing desirable vegetation and diminishing the frequency and extent of weedy plants. The ecological lift in the plant community causes companion enhancement of soil conditions including improved structure, increased organic carbon, improved water holding capacity, increased infiltration and improved nutrient retention in a symbiotic relationship with the plant community. The decrease in annual grasses in rangeland, for example, causes increased cover of perennial vegetation that facilitates capture of atmospheric carbon dioxide as soil carbon (e.g. terrestrial CO₂ sequestration) that is further beneficial to the plant-soil system as increased organic matter content (Yang et al., 2019).

The present disclosure teaches the example of plant micronutrient boron although the same result can be understood by one skilled in the art to also apply to other plant micronutrients including, copper, zinc, manganese, iron, chlorine and molybdenum. The expectation is that each invasive or weedy plant species that one is seeking to control or eliminate has a characteristic sensitivity, tolerance and mortality to each micronutrient. The unique combinations of plant and micronutrient number in the thousands, however this disclosure has demonstrated that invasive species have lower tolerance and higher sensitivity to micronutrients compared to perennial grass species suggesting many possible opportunities for invasive plant control using micronutrient application. Most work performed to date has been performed to make boron within the range of 0.5-50 mg/L in soil solution. Water soluble micronutrient ranges for copper, zinc, manganese, molybdenum and chlorine for control of invasive plant species are expected to be similarly low, yet the precise targets are expected to be unique to each land area and species targeted. In the instance where existing soil micronutrients are near normal levels prior to treatment to control invasive species target application rates may be lower (e.g. 0.01-0.5 mg/L). The selection of a specific micronutrient and application rate will be made based on species specific sensitivity to each micronutrient and cost for each micronutrient fertilizer.

In one embodiment, the phytotoxic micronutrients are provided in a dry formulation. In one embodiment, the dry formulation is in a granular form. In one embodiment, the dry formulation can be in a dry powder or in a pelletized form. The dry formulation of the phytotoxic micronutrients can be applied to the soil surface with a tractor or a spreader. The dry formulation would become available to the plant upon rainfall, snowmelt or irrigation practices.

In one embodiment, the phytotoxic micronutrient is in a dry formulation and the dry formulation is spread on the soil surface or onto vegetation, prior to filtering down to the soil surface by gravity or being dissolved into the soil by water addition by rainfall, snowmelt or irrigation practices.

In some embodiments, the phytotoxic micronutrients comprise boron, boron source, copper, copper source, zinc, zinc source, manganese, manganese source, molybdenum, molybdenum source, chlorine or a chlorine source. In some embodiments, the phytotoxic micronutrients comprise soluble sources of boron, copper, zinc, manganese, molybdenum or chlorine in the range of about 0.01 mg/L to about 50 mg/L, about 0.01 mg/L to about 0.5 mg/L, or about 0.5 mg/L to about 50 mg/L. The selection of a specific micronutrient and application rate will be made based on species-specific sensitivity of invasive plants to each micronutrient and cost for each micronutrient fertilizer.

In some embodiments, the phytotoxic micronutrients comprising boron or a boron source is in a dry formulation comprising about 5% to about 40% elemental boron by weight of a composition as a phytotoxic micronutrient fertilizer, or any value and subranges there between. In some embodiments, the phytotoxic micronutrients comprising boron or a boron source is in a dry formulation comprising about 5% to about 30% elemental boron by weight of a composition as a phytotoxic micronutrient fertilizer, and any value and subranges there between. In some embodiments, the phytotoxic micronutrients comprising boron or a boron source is in a dry formulation comprising about 10% to about 30% elemental boron by weight of a composition as a phytotoxic micronutrient fertilizer, and any value and subranges there between. In some embodiments, the phytotoxic micronutrients comprising boron or a boron source is in a dry formulation comprising about 10% to about 25% elemental boron by weight of a composition as a phytotoxic micronutrient fertilizer, and any value and subranges there between.

In some embodiments, the phytotoxic micronutrients comprising boron or a boron source is in a dry formulation comprising about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, or about 30% elemental boron by weight of a composition as a phytotoxic micronutrient fertilizer. In some embodiments, a dry formulation is for a granular application.

### III. Foliar Application of Micronutrients

In some embodiments, the foliar micronutrient application is a one-time application on restoring soil health, plant community composition and long-term control of weeds through natural micronutrient cycling. In other embodiments, subsequent micronutrient applications are required if target soil levels are not attained during a first application due to landscape factors, climate, grazing, fire or related land management activities. In further embodiments, multiple applications of micronutrients are also practiced by this disclosure. In some embodiments, the granular application is once per year, twice per year, three times per year, four times per year, five times per year, six times per year, every month, every other week, every week, three times per week, every other day, every day, every 12 hour, every 6 hour, every 3 hour, every 2 hour, every 1 hour, every 30 minute, every 15 minute, every 10 minute, every 5 minute, every 3 minute, every 2 minute, and every minute.

In one embodiment, the phytotoxic micronutrient may be taken up by the plant as a foliar nutrient or the liquid spray drizzling down the vegetation tissue and into the soil to be taken up by roots, or in combination of uptake mechanisms. In other embodiments, the phytotoxic micronutrient compound is spread on the soil surface or onto vegetation prior to filtering down to the soil surface by gravity, prior to being dissolved into the soil by water addition by rainfall, snowmelt or irrigation practices.

In one embodiment, the phytotoxic micronutrients are provided in a liquid formulation. In one embodiment, the liquid formulation is in a spray mixture formulation. In one embodiment, a liquid formulation can be prepared by dissolving the phytotoxic micronutrients in water. In some embodiments, the phytotoxic micronutrients can be dissolved in any liquid not harmful to plants. In one embodiment, a liquid formulation can be applied with a sprayer as long as the application rates are appropriate to achieve the desired fertility goals.

In one embodiment of the liquid formulation of the phytotoxic micronutrients, the formulation is thoroughly mixed to assure complete dissolution of the micronutrients. The solution can then be applied as an aerial spray to the target area. The solution can be applied to the surface of soil containing invasive species seed, directly to weed seed, or to senesced or live, seed-bearing weed plants. A target area may be any plant community where invasive species are present, e.g. urban land, rangeland, forestland, roadside, brownfield, or disturbed land.

As used herein, the phrase “urban land” refers to an area having the characteristics of a city or otherwise developed for human habitation, with intense development and a wide range of public facilities and services. Urban land includes turf and residential horticultural lands.

As used herein, the term “rangeland” refers to an expanse of land suitable for livestock or wildlife to wander and graze on.

As used herein, the term “forestland” refers to a section of land covered with forest or set aside for the cultivation of forests or as wildland without silvicultural intent.

As used herein, the term “brownfield” refers to a piece of industrial or commercial property that is abandoned or underused and often environmentally contaminated, especially one considered as a potential site for redevelopment.

As used herein, the phrase “disturbed land” refers to land that has been physically disturbed by resource operations (e.g., from mining, logging or construction) that cannot be used for other purposes (e.g., for agriculture or home sites). Disturbed land may be caused by, but not limited to, grazing by wildlife and domestic animals, fire, road construction, climate change, flooding, landslide, erosion, invasive species colonization, tillage for agriculture, urbanization, pipeline or utility installation, dam building (or removal), and the like.

In some embodiments of the present disclosure, the target area does not include land under intensive agronomical or horticultural production. For example, in some embodiments of the present disclosure, the target area does not include land being used to grow row crops, such as is used for large-scale growing of soybeans, maize/corn, cotton, dry peas and the like. In other examples, in some embodiments of the present disclosure, the target area does not include land being used to grow truck crops (i.e., large-scale vegetable crops), such as is used for large-scale growing of watermelons, fresh peas, peppers, cucumbers, tomatoes, onions and the like. In still other examples, in some embodiments for the present disclosure, the target area does not include land being used to grow large-scale production of flowers, such as is used for large-scale growing of tulips, daffodils, chrysanthemums and the like.

In some embodiments, the liquid formulation comprising the phytotoxic micronutrients is applied to a target at a rate of 1-50 milliliters per square meter, 1-75 milliliters per square meter, 1-100 milliliters per square meter, 1-150 milliliters per square meter, 1-200 milliliters per square meter, 2-200 milliliters per square meter, 2-300 milliliters per square meter, 2-400 milliliters per square meter, 5-500 milliliters per square meter, 10-600 milliliters per square meter 10-700 milliliters per square meter, 20-800 milliliters per square meter, 30-900 milliliters per square meter, 50-1000 milliliters per square meter, 100-1000 milliliters per square meter, 100-1000 milliliters per square meter, 100-1500 milliliters per square meter, 100-2000 milliliters per square meter, 100-3000 milliliters per square meter, 100-4000 milliliters per square meter, or 100-5000 milliliters per square meter.

### IV. Phytotoxic Micronutrients Comprising Boron or a Boron Source

In one embodiment, the phytotoxic micronutrients comprise boron or a boron source. In one embodiment, the boron source is boric acid, sodium borate, sodium tetraborate, or disodium tetraborate, or other soluble sources of boron. In some embodiments, soluble boron can be provided by dissolving boric acid, sodium borate, sodium tetraborate, or disodium tetraborate, or other soluble sources of boron, in water or alternative agriculturally acceptable liquid to create a boron-containing solution. In one embodiment, water soluble boron can be provided by dissolving boric acid, sodium borate, sodium tetraborate, or disodium tetraborate, or other water soluble sources of boron, in water.

In one embodiment, the applied liquid phytotoxic micronutrient solution comprising boron or a boron source has a boron concentration ranging from about 0.1 g/L to about 1 g/L, about 0.1 g/L to about 10 g/L, about 0.5 g/L to about 10 g/L, about 2 g/L to about 20 g/L, from about 3 g/L to about 30 g/L, from about 4 g/L to about 40 g/L or from about 5 g/L to about 50 g/L of water soluble boron.

In some embodiments, the phytotoxic micronutrients comprising boron or a boron source has a boron concentration of about 0.5-1 g/L to about 1.00-1.50 g/L, about 1.50-2.00 g/L, about 2.00-2.50 g/L, about 2.50-3.00 g/L, about 3.00-3.50 g/L, about 3.50-4.00 g/L, about 4.00-4.50 g/L, about 4.50-5.00 g/L, about 5.00-5.50 g/L, about 5.50-6.00 g/L, about 6.00-6.50 g/L, about 6.50-7.0 g/L, about 7.00-7.50 g/L, about 7.50-8.0 g/L, about 8.00-8.50 g/L, about 8.50-9.0 g/L, about 9.00-9.50 g/L, about 9.50-10.00 g/L, about 10.00-11.00 g/L, about 11.00-12.00 g/L, about 12.00-13.00 g/L, about 13.00-14.00 g/L, about 14.00-15.00 g/L, about 15.00-16.00 g/L, about 16.00-17.00 g/L, about 17.00-18.00 g/L, about 18.00-19.00 g/L, about 19.00-20.00 g/L, about 20.00-21.00 g/L, about 21.00-22.00 g/L, about 22.00-23.00 g/L, about 23.00-24.00 g/L, about 24.00-25.00 g/L, about 25.00-26.00 g/L, about 26.00-27.00 g/L, about 27.00-28.00 g/L, about 28.00-29.00 g/L, about 29.00-30.00 g/L, about 30.00-31.00 g/L, about 31.00-32.00 g/L, about 32.00-33.00 g/L, about 33.00-34.00 g/L, about 34.00-35.00 g/L, about 35.00-36.00 g/L, about 36.00-37.00 g/L, about 37.00-38.00 g/L, about 38.00-39.00 g/L, about 39.00-40.00 g/L, about 40.00-41.00 g/L, about 41.00-42.00 g/L, about 42.00-43.00 g/L, about 43.00-44.00 g/L, about 44.00-45.00 g/L, about 45.00-46.00 g/L, about 46.00-47.00 g/L, about 47.00-48.00 g/L, about 48.00-49.00 g/L, and about 49.00-50.00 g/L in a liquid formulation of interest.

In one embodiment, 14.1 g boron/L concentration (B1044) is achieved by dissolving 1044 grams of 20.5% boron into 4 gallons of water. In one embodiment, 17.6 g boron/L concentration (B1300) is achieved by dissolving 1300 grams of 20.5% boron into 4 gallons of water. In one embodiment, 19.4 g boron/L concentration (B1440) is achieved by dissolving 1440 grams of 20.5% boron into 4 gallons of water. In one embodiment, 35.2 g boron/L concentration (B2600) is achieved by dissolving 2600 grams of 20.5% boron into 4 gallons of water.

In one embodiment, the phytotoxic micronutrient comprising boron or a boron source can be prepared by dissolving boron or a boron source in cold water, room-temperature water, lukewarm water, warm water, hot water or boiling water.

In some embodiments, the phytotoxic micronutrients comprising boron or a boron source is in a liquid formulation.

In other embodiments, the phytotoxic micronutrients comprising boron or a boron source is in a dry formulation. In some embodiments, the dry formulation is a coarse granular form, fine granular form, or a powder form. In some embodiments, the phytotoxic micronutrients in powder form is more soluble than the phytotoxic micronutrients in a fine granular form. In some embodiments, the phytotoxic micronutrients in fine granular form is more soluble than the phytotoxic micronutrients in a coarse granular form.

In some embodiments, the phytotoxic micronutrients comprising boron or a boron source is in a dry formulation comprising about 5% to about 40% elemental boron by weight of the phytotoxic micronutrients, or any value and subranges there between. In some embodiments, the phytotoxic micronutrients comprising boron or a boron source is in a dry formulation comprising about 5% to about 30% elemental boron by weight of the phytotoxic micronutrients, and any value and subranges there between. In some embodiments, the phytotoxic micronutrients comprising boron or a boron source is in a dry formulation comprising about 10% to about 30% elemental boron by weight of the phytotoxic micronutrients, and any value and subranges there between. In some embodiments, the phytotoxic micronutrients comprising boron or a boron source is in a dry formulation comprising about 10% to about 25% elemental boron by weight of the phytotoxic micronutrients, and any value and subranges there between.

In some embodiments, the phytotoxic micronutrients comprising boron or a boron source is in a dry formulation comprising about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, and about 40%, elemental boron by weight of the phytotoxic micronutrients.

In one embodiment, the rates of application of the phytotoxic micronutrients comprising boron or a boron source is at about 1 lbs. to about 200 lbs. of elemental boron per acre, and any value and subranges there between. In some embodiments, the rates of application of the phytotoxic micronutrients comprising boron or a boron source is at about 5 lbs. to about 160 lbs. of elemental boron per acre, and any value and subranges there between. In some embodiments, the rates of application of the phytotoxic micronutrients comprising boron or a boron source is at about 5 lbs., about 10 lbs., 15 lbs., about 20 lbs., 25 lbs., about 30 lbs., 35 lbs., about 40 lbs., 45 lbs., about 50 lbs., 55 lbs., about 60 lbs., 65 lbs., about 70 lbs., 75 lbs., about 80 lbs., 85 lbs., about 90 lbs., 95 lbs., about 100 lbs., 105 lbs., about 110 lbs., 115 lbs., about 120 lbs., 125 lbs., about 130 lbs., about 135 lbs., about 140 lbs., about 145 lbs., about 150 lbs. about 155 lbs., or about 160 lbs. of elemental boron per acre.

In some embodiments, the rates of application of the phytotoxic micronutrients comprising boron or a boron source for turf and range treatment of weeds is at about 5 lbs. to about 160 lbs. of elemental boron per acre, and any value and subranges there between. In some embodiments, the rates of application of the phytotoxic micronutrients comprising boron or a boron source for turf and range treatment of weeds is at about 8-100 lbs. of elemental boron per acre. In other embodiments, the rates of application of the phytotoxic micronutrients comprising boron or a boron source for turf and range treatment of weeds is at about 9 lbs. of elemental boron per acre, about 25 lbs. of elemental boron per acre, about 50 lbs. of elemental boron per acre, about 75 lbs. of elemental boron per acre and about 100 lbs. of elemental boron per acre.

In some embodiments, the rates of application of the phytotoxic micronutrients comprising boron or a boron source for rangeland treatment of invasive species is at about 5 lbs. to about 160 lbs. of elemental boron per acre, and any value and subranges there between. In some embodiments, the rates of application of the phytotoxic micronutrients comprising boron or a boron source for rangeland treatment of invasive species is at about 5 lbs., about 10 lbs., 15 lbs., about 20 lbs., 25 lbs., about 30 lbs., 35 lbs., about 40 lbs., 45 lbs., about 50 lbs., 55 lbs., about 60 lbs., 65 lbs., about 70 lbs., 75 lbs., about 80 lbs., 85 lbs., about 90 lbs., 95 lbs., about 100 lbs., 105 lbs., about 110 lbs., 115 lbs., about 120 lbs., 125 lbs., about 130 lbs., about 135 lbs., about 140 lbs., about 145 lbs., about 150 lbs. about 155 lbs., or about 160 lbs. of elemental boron per acre.

In some embodiments, the rates of application of the phytotoxic micronutrients comprising boron or a boron source for rangeland treatment of cheatgrass and/or noxious weeds (including, but not limited to knapweed, thistle, etc. also listed in Tables 1 and 2) is at about 5 lbs., about 10 lbs., 15 lbs., about 20 lbs., 25 lbs., about 30 lbs., 35 lbs., about 40 lbs., 45 lbs., about 50 lbs., 55 lbs., about 60 lbs., 65 lbs., about 70 lbs., 75 lbs., about 80 lbs., 85 lbs., about 90 lbs., 95 lbs., about 100 lbs., 105 lbs., about 110 lbs., 115 lbs., about 120 lbs., 125 lbs., about 130 lbs., about 135 lbs., about 140 lbs., about 145 lbs., about 150 lbs. about 155 lbs., or about 160 lbs. of elemental boron per acre.

In one embodiment, the phytotoxic micronutrients comprising boron or a boron source for rangeland treatment of cheatgrass and/or noxious weeds (including, but not limited to knapweed, thistle, etc. also listed in Tables 1 and 2) is in a dry formulation (that is a granular formulation), which can be applied at a rate of about 25 lbs. to about 100 lbs. of elemental boron per acre, and any value and subranges there between. In some embodiments, the dry formulation can be applied to the soil.

In one embodiment, the phytotoxic micronutrients comprising boron or a boron source for rangeland treatment of cheatgrass and/or noxious weeds (including, but not limited to knapweed, thistle, etc. also listed in Tables 1 and 2) is in a liquid formulation, which can be applied at a rate of about 9 lbs. to about 128 lbs. of elemental boron per acre, and any value and subranges there between. In some embodiments, the liquid formulation can be applied to the plant tissue.

In some embodiments, the rates of application of the phytotoxic micronutrients comprising boron or a boron source for turf treatment of invasive species is at about 5 lbs. to about 100 lbs. of elemental boron per acre, and any value and subranges there between. In some embodiments, the rates of application of the phytotoxic micronutrients comprising boron or a boron source for turf treatment of invasive species is at about 5 lbs., about 10 lbs., 15 lbs., about 20 lbs., 25 lbs., about 30 lbs., 35 lbs., about 40 lbs., 45 lbs., about 50 lbs., 55 lbs., about 60 lbs., 65 lbs., about 70 lbs., 75 lbs., about 80 lbs., 85 lbs., about 90 lbs., 95 lbs., about 100 lbs., 105 lbs., about 110 lbs., 115 lbs., about 120 lbs., 125 lbs., about 130 lbs., about 135 lbs., about 140 lbs., about 145 lbs., about 150 lbs. about 155 lbs., or about 160 lbs. of elemental boron per acre.

In some embodiments, the rates of application of the phytotoxic micronutrients comprising boron or a boron source for turf treatment of dandelions is at about 5 lbs., about 10 lbs., 15 lbs., about 20 lbs., 25 lbs., about 30 lbs., 35 lbs., about 40 lbs., 45 lbs., about 50 lbs., 55 lbs., about 60 lbs., 65 lbs., about 70 lbs., 75 lbs., about 80 lbs., 85 lbs., about 90 lbs., 95 lbs., about 100 lbs., 105 lbs., about 110 lbs., 115 lbs., about 120 lbs., 125 lbs., about 130 lbs., about 135 lbs., about 140 lbs., about 145 lbs., about 150 lbs. about 155 lbs., or about 160 lbs. of elemental boron per acre. In other embodiments, dandelion is treated with B+N as it controls dandelion and the N minimizes grass stress. In one embodiments, B+N is applied in the fall to control dandelions in the next growing season. In another embodiments, B+N is applied in the spring. In further embodiments, foliar Cu is applied together with B+N treatment. The Cu defoliates the broad leaf plants and the plants can not grow back from the roots with all the B+N. Foliar Cu is applied alone and also rapidly defoliates broadleaf weeds. However, the weeds may grow back later absent of the B+N in the soil.

In some embodiments, the rates of application of the phytotoxic micronutrients comprising boron or a boron source for turf treatment of clovers is at about 5 lbs., about 10 lbs., 15 lbs., about 20 lbs., 25 lbs., about 30 lbs., 35 lbs., about 40 lbs., 45 lbs., about 50 lbs., 55 lbs., about 60 lbs., 65 lbs., about 70 lbs., 75 lbs., about 80 lbs., 85 lbs., about 90 lbs., 95 lbs., about 100 lbs., 105 lbs., about 110 lbs., 115 lbs., about 120 lbs., 125 lbs., about 130 lbs., about 135 lbs., about 140 lbs., about 145 lbs., about 150 lbs. about 155 lbs., or about 160 lbs. of elemental boron per acre. In some embodiments, the rates of application of the phytotoxic micronutrients comprising boron or a boron source for turf treatment of clovers is at about 50 lbs.

In some embodiments, the rates of application of the phytotoxic micronutrients comprising boron or a boron source for turf treatment of dandelions, clovers and/or noxious weeds (including, but not limited to knapweed, thistle, etc. also listed in Tables 1 and 2) is at about 5 lbs., about 10 lbs., 15 lbs., about 20 lbs., 25 lbs., about 30 lbs., 35 lbs., about 40 lbs., 45 lbs., about 50 lbs., 55 lbs., about 60 lbs., 65 lbs., about 70 lbs., 75 lbs., about 80 lbs., 85 lbs., about 90 lbs., 95 lbs., about 100 lbs., 105 lbs., about 110 lbs., 115 lbs., about 120 lbs., 125 lbs., about 130 lbs., about 135 lbs., about 140 lbs., about 145 lbs., about 150 lbs. about 155 lbs., or about 160 lbs. of elemental boron per acre.

In one embodiment, the phytotoxic micronutrients comprising boron or a boron source for turf treatment of dandelions, clovers and/or noxious weeds (including, but not limited to knapweed, thistle, etc. also listed in Tables 1 and 2) is in a dry/granular formulation, which can be applied at a rate of about 25 lbs. to about 100 lbs. of elemental boron per acre, and any value and subranges there between. In some embodiments, the dry formulation can be applied to the soil.

In one embodiment, the phytotoxic micronutrients comprising boron or a boron source for turf treatment of dandelions, clovers and/or noxious weeds (including, but not limited to knapweed, thistle, etc., also listed in Tables 1 and 2) is in a liquid formulation, which can be applied at a rate of about 9 lbs. to about 128 lbs. of elemental boron per acre, and any value and subranges there between. In some embodiments, the liquid formulation can be applied to the plant tissue.

In some embodiments, the rates of application of the phytotoxic micronutrients comprising boron or a boron source for a glyphosate-like treatment of invasive species is at about 50 lbs. to about 300 lbs. of elemental boron per acre, and any value and subranges there between. In some embodiments, the rates of application of the phytotoxic micronutrients comprising boron or a boron source for a glyphosate-like treatment of invasive species by a dry granular treatment can be at about 100-300 pounds/acre. In some embodiments, the rates of application of the phytotoxic micronutrients comprising boron or a boron source for a glyphosate-like treatment of invasive species by a liquid foliar treatment can be at about 100-200 pounds/acre.

In some embodiments, the rates of application of the phytotoxic micronutrients comprising boron or a boron source for rangeland treatment of invasive species is at about 50 lbs., about 60 lbs., 65 lbs., about 70 lbs., 75 lbs., about 80 lbs., 85 lbs., about 90 lbs., 95 lbs., about 100 lbs., 105 lbs., about 110 lbs., 115 lbs., about 120 lbs., 125 lbs., about 130 lbs., about 135 lbs., about 140 lbs., about 145 lbs., about 150 lbs. about 155 lbs., about 160 lbs., about 170 lbs, about 180 lbs, about 190 lbs, about 200 lbs, about 250 lbs or about 300 lbs of elemental boron per acre. In some embodiments, the rates of application of the phytotoxic micronutrients comprising boron or a boron source for a glyphosate-like treatment of invasive species is at about 100 lbs. to about 200 lbs.

In some embodiments, the rates of application of the phytotoxic micronutrients comprising boron or a boron source for glyphosate-like like treatment of grasses and/or forbs is at about 100 lbs. to about 200 lbs. of elemental boron per acre. In some embodiments, the rates of application of the phytotoxic micronutrients comprising boron or a boron source for glyphosate-like like treatment of grasses and/or forbs is at about 100 lbs., 105 lbs., about 110 lbs., 115 lbs., about 120 lbs., 125 lbs., about 130 lbs., about 135 lbs., about 140 lbs., about 145 lbs., about 150 lbs. about 155 lbs., about 160 lbs. or up to 300 lbs of elemental boron per acre.

In one embodiment, the phytotoxic micronutrients comprising boron or a boron source for glyphosate-like like treatment of grasses and/or forbs listed in Tables 1 and 2 is in a dry/granular formulation, which can be applied at a rate of about 100 lbs. to about 300 lbs. of elemental boron per acre, and any value and subranges there between. In some embodiments, the dry formulation can be applied to the soil.

In one embodiment, the phytotoxic micronutrients comprising boron or a boron source for glyphosate-like like treatment of grasses and/or forbs listed in Tables 1 and 2 is in a liquid formulation, which can be applied at a rate of about 100 lbs. to about 200 lbs. of elemental boron per acre, and any value and subranges there between. In some embodiments, the liquid formulation can be applied to the plant tissue.

The foliar application method can be applied for many of the species listed in table 1 and at comparatively low rates compared to the granular approach because granular applications can be diluted as they dissolve and prior to plant uptake. With foliar the plant is rapidly effected as the plant experiences the full concentration in the plant tissue, while granular lasts longer and has a better effect on seed germination in subsequent years.

When the phytotoxic micronutrients comprising boron or a boron source is applied as a dry, spreadable powder, some source of boron is crystalline, powdered boric acid, or in other boron-containing compounds. In an embodiment, the application of a dry formulation of boron containing phytotoxic micronutrients can be in a flowable form.

TABLE 1
Listing of invasive plant species that may be controlled through application of
phytotoxic micronutrient compounds resulting in highly efficacious control.

| Applicability | | | Type/ | Common | | Granular or |
|---|---|---|---|---|---|---|
| Rangeland | Turf | Crop | Lifeform | Name | Scientific Name | Foliar Best |
| X | | | Annual Grass | Cheatgrass | Bromus tectorum | Both/Granular |
| X | X | X | Perennial Forb | Knapweed | Centaurea stoebe | Both |
| X | X | X | Perennial forb | Canadian Thistle | Circium arvense | Foliar |
| X | X | | Perennial forb | Common Yarrow | Achillea | Foliar |
| | | | | | millefolium | |
| X | X | | Biennial forb | Musk/Bull Thistle | Cirsium vulgare | Foliar |
| X | X | | Annual forb | Pineapple Weed | Matricaria | Foliar |
| | | | | | matricariodes | |
| X | X | | Perennial folb | Common Tansy | Tanacetum | Both |
| | | | | | vulgare | |
| X | X | | Biennial forb | Salsify | Tragopogon | Foliar |
| | | | | | dubious | |
| X | | | Perennial forb | St Johnswort | Hypericum | Granular |
| | | | | | perforatum | |
| X | X | | Perennial forb | Hoary Alyssum | Berteroa incana | Foliar |
| X | | | Annual forb | Miner's lettuce | Montia perfoliata | Both |
| X | X | | Perennial forb | Yellow toadflax | Linaria vulgaris | Foliar |
| X | X | X | Perennial forb | Dandelion | Taraxacum | Foliar |
| | | | | | officinale | |
| X | X | X | Perennial forb | White Clover | Trifolium repens | Both |
| X | X | X | Annual or perennial | Black Medic | Medicago | Both/Foliar |
| | | | | | lupulina | |
| X | X | X | Annual forb | Prostrate Knotweed | Polygonum | Foliar |
| | | | | | aviculare | |
| X | X | X | Annual forb | Common Mallow | Malva neglecta | Foliar |
| X | X | X | Perennial forb | Broadleaf Plantain | Plantago major | Both |
| X | X | X | Perennial forb | Oxeye Daisy | Chrysanthemum | Both |
| | | | | | leucanthemum | |
| X | X | | Annual Grass | Witchgrass | Panicum capillare | Foliar |
| X | X | X | Perennial forb | Leafy Spurge | Euphorbia esula | Foliar |
| | X | | Perennial forb | Creeping buttercup | Ranunculus | Foliar |
| | | | | | repens | |
| X | X | | Perennial forb | Birdsfoot trefoil | Lotus | Foliar |
| | | | | | corniculatus | |
| X | | | Perennial forb | Bittersweet | Solanum | Foliar |
| | | | | nightshade | dulcamara | |
| X | X | | Perennial forb | Creeping bellflower | Campanula | Both |
| | | | | | rapunculoides | |
| X | | | Biennial forb | Common mullein | Verbascum | Foliar |
| | | | | | thapsus | |

TABLE 2
Listing of invasive plant species that may be controlled through application of
phytotoxic micronutrient compounds resulting in moderately efficacious control.

| Applicability | | | Type/ | Common | | Granular or |
|---|---|---|---|---|---|---|
| Rangeland | Turf | Crop | Lifeform | Name | Scientific Name | Foliar Best |
| X | | X | Annual forb | Kochia | Kochia scoparia | Foliar |
| X | X | | Biennial forb | Burdock | Arctium minus | Foliar |
| X | X | | Perennial forb | Mayweed chamomile | Anthemis cotula | Foliar |
| X | | | Biennial forb | Prickly Lettuce | Latuca serriola | Foliar |
| X | X | | Biennial forb | Houndstongue | Cynoglossum | Foliar |
| | | | | | officinale | |
| X | | | Perennial forb | Whitetop/Hoary cress | Cardaria draba | Foliar |
| X | | | Annual forb | Lambsquarter | Chenopodium | Foliar |
| | | | | | berlandieri | |
| X | X | | Annual forb | Russian thistle | Salsola iberica | Foliar |
| X | | | Perennial forb | Dalmation toadflax | Linaria genistifolia | Granular |
| X | | | Annual forb | Black Henbane | Hyoscyamus niger | Foliar |
| X | X | X | Perennial forb | Field Bindweed | Convolvulus | Foliar |
| | | | | | arvensis | |
| X | X | X | Annual forb | Tumble Pigweed | Amaranthus albus | Foliar |
| X | X | | Vine | Poison Ivy | Toxicodendron | Foliar |
| | | | | | radicans | |
| X | X | | Tree | Aspen (root suckers) | Populous | Foliar (roots) |
| | | | | | tremuloides | |
| X | | | Annual grass | Medusahead | Taeniatherum | Granular |
| | | | | | caput-medusae | |
| X | X | X | Biennial forb | Yellow sweetclover | Melilotus officinale | Both |
| X | | | Tree | Common buckthorn | Rhamnus cathartica | Both |

Tables 1 and 2 present lists of the High and Moderate Efficacy Species. Most annual grasses and forbs appear to be negatively effected by micronutrient application. Perennial grasses show species variation, but most are tolerant of granular and foliar micronutrient application especially if Boron is accompanied by Nitrogen.

Applying a boron-containing formulation to weed seeds, weed seedlings, and/or weed plants functions by disrupting the target species cell physiology when moisture-containing boron is imbibed by the seed or seedling from the soil. While control of invasive plant species is the outcome of the disclosure, the applications of micronutrients are intended to change the soil chemistry and favorably change the function of the plant-soil biogeochemical system. The soil is the host of the micronutrients delivered to the invasive plant species. In each application embodiment, whether liquid or dry, the applied boron is made plant-available through either dissolution by rainfall, snowmelt or other environmental conditions, or plant uptake of the liquid application, and is therefore plant-available regardless of the form of application. The actual mechanism of boron involvement in plant physiology remains somewhat unclear. There is a very narrow window between the levels of boron required by and toxic to plants. The subject disclosure discloses the specific, narrow window of concentrations of boron toxic to invasive plant species, thereby allowing control by application of boron concentrations in excess of invasive plant species toxic limits, yet below levels toxic to desirable species.

Another embodiment of the application of the phytotoxic micronutrients entails measuring the amount of plant-available boron in the soil in the target area and adding supplemental boron to achieve an effective level harmful to invasive plant species, but not harmful to desirable vegetation (also referred to as the Induced Phytotoxicity Threshold or IPT). Under this embodiment, the naturally occurring soil boron level is measured therein establishing a baseline boron concentration. This method is made possible by laboratory, greenhouse and field-testing of common plant species and development of unique characteristic dose-response curves identifying plant growth characteristics resulting from varying the water soluble boron concentrations across the range of about 0.5 to about 50 mg/L. The novel finding that facilitates the disclosure is the sensitivity of invasive plants species to low levels of water soluble soil boron compared to desirable plant species found on rangeland or other environments.

As well known to those skilled in the art, application rates can be calculated based on the purity of the micronutrient in the composition being applied. For example, if one wants to apply 50 lbs. of boron per acre and the coarse granular fertilizer has a boron purity of 14.3%, then 349.7 lbs. of the fertilizer must be applied per acre. For a fine granular fertilizer with a boron purity of 15%, the amount of fertilizer to be applied would be 333.3 lbs. per acre. If a powder fertilizer had a boron purity of 20.5%, then 243.9 lbs. must be applied per acre. The solubility of each type of these fertilizers in water is, in general, low, moderate and high, respectively.

Each of the embodiments of the present disclosure as described herein for preparation and application of boron are similarly applicable to formulations containing the other micronutrients useful for this disclosure. Such formulations containing the other micronutrients, or combinations thereof, may be similarly prepared and applied to a target area, depending on the invasive species that is to be controlled or eradicated and the IPT for that species, micronutrient and target area soil conditions or preexisting micronutrient levels.

Boron toxicity to invasive plant species appears to cause significant changes in the physiology and activity of numerous enzymes in seed and seedling development, and consequently plant metabolism during the life cycle of the plant. Three main candidates for boron toxicity involve the ability of boron to bind compounds with two hydroxyl groups in the cis-configuration: (a) alteration of cell wall structure; (b) metabolic disruption by binding to the ribose moieties of molecules such as adenosine triphosphate (ATP), nicotinamide adenine dinucleotide; and (c) disruption of cell division and development by binding to ribose, either as a free sugar or within RNA. However, the only defined physiological role of boron in plants is as a cross-linking molecule involving reversible covalent bonds with cis-diols on either side of borate. Because boronic acids cannot cross-link two molecules, the addition of boronic acids causes the disruption of cytoplasmic strands and cell-to-cell wall detachment. Boronic acids appear to specifically disrupt or prevent borate-dependent cross-links important for the structural integrity of the cell, including the organization of transvacuolar cytoplasmic strands. Boron likely plays a structural role in the plant cytoskeleton. Absent of sufficient levels of soil boron naturally occurring invasive plant toxicity cannot occur.

Many variations of the phytotoxic micronutrients will occur to those skilled in the art. Some variations include plant micronutrients in addition to or in place of boron. Known plant micronutrients include boron, copper, zinc, manganese, iron, chlorine and molybdenum. Other variations call for variations and ranges of the concentrations of each element being applied, and the compound source for the micronutrient. Other variations include application of combinations of more than one plant micronutrient. Other variations include application of micronutrients with macronutrients nitrogen (N), phosphorous (P) potassium (K) or secondary nutrients calcium (Ca), magnesium (Mg) and sulfur (S). Additional variations include the targeted invasive plant species subject to control or eradication. Additional variations include the type of site or landscape the methods and compositions of this disclosure may be applied to. There are many different techniques, which may be used to apply or distribute a specific form of the compounds (whether liquid or dry). The application rate can be adjusted across a range from low to high concentration to reduce, control, and eliminate/eradicate a particular invasive plant species or species. The timing of application can be varied depending on seasonal moisture and climatic factors to achieve the optimal result. The application rate for treatment of existing invasive plants can be adjusted downward and applied to protect against future invasion by invasive species. The application rate can also be applied at such levels to cause a phytotoxic condition for all plants resulting in bare ground. All such variations are intended to be within the scope and spirit of the disclosure.

Although some embodiments are shown to include certain features or steps, the applicant specifically contemplates that any feature or step disclosed herein may be used together or in combination with any other feature or step in any embodiment of the disclosure. It is also contemplated that any feature or step may be specifically excluded from any embodiment of the disclosure.

The utility of the phytotoxic micronutrients is multi-fold and includes but is not limited to:
a) usefulness for control or eradication of invasive plant species currently occupying more than 100 million acres in the U.S.;
b) can comprise non-synthetic, non-organic naturally occurring inorganic earth elements, which are known plant nutrients, non-carcinogenic and non-impairing to soil and water resources at the low concentrations involved in this disclosure;
c) can be relatively inexpensive, easily accessible materials, combined with relatively simplified methods of utilization;
d) boron sources such as boric acid, borate salts or boron (and the other micronutrients of the disclosure) are neither classified as endocrine disruptors nor are they currently on the list of compounds being screened by the U.S. EPA as part of the Endocrine Disruptor Screening Program (EDSP) for potential in humans;
e) boron sources such as boric acid and borate salts (and the other micronutrients of the disclosure) are classified by the U.S. EPA as “not likely to be carcinogenic to humans” under the 2005 carcinogen assessment guidelines;
f) no reported risk from occupational exposures studies indicating the carcinogenicity of boric acid, borate salts or boron (and the other micronutrients of the disclosure);
g) the effectiveness and use of the subject disclosure is facilitated by the application of relatively small/minute amounts of material required to treat large areas of land;
h) selective to weedy plant species, allowing the phytotoxic micronutrients to be used on land parcels of mixed plant communities without significant adverse impact on desired plant species;
i) application of low concentrations of micronutrient-containing compositions to plants, seeds, seedlings or soil which results in phytotoxic responses of weedy species while minimizing impact to existing desirable native plant species; and,
j) has potential applications to a wide variety of cropping systems including but not limited to rangelands, golf courses, pastures, meadows, flooded fields (e.g., rice), bogs or marshes (e.g., cranberries), orchards (e.g., oranges, avocadoes, apples, peaches), row cropping systems (e.g., corn/maize, oats, wheat, soybean, cotton), arbor or trellis systems (e.g., grapes, snap peas), and hill plantings (e.g., melons, squash, cucumbers, sweet corn, okra).

The low rates of the application for the phytotoxic micronutrients are also manifested in low unit cost per land area treated.

Extensive research has documented that some plants are sensitive to relatively minute concentrations or exposures to unique synthetic compounds or combinations of naturally occurring elements, including micronutrients. For example, glyphosate (aka ROUNDUP®, a synthetic Monsanto product) is effective at causing photosynthetic disruption in chlorophyllitic plants at an application rate of as little as 0.75 pounds active ingredient per acre, which equates to only approximately 8 mg/square foot of application. The American Phytopathological Society (APS) reported that micronutrients are generally toxic when present in high amounts, although ‘high concentrations’ are not clearly defined, and little toxicity have been reported at exceptionally low micronutrient concentrations. Choi et al. (1996) reported micro-nutrient toxicity in French marigold induced from boron, copper, iron, manganese, molybdenum, and zinc at concentrations of 0.5 mM B, 4 mM Cu, 4 mM Fe, 2 mM Mn, 1 mM Mo and 5 mM Zn, respectively. In addition, plants can vary considerably from species to species in their susceptibility to nutrient toxicities. For example, Lee et al. (1996) reported inducing seed geranium (Pelargonium×hortorum) micronutrient toxicity symptoms by applying nutrient solutions containing 0.5 mM B, 0.5 mM Cu, 0.5 mM Fe, 1 mM Mn, 0.5 mM Zn, or as little as 0.25 mM Mo, in combination with nitrogen, phosphorus, and potassium. Micronutrient toxicity has also been reported for Begonia, Chrysanthemum, Geraniums, Marigolds, Poinsettia, and Lilium longiflorum (Hammer et al. 1987; Choi et al. 1996; Lee et al. 1996; Marousky, 1981). Thus, the prior art teaches that even low levels of micronutrients in the soil solution may reduce the growth of some species and especially horticultural varieties.

The toxic effects of excessive application of nutrients to agricultural and horticultural crops are well documented. Even the macronutrient nitrogen can be toxic to plants if applied in excess. Similarly, excessive application of micronutrients can cause phytotoxic effects. However, excessive micronutrient concentrations are rarely found in native soils, with the exception of mineralized areas. In mineral soils, release of micronutrients is usually quite slow. Much of the available soil micronutrients are held rather tightly by soil organic material and thus toxicity to plants is not a frequent occurrence under ‘field’ conditions. For the majority of landscape plants micronutrient concentrations are measured in the saturated soil paste extract between 0.15-0.5 parts per million. Depending on plant sensitivity, some of these elements can be toxic at soil test concentrations above one part per million. Nutrient toxicity does not often occur in most arable soils. Such toxicity exerts different effects on very diverse processes in vascular plants, such as altered metabolism, reduced root cell division, lower leaf chlorophyll contents and photosynthetic rates, and decreased lignin and suberin levels, among others (Nable et. al. 1997; Reid 2007b). Accordingly, reduced growth of shoots and roots is typical of plants exposed to high micronutrient levels (Nable et al. 1990). Referring to Keren and Bingham (1985), safe concentrations of micro-nutrients in irrigation water range from 0.3 mg/L for sensitive agronomic plants [i.e. avocado (Persea americana), apple (Malus domestica) and bean (Phaseolus vulgaris)], 1-2 mg/L for semi tolerant plants [oat (Avena sativa), maize (Zea mays), potato (Solanum tuberosum)], and 2-4 mg/L for tolerant plants [i.e. carrot (Daucus carota), alfalfa (Medicago sativa) and sugar beet (Beta vulgaris)]. In research performed to evaluate the boron tolerance of rangeland plants Munshower and others (2006) found that selected grasses and forbs performed adequately when grown in greenhouse trials in solution concentrations up to 40 mg B/L. In the study the perennial grass species thickspike wheatgrass (Elymus lanceolatus), Indian ricegrass (Achnatherum hymenoides) and Beardless wheatgrass (Pseudoroegneria spicata) performed better than the forb silky lupine (Lupinus sericeus) which showed reduced performance (FIGS. 7 and 8). Thus, the findings of the present invention that higher levels of micronutrients can damage invasive plants and not harm or even benefit desirable plants is consistent with previous studies of rangeland plants grown in boron solutions yet control of weeds by this invention in agronomic systems would require careful consideration of the desirable plants in cultivation and their respective nutritional needs. The literature generally provides few examples of the nutritional needs of invasive plants as they are not commonly studied to determine either toxic thresholds or optimal fertility conditions

### V. Phytotoxic Micronutrients Comprising Copper or a Copper Source

In one embodiment, the phytotoxic micronutrient comprises copper or a copper source. In some embodiments, a copper source can be selected from Copper chelate (Na₂CuEDTA), Copper sulfate (CuSO₄.5H₂O), Cupric oxide CuO, and Cuprous oxide (Cu₂O).

TABLE 3
Fertilizer sources of copper.

| Source | Formula | % Copper by weight |
|---|---|---|
| Copper chelate | Na₂CuEDTA | 13 |
| Copper sulfate | CuSO₄•5H₂O | 25 |
| Cupric oxide | CuO | 75 |
| Cuprous oxide | Cu₂O | 89 |

Table 3 shows the percentage of elemental copper by weight in each of the listed copper source. Thus, in order to apply the phytotoxic micronutrients at a rate of 10 pounds/acre of copper using the Na₂CuEDTA, 76.9 pounds of Na₂CuEDTA will be required as the copper content in the Na₂CuEDTA is 13% by weight. Similarly, for the same rate of copper application, 40 pounds copper sulfate will be required per acre, or 13 pounds of cupric oxide per acre, or 11.2 pounds of cuprous oxide per acre.

Whether the phytotoxic micronutrient is applied as a dry formulation or as a liquid formulation is irrelevant as the objective is to achieve the desired amount of the micronutrients in the soil to favor the species desired and reduce or eliminate the invasive weedy species.

In some embodiments of the present disclosure, the phytotoxic micronutrients comprising copper or a copper source is applied to a locus to achieve copper soil concentration ranges as follows (including any and all concentrations between these ranges): 1-25 mg/Kg, 25-50 mg/Kg, 50-75 mg/Kg, 75-100 mg/Kg, 100-125 mg/Kg, 125-150 mg/Kg, 150-175 mg/Kg, 175-200 mg/Kg, 200-225 mg/Kg, 225-250 mg/Kg, 250-275 mg/Kg, 275-300 mg/Kg, 300-325 mg/Kg, 325-350 mg/Kg, 350-375 mg/Kg, 375-400 mg/Kg, 400-425 mg/Kg, 425-450 mg/Kg, 450-475 mg/Kg, 475-500 mg/Kg, 500-525 mg/Kg, 525-550 mg/Kg, 550-575 mg/Kg, 575-600 mg/Kg, 600-625 mg/Kg, 625-650 mg/Kg, 650-675 mg/Kg, 675-700 mg/Kg, 700-725 mg/Kg, 725-750 mg/Kg, 750-775 mg/Kg, 775-800 mg/Kg, 800-825 mg/Kg, 825-850 mg/Kg, 850-875 mg/Kg, 875-900 mg/Kg, 900-925 mg/Kg, 925-950 mg/Kg, 950-975 mg/Kg, 975-1000 milligrams of copper per kilogram of soil.

In other embodiments of the present disclosure, copper micronutrient is applied to a locus to achieve a soil copper concentration of about: 25 mg/Kg, 50 mg/Kg, 75 mg/Kg, 100 mg/Kg, 125 mg/Kg, 150 mg/Kg, 175 mg/Kg, 200 mg/Kg, 225 mg/Kg, 250 mg/Kg, 275 mg/Kg, 300 mg/Kg, 325 mg/Kg, 350 mg/Kg, 375 mg/Kg, 400 mg/Kg, 425 mg/Kg, 450 mg/Kg, 475 mg/Kg, 500 mg/Kg, 525 mg/Kg, 550 mg/Kg, 575 mg/Kg, 600 mg/Kg, 625 mg/Kg, 650 mg/Kg, 675 mg/Kg, 700 mg/Kg, 725 mg/Kg, 750 mg/Kg, 775 mg/Kg, 800 mg/Kg, 825 mg/Kg, 850 mg/Kg, 875 mg/Kg, 900 mg/Kg, 925 mg/Kg, 950 mg/Kg, 975 mg/Kg, 1000 milligrams of copper per kilogram of soil.

Copper compounds vary in solubility. Therefore, the plant-available amounts of copper will vary in the soil in accordance to the mineral form of copper and their respective solubility. For example, copper fertilizers might be as much as 50% soluble while copper fallout from a smelter might be less than 1% soluble. Likewise, soil acidity is an important control on copper solubility. For a given total elemental amount of copper, the plant availability (solubility) may vary by orders of magnitude in accordance with the soil pH. Because copper is a heavy metal, any extraneous application of copper must consider that excessive amounts of copper can be harmful to the environment and to animals, including humans. For guidance on safe levels, see the U.S. Department of Health and Human Services, Agency for Toxic Substances and Disease Registry (ATSDR), Toxic Substances—Copper.

In some embodiments of the present disclosure, the phytotoxic micronutrients comprising copper or a copper source is applied to a locus to achieve a soluble copper soil concentration of about: 0.01 mg/L, 0.02 mg/L, 0.03 mg/L, 0.04 mg/L, 0.05 mg/L, 0.06 mg/L, 0.07 mg/L, 0.08 mg/L, 0.09 mg/L, 0.10 mg/L, 0.15 mg/L, 0.20 mg/L, 0.25 mg/L, 0.30 mg/L, 0.35 mg/L, 0.40 mg/L, 0.45 mg/L, 0.50 mg/L, 0.55 mg/L, 0.60 mg/L, 0.65 mg/L, 0.70 mg/L, 0.75 mg/L, 0.80 mg/L, 0.85 mg/L, 0.90 mg/L, 0.95 mg/L, 1.00 mg/L, 1.50 mg/L, 2.00 mg/L, 2.50 mg/L, 3.00 mg/L, 3.50 mg/L, 4.00 mg/L, 4.50 mg/L, 5.00 mg/L, 5.50 mg/L, 6.00 mg/L, 6.50 mg/L, 7.00 mg/L, 7.50 mg/L, 8.00 mg/L, 8.50 mg/L, 9.00 mg/L, 9.50 mg/L, 10.00 mg/L of soil.

In other embodiments of the present disclosure, the phytotoxic micronutrients comprising copper or a copper source is applied to a locus to achieve soluble copper soil concentration ranges as follows (including any/all concentrations between these ranges): 0.01-0.02 mg/L, 0.02-0.03 mg/L, 0.03-0.04 mg/L, 0.04-0.05 mg/L, 0.05-0.06 mg/L, 0.06-0.07 mg/L, 0.07-0.08 mg/L, 0.08-0.09 mg/L, 0.09-0.10 mg/L, 0.10-0.15 mg/L, 0.15-0.20 mg/L, 0.20-0.25 mg/L, 0.25-0.30 mg/L, 0.30-0.35 mg/L, 0.35-0.40 mg/L, 0.40-0.45 mg/L, 0.45-0.50 mg/L, 0.50-0.55 mg/L, 0.55-0.60 mg/L, 0.60-0.65 mg/L, 0.65-0.70 mg/L, 0.70-0.75 mg/L, 0.75-0.80 mg/L, 0.80-0.85 mg/L, 0.85-0.90 mg/L, 0.90-0.95 mg/L, 0.95-1.00 mg/L, 1.00-1.50 mg/L, 1.50-2.00 mg/L, 2.00-2.50 mg/L, 2.50-3.00 mg/L, 3.00-3.50 mg/L, 3.50-4.00 mg/L, 4.00-4.50 mg/L, 4.50-5.00 mg/L, 5.00-5.50 mg/L, 5.50-6.00 mg/L, 6.00-6.50 mg/L, 6.50-7.0 mg/L, 7.00-7.50 mg/L, 7.50-8.0 mg/L, 8.00-8.50 mg/L, 8.50-9.0 mg/L, 9.00-9.50 mg/L, 9.50-10.00 mg/L of soil. In one embodiment, the phytotoxic micronutrients comprising copper or a copper source is applied to a locus to achieve soluble copper soil concentration of about 0.1 mg/L to about 50 mg/L. In one embodiment, the phytotoxic micronutrients comprising copper or a copper source is applied to a locus to achieve soluble copper soil concentration of about 0.1 mg/L to about 5 mg/L.

### VI. Agricultural Compositions

The present disclosure provides a composition comprising at least one phytotoxic micronutrient disclosed herein. The present disclosure provides a composition comprising at least one phytotoxic macronutrient disclosed herein. The present disclosure also provides a combination comprising at least one phytotoxic micronutrient and another agricultural composition as described herein. The present disclosure also provides methods for using the composition or the combination of at least one phytotoxic micronutrient and at least one agricultural composition as described herein. The present disclosure further provides methods for using the composition or the combination of at least one phytotoxic micronutrient and at least one macronutrient as described herein, for a selective treatment of invasive species.

i. Micronutrients and Macronutrients

In some embodiments, the agricultural composition comprises micronutrients. In some embodiments, micronutrient is selected from copper, zinc, iron, boron, manganese, molybdenum, or chlorine.

In one embodiment, the agricultural composition comprises boron or a water soluble boron source. In some embodiments, the agricultural composition is applied at a rate to provide about 10 lbs. elemental boron to about 100 lbs. elemental boron per acre of land, or any value and subranges there between. In one embodiment, the agricultural composition is applied at a rate to provide average of about 20 lbs. elemental boron. In some embodiments, the agricultural composition is applied at a rate to provide fertility level of about 1 lb. elemental boron to about 10 lbs. elemental boron per acre of land. In some embodiments, the agricultural composition is applied at a rate to provide an average fertility level of about 3 lbs. of elemental boron per an acre of land.

In one embodiment, the agricultural composition comprises copper or a water soluble copper source. In some embodiments, the agricultural composition is applied at a rate to provide about 5 lbs. elemental copper to about 20 lbs. elemental copper per acre of land, or any value and subranges therebetween. In one embodiment, the agricultural composition is applied at a rate to provide average of about 10 lbs. elemental copper. In some embodiments, the agricultural composition is applied at a rate to provide fertility level of about 0.75 lb. elemental copper to about 5 lbs. elemental copper per acre of land. In some embodiments, the agricultural composition is applied at a rate to provide an average fertility level of about 2 lbs. of elemental copper per an acre of land.

In one embodiment, the agricultural composition comprises an iron or a water soluble iron source. In some embodiments, the agricultural composition is applied at a rate to provide about 5 lbs. elemental iron to about 20 lbs. elemental iron per acre of land, or any value and subranges therebetween. In one embodiment, the agricultural composition is applied at a rate to provide average of about 10 lbs. elemental iron. In some embodiments, the agricultural composition is applied at a rate to provide fertility level of about 0.25 lb. elemental iron to about 5 lbs. elemental iron per acre of land. In some embodiments, the agricultural composition is applied at a rate to provide an average fertility level of about 1.5 lbs. of elemental iron per an acre of land.

In one embodiment, the agricultural composition comprises a manganese or a manganese source. In some embodiments, the agricultural composition is applied at a rate to provide about 5 lbs. elemental manganese to about 15 lbs. elemental manganese per acre of land, or any value and subranges therebetween. In one embodiment, the agricultural composition is applied at a rate to provide average of about 10 lbs. elemental manganese. In some embodiments, the agricultural composition is applied at a rate to provide fertility level of about 0.75 lb. elemental manganese to about 4.65 lbs. elemental manganese per acre of land. In some embodiments, the agricultural composition is applied at a rate to provide an average fertility level of about 2.3 lbs. of elemental manganese per an acre of land.

In one embodiment, the agricultural composition comprises a molybdenum or a molybdenum source. In some embodiments, the agricultural composition is applied at a rate to provide about 2 lbs. elemental molybdenum to about 10 lbs. elemental molybdenum per acre of land, or any value and subranges therebetween. In one embodiment, the agricultural composition is applied at a rate to provide average of about 5 lbs. elemental molybdenum. In some embodiments, the agricultural composition is applied at a rate to provide fertility level of about 0.78 lb. elemental molybdenum to about 6.6 lbs. elemental molybdenum per acre of land. In some embodiments, the agricultural composition is applied at a rate to provide an average fertility level of about 2.6 lbs. of elemental molybdenum per an acre of land.

In one embodiment, the agricultural composition comprises a zinc or a water soluble zinc source. In some embodiments, the agricultural composition is applied at a rate to provide about 5 lbs. elemental zinc to about 20 lbs. elemental zinc per acre of land, or any value and subranges therebetween. In one embodiment, the agricultural composition is applied at a rate to provide average of about 10 lbs. elemental zinc. In some embodiments, the agricultural composition is applied at a rate to provide fertility level of about 0.5 lb. elemental zinc to about 7 lbs. elemental zinc per acre of land. In some embodiments, the agricultural composition is applied at a rate to provide an average fertility level of about 2.25 lbs. of elemental zinc per an acre of land.

In other embodiments, the agricultural composition comprises macronutrients. In some embodiments, macronutrient is selected from nitrogen, phosphorous, potassium, calcium, magnesium or sulfur. In some embodiments, the agricultural composition comprises nitrogen, phosphorous, potassium, calcium, magnesium and sulfur.

In one embodiment, the agricultural composition comprises an organic or inorganic nitrogen source. In some embodiments, the agricultural composition is applied at a rate to provide about 20 lbs. nitrogen to about 200 lbs. nitrogen per acre of land, or any value and subranges therebetween. In one embodiment, the agricultural composition is applied at a rate to provide average of about 60 lbs. nitrogen in combination with micronutrient B treatment. In some embodiments, the agricultural composition is applied at a rate to provide fertility level of about 10 lbs. nitrogen to about 138 lbs. nitrogen per acre of land. In some embodiments, the agricultural composition is applied at a rate to provide an average fertility level of about 56 lbs. of nitrogen per an acre of land in combination with micronutrient B treatment.

In one embodiment, the agricultural composition comprises a phosphorous source. In some embodiments, the agricultural composition is applied at a rate to provide about 10 lbs. phosphorous to about 150 lbs. phosphorous per acre of land, or any value and subranges therebetween. In one embodiment, the agricultural composition is applied at a rate to provide average of about 100 lbs. phosphorous. In some embodiments, the agricultural composition is applied at a rate to provide fertility level of about 10 lbs. phosphorous to about 100 lbs. phosphorous per acre of land. In some embodiments, the agricultural composition is applied at a rate to provide an average fertility level of about 35 lbs. of phosphorous per an acre of land.

In one embodiment, the agricultural composition comprises a potassium source. In some embodiments, the agricultural composition is applied at a rate to provide about 30 lbs. potassium to about 500 lbs. potassium per acre of land, or any value and subranges therebetween. In one embodiment, the agricultural composition is applied at a rate to provide average of about 250 lbs. potassium. In some embodiments, the agricultural composition is applied at a rate to provide fertility level of about 30 lbs. potassium to about 200 lbs. potassium per acre of land. In some embodiments, the agricultural composition is applied at a rate to provide an average fertility level of about 75 lbs. of potassium per an acre of land.

In one embodiment, the agricultural composition comprises copper or a copper source. In another embodiment, the agricultural composition comprising copper or a copper source is applied in a granular formulation or in a liquid formulation.

In one embodiment, the agricultural composition comprises micronutrients and macronutrients.

In one embodiment, the agricultural composition is a multi-element fertilizer. In one embodiment, the multi-element fertilizer comprises micronutrients and macronutrients. In some embodiments, the multi-element fertilizer comprises nitrogen, phosphorous, and potassium and at least one micronutrient selected from copper, zinc, iron, boron, manganese, molybdenum, or chlorine. In some embodiments, the multi-element fertilizer comprises nitrogen, phosphorous, potassium, copper, zinc, iron, boron, manganese, and molybdenum. In one embodiment, the multi-element fertilizer is Mora-Leaf 20-20-20.

In one embodiment, the agricultural composition comprising micronutrient and/or macronutrient is an organic fertilizer or an inorganic fertilizer. In some embodiments, the organic fertilizer or the inorganic fertilizer comprises calcium, magnesium, sulfur, carbon, hydrogen or oxygen elements.

In some embodiments, the agricultural composition comprising micronutrients and/or macronutrients is in an amount less than 50% of weight of the phytotoxic micronutrients in the combination. In some embodiments, the agricultural composition comprising micronutrients and/or macronutrients is in an amount less than 40% of weight of the phytotoxic micronutrients in the combination. In some embodiments, the agricultural composition comprising micronutrients and/or macronutrients is in an amount less than 30% of weight of the phytotoxic micronutrients in the combination. In some embodiments, the agricultural composition comprising micronutrients and/or macronutrients is in an amount less than 20% of weight of the phytotoxic micronutrients in the combination. In some embodiments, the agricultural composition comprising micronutrients and/or macronutrients is in an amount less than 10% of weight of the phytotoxic micronutrients in the combination. In some embodiments, the agricultural composition comprising micronutrients and/or macronutrients is in an amount less than 5% of weight of the phytotoxic micronutrients in the combination. In some embodiments, the agricultural composition comprising micronutrients and/or macronutrients is in an amount less than 5%, less than 4%, less than 3%, less than 2%, or less than 1% of weight of the phytotoxic micronutrients (A) in the combination.

ii. Adjuvant

In one embodiment, the agricultural composition comprises an adjuvant. In one embodiment, the agricultural composition comprising an adjuvant is provided in a liquid formulation. In one embodiment, the adjuvant is selected from a wetting agent, an activator, a crop oil concentrate, a buffer, a marker dye or a surfactant.

In one embodiment, the wetting agent is selected from polyoxyethylene alkylphenol ether sulfates formaldehyde condensate, polyoxyethylene alkyl phenol ether phosphate, polyoxyethylene phenethyl phenol ether phosphates, alkyl sulfates salts, alkyl sulfonates, naphthalene sulfonate, or TERSPERSE2500 (Huntsman Corp.). In some embodiments, the wetting agent is wetting agent is selected from organosilicones (e.g., Sylgard 309 from Dow Corning Corporation or Silwet L77 from Union Carbide Corporation) including polyalkylene oxide modified polydimethylsiloxane (Silwet L7607 from Union Carbide Corporation), methylated seed oil, and ethylated seed oil (e.g., Scoil from Agsco or Hasten from Wilfarm), alkylpolyoxyethylene ethers (e.g., Activator 90), alkylarylalolates (e.g., APSA 20), alkylphenol ethoxylate and alcohol alkoxylate surfactants (e.g., products sold by Huntsman), fatty acid, fatty ester and fatty amine ethoxylates (e.g., products sold by Huntsman), products sold by Cognis such as sorbitan and ethoxylated sorbitan esters, ethoxylated vegetable oils, alkyl, glycol and glycerol esters and glycol ethers, tristyrylphenol ethoxylates, anionic surfactants such as sulphonates, such as sulphosuccinates, alkylaryl sulphonates, alkyl naphthalene sulphonates (e.g., products sold by Adjuvants Unlimited), calcium alkyl benzene sulphonates, and phosphate esters (e.g., products sold by Huntsman Chemical or BASF), as salts of sodium, potassium, ammonium, magnesium, triethanolamine (TEA), etc. Other specific examples of the above sulfates include ammonium lauryl sulfate, magnesium lauryl sulfate, sodium 2-ethyl-hexyl sulfate, sodium actyl sulfate, sodium oleyl sulfate, sodium tridecyl sulfate, triethanolamine lauryl sulfate, ammonium linear alcohol, ether sulfate ammonium nonylphenol ether sulfate, and ammonium monoxynol-4-sulfate. Other examples of wetting agents or dispersing agents include, but are not limited to, sulfo succinamates, disodium N-octadecylsulfo-succinamate; tetrasodium N-(1,2-dicarboxyethyl)-N-octadecylsulfo-succinamate; diamyl ester of sodium sulfosuccinic acid; dihexyl ester of sodium sulfosuccinic acid; and dioctyl esters of sodium sulfosuccinic acid; dihexyl ester of sodium sulfosuccinic acid; and dioctyl esters of sodium sulfosuccinic acid; castor oil and fatty amine ethoxylates, including sodium, potassium, magnesium or ammonium salts thereof. Dispersants and wetting agents also include natural emulsifiers, such as lecithin, fatty acids (including sodium, potassium or ammonium salts thereof) and ethanolamides and glycerides of fatty acids, such as coconut diethanolamide and coconut mono- and diglycerides, sodium polycarboxylate; sodium salt of naphthalene sulfonate condensate; sodium lignosulfonates; aliphatic alcohol ethoxylates; tristyrylphenol ethoxylates and esters; ethylene oxide-propylene oxide block copolymers, sodium dodecylbenzene sulfonate; N-oleyl N-methyl taurate; 1,4-dioctoxy-1,4-dioxo-butane-2-sulfonic acid; sodium lauryl sulphate; sodium dioctyl sulphosuccinate; aliphatic alcohol ethoxylates; nonylphenol ethoxylates, sodium taurates; and sodium or ammonium salts of maleic anhydride copolymers, lignosulfonic acid formulations or condensed sulfonate sodium, potassium, magnesium or ammonium salts, polyvinylpyrrolidone (available commercially as Polyplasdone XL-10 from International Specialty Products or as Kollidon C1 M-10 from BASF Corporation), polyvinyl alcohols, modified or unmodified starches, methylcellulose, hydroxyethyl or hydroxypropyl methylcellulose, carboxymethyl methylcellulose, or combinations, such as a mixture of either lignosulfonic acid formulations or condensed sulfonate sodium, potassium, magnesium or ammonium salts with polyvinylpyrrolidone (PVP).

In one embodiment, the activator is a polyoxyalkylene polysiloxane surfactant, a linear alkylbenzene sulfonate, an ethoxylated sorbitan ester such as a polyoxyethylene sorbitans, an alcohol ethoxylate such as an alcohol C5-15 ethoxylate, or combinations thereof. In one embodiment, the activator is an ammonium salt selected from ammonium nitrate, ammonium chloride, ammonium carbonate, ammonium bicarbonate, mono ammonium phosphate, di ammonium phosphate, tri ammonium phosphate, ammonium sulfate, or combinations thereof.

In one embodiment, the crop oil concentrate (COC) comprises paraffinic petroleum-based oils (blend of crop oils) and non-ionic surfactants. In one embodiment, the COC comprises paraffinic oil and a surfactant or an emulsifier. In one embodiment, the COC is paraffinic oil formulated with one or more of: surfactant blend, polyol fatty acid esters and/or polyethoxylated derivatives, emulsifiers, nitrogen solution blend, ethoxylated alcohol, water conditioners, or ethoxylated alkyl phosphate esters.

In one embodiment, the buffer may be selected from ammonium salt/ammonia, deprotonated lysine/doubly deprotonated lysine, potassium phosphate monobasic/potassium phosphate dibasic, potassium bicarbonate/potassium carbonate, boric acid/borax, potassium phosphate dibasic/potassium phosphate tribasic, ammonium citrate tribasic, or potassium phosphate monobasic/potassium phosphate dibasic systems.

In one embodiment, the marker dye is an organic dye. In some embodiments, the marker dye is a naturally occurring dye. In one embodiment, a marker dye comprises beet juice. In some embodiments, the marker dye is Fluorescent Red Liquid Concentrate and Hi-Light™ Blue.

iii. Biological Compounds or Related Carbon-Based Organic Compounds

In one embodiment, the agricultural composition comprises a biological compound or a related carbon-based organic compound. In one embodiment, the biological compound or the related carbon-based organic compound is selected from fungus, spores, bacteria, soluble carbon-based solids or liquids (including sugar), organic matter, organic acids such as humic or fulvic acid, mycorrhizae, biochar, hydromulch, hydraulic mulch, waste products such as sawdust, manure, straw, corn stover, shells, hulls, or meal.

In one embodiment, the agricultural composition comprises fungi, spores and/or bacterial inoculant. In one embodiment, the agricultural composition comprises spores and/or bacterial inoculant. In one embodiment, the agricultural composition comprises a Pseudomonas fluorescens bacterial strain. In one embodiment, the Pseudomonas fluorescens bacterial strain is Pseudomonas fluorescens strain ACK55, Pseudomonas fluorescens strain NKK78 or Pseudomonas fluorescens strain SMK69. See U.S. Pat. No. 9,578,884.

In one embodiment, the agricultural composition comprising spores and/or bacterial inoculant is applied at a rate to provide from about 1 gram of spores or bacterial inoculant per one acre of land to about 5000 grams of spores or bacterial inoculant per one acre of land, or at any value and subranges therebetween.

In one embodiment, the agricultural composition comprises soluble carbon or soluble carbon source. In one embodiment, the agricultural composition comprises soluble sugar. In one embodiment, the soluble sugar is sucrose. See McLendon et al. Oecologia (1992) 91: 312-317. In one embodiment, the agricultural composition comprising sucrose is applied at a rate from about 1000 kg C/ha/yr to about 2000 kg C/ha/yr, or at any value and subranges therebetween. In one embodiment, the agricultural composition comprising sucrose is applied at a rate from about 1600 kg C/ha/yr. In one embodiment, the agricultural composition comprising sucrose is applied at a rate from about 10 kg C/ha/yr to about 1000 kg C/ha/yr, or at any value and subranges therebetween. In one embodiment, the agricultural composition comprising sucrose is applied at a rate from about 10 kg C/ha/yr to about 500 kg C/ha/yr, or at any value and subranges therebetween.

In one embodiment, the agricultural composition comprising soluble carbon or soluble carbon source is applied at a rate from about 1 lb. of soluble carbon per one acre of land to about 1000 lbs. of soluble carbon per one acre of land, or at any value and subranges therebetween. In one embodiment, the agricultural composition comprising soluble carbon or soluble carbon source is applied at a rate from about 10 lb. of soluble carbon per one acre of land to about 1000 lbs. of soluble carbon per one acre of land, or at any value and subranges therebetween.

In one embodiment, the agricultural composition comprises organic matter. In one embodiment, the organic matter is compost or related decomposed organics used for vegetation enhancement. In one embodiment, the agricultural composition comprising organic matter is applied at a rate from about 0.01 ton of organic matter per one acre of land to about 500 tons of organic matter per one acre of land, or at any value and subranges therebetween. In one embodiment, the agricultural composition comprising organic matter is applied at a rate from about 1 ton of organic matter per one acre of land to about 100 tons of organic matter per one acre of land, or at any value and subranges therebetween.

In one embodiment, the agricultural composition comprises mycorrhizae. In one embodiment, mycorrhizae is a commercial inoculum developed for plant growth augmentation. In one embodiment, the agricultural composition comprising mycorrhizae is applied at a rate from about 1 lb. of mycorrhizae per one acre of land to about 1000 lbs. of mycorrhizae per one acre of land, or at any value and subranges therebetween. In one embodiment, the agricultural composition comprising mycorrhizae is applied at a rate from about 10 lb. of mycorrhizae per one acre of land to about 1000 lbs. of mycorrhizae per one acre of land, or at any value and subranges therebetween.

In one embodiment, the agricultural composition comprises biochar. In one embodiment, biochar is a thermally degraded cellulosic material, such as wood, developed as a soil amendment. Biochar is created by the pyrolysis of biomass, which generally involves heating and/or burning of organic matter, in a reduced oxygen environment, at a predetermined rate. Such heating and/or burning is stopped when the matter reaches a charcoal like stage. Typically, biochars include porous carbonaceous materials, such as charcoal. Biochar is highly porous material. In one embodiment, the agricultural composition comprising biochar is applied at a rate from about 100 lb. of biochar per one acre of land to about 1000 tons of biochar per one acre of land, or at any value and subranges therebetween. In one embodiment, the agricultural composition comprising biochar is applied at a rate from about 500 lb. of biochar per one acre of land to about 100 tons of biochar per one acre of land, or at any value and subranges therebetween.

In one embodiment, the agricultural composition comprises hydromulch or hydraulic mulch. In one embodiment, the application of hydromulch or hydraulic mulch comprises applying slurry of water, wood fiber mulch, and often a tackifier to prevent soil erosion. In one embodiment, the wood fiber mulch is a thermally refined wood fiber, In one embodiment, the agricultural composition comprising hydromulch or hydraulic mulch is applied at a rate from about 100 lb. of hydromulch or hydraulic mulch per one acre of land to about 500 tons of hydromulch or hydraulic mulch per one acre of land, or at any value and subranges therebetween. In one embodiment, the agricultural composition comprising hydromulch or hydraulic mulch is applied at a rate from about 500 lb. of hydromulch or hydraulic mulch per one acre of land to about 100 tons of hydromulch or hydraulic mulch per one acre of land, or at any value and subranges therebetween. In one embodiment, hydraulic mulch is selected from Conwed Fibers®, Terra-Mulch®, HydroCover™, SoilCover®, EcoSolutions, Engineered Soil Media™, Proganics®, ProGanics® BSM™, Flexterra®, Second Nature®, or Enviro-Fibers® (ProfileProducts).

In one embodiment, the agricultural composition comprises sawdust. In one embodiment, sawdust is a waste material high in cellulosic carbon. In one embodiment, sawdust is generally a residue from sawmills. In one embodiment, the agricultural composition comprising sawdust is applied at a rate from about 100 lb. of sawdust per one acre of land to about 500 tons of sawdust per one acre of land, or at any value and subranges therebetween. In one embodiment, the agricultural composition comprising sawdust is applied at a rate from about 500 lb. of sawdust per one acre of land to about 100 tons of sawdust per one acre of land, or at any value and subranges therebetween.

In one embodiment, the agricultural composition comprises manure. In one embodiment, manure is an agricultural waste, typically from confined livestock feeding areas. In one embodiment, the agricultural composition comprising manure is applied at a rate from about 100 lb. of manure per one acre of land to about 500 tons of manure per one acre of land, or at any value and subranges therebetween. In one embodiment, the agricultural composition comprising manure is applied at a rate from about 500 lb. of manure per one acre of land to about 100 tons of manure per one acre of land, or at any value and subranges therebetween.

In one embodiment, the agricultural composition comprises straw. In one embodiment, straw is an agricultural waste, typically from cereal grain production. In one embodiment, the agricultural composition comprising straw is applied at a rate from about 100 lb. of straw per one acre of land to about 500 tons of straw per one acre of land, or at any value and subranges therebetween. In one embodiment, the agricultural composition comprising straw is applied at a rate from about 500 lb. of straw per one acre of land to about 100 tons of straw per one acre of land, or at any value and subranges therebetween.

In one embodiment, the agricultural composition comprises corn stover. In one embodiment, corn stover is waste leaves, stalks, and/or cobs of corn remaining after corn harvest. In one embodiment, the agricultural composition comprising corn stover is applied at a rate from about 100 lb. of corn stover per one acre of land to about 1000 tons of corn stover per one acre of land, or at any value and subranges therebetween. In one embodiment, the agricultural composition comprising corn stover is applied at a rate from corn stover 500 lb. of corn stover per one acre of land to about 100 tons of corn stover per one acre of land, or at any value and subranges therebetween.

In one embodiment, the agricultural composition comprises shell, meal, and/or hulls. In one embodiment, shell, meal, and/or hulls is an agricultural waste material remaining after harvest. In one embodiment, shell, meal, and/or hulls includes, but are not limited to, seed shells, ground meal, pressed oil seed hulls, rice hulls, and related materials. In one embodiment, the agricultural composition comprising shell, meal, and/or hulls is applied at a rate from about 100 lb. of shell, meal, and/or hulls per one acre of land to about 500 tons of shell, meal, and/or hulls per one acre of land, or at any value and subranges therebetween. In one embodiment, the agricultural composition comprising shell, meal, and/or hulls is applied at a rate from about 500 lb. of shell, meal, and/or hulls per one acre of land to about 100 tons of shell, meal, and/or hulls per one acre of land, or at any value and subranges therebetween.

iv. Inorganic Compounds

In one embodiment, the agricultural composition comprises an inorganic compound. In one embodiment, the inorganic compound is selected from lime, silica, aluminosilicate, gypsum, or sulfur compound.

In one embodiment, the agricultural composition comprises lime. In some embodiments, lime comprises calcium oxide, calcium hydroxide, calcium carbonate. In one embodiment, lime is selected from limestone, dolomite, calcite, cement kiln dust, limekiln dust, calcium oxide, or calcium hydroxide.

In one embodiment, the agricultural composition comprising lime is applied at a rate from about 0.1 ton of lime per one acre of land to about 100 tons of lime per one acre of land, or at any value and subranges therebetween. In one embodiment, the agricultural composition comprising lime is applied at a rate from about 1 ton of lime per one acre of land to about 10 tons of lime per one acre of land, or at any value and subranges therebetween.

In one embodiment, the inorganic compound is selected from calcium carbonate, calcium magnesium carbonate, calcium oxide, calcium hydroxide, cementitious waste product, or calcium sulfate.

In one embodiment, the agricultural composition comprises gypsum (calcium sulfate). In one embodiment, the agricultural composition comprising gypsum is applied at a rate from about 0.1 ton of gypsum per one acre of land to about 100 tons of gypsum per one acre of land, or at any value and subranges therebetween. In one embodiment, the agricultural composition comprising gypsum is applied at a rate from about 1 ton of gypsum per one acre of land to about 10 tons of gypsum per one acre of land, or at any value and subranges therebetween.

In one embodiment, the agricultural composition comprises a sulfur compound. In one embodiment, the sulfur compound decreases soil alkalinity. In one embodiment, the agricultural composition comprising sulfur compound is applied at a rate from about 0.1 ton of sulfur compound per one acre of land to about 100 tons of sulfur compound per one acre of land, or at any value and subranges therebetween. In one embodiment, the agricultural composition comprising sulfur compound is applied at a rate from about 1 ton of sulfur compound per one acre of land to about 20 tons of sulfur compound per one acre of land, or at any value and subranges therebetween.

In one embodiment, the agricultural composition comprises a silica compound. In one embodiment, the agricultural composition comprising silica compound is applied at a rate from about 100 lb. of silica compound per one acre of land to about 500 tons of silica compound per one acre of land, or at any value and subranges therebetween. In one embodiment, the agricultural composition comprising silica compound is applied at a rate from silica compound 500 lb. of silica compound per one acre of land to about 100 tons of silica compound per one acre of land, or at any value and subranges therebetween.

v. Seeds, Seed Coating, and Seed Inoculants

In one embodiment, the agricultural composition comprises a seed, seed coating, and/or a seed inoculant.

In one embodiment, the agricultural composition comprising a seed, seed coating, and/or a seed inoculant is applied at a rate from about 1 lb. of a seed, a seed coating, or a seed inoculant per one acre of land to about 1000 lbs. of a seed, a seed coating, or a seed inoculant per one acre of land, or at any value and subranges therebetween. In one embodiment, the agricultural composition comprising a seed, a seed coating, or a seed inoculant is applied at a rate from about 10 lb. of a seed, a seed coating, or a seed inoculant per one acre of land to about 1000 lbs. of a seed, a seed coating, or a seed inoculant per one acre of land, or at any value and subranges therebetween. In one embodiment, the rate of the application of the agricultural composition comprising a seed, a seed coating, and/or a seed inoculant may depend on size of the seed and desired seed density.

### VII. Excipients

In some embodiments, the phytotoxic micronutrients or the agricultural composition can further comprise an agriculturally acceptable excipient.

In some embodiments, an excipient is a multifunctional surfactant/dispersing agent/thickener/stabilizer which can reduce surface tension, improve plant surface adhesion, soil penetration and rewetting and/or to keep all components in a suspension. Alternatively, a separate surfactant/wetting agent and a thickener/stabilizer may be used to accomplish any or all of the above functions. In addition, an excipient can be a multifunctional chelator/dispersant/stabilizer, which may be included to chelate any of the metal ions present such as the calcium and to trap the excess calcium for later release.

In some embodiments, an excipient is a chelating agent. A chelate agent can increases the solubility of the metallic ions and favor the transportation of metallic ions inside the plant. Furthermore, after binding to the metallic ion and later on depositing the metallic ion in the place where the plant requires it, the organic part of the chelate returns to dissolve more ions, which can make the use of the micronutrients in the soil more prolonged.

In some embodiments, an excipient is a surfactant. Use of a surfactant can results in a high moisturizing ability and a capacity to decrease the superficial surface tension of the water, which facilitates assimilation of nutrients and other ingredients. On the other hand, due to the ability of the surfactant to form emulsions, the surfactant gives stability to the fertilizer.

In some embodiments, an excipient maintains a dry composition to remain flowable to the desired consistency. The dry flowable form of the phytotoxic micronutrient can be applied to the surface of soil containing weed seed, directly to weed seed, or to senesced or live, seed-bearing weed plants.

In some embodiments, the surfactant is selected from tertiary alkylamines and alkyletheramines, polyoxyethylene tertiary alkylamines and alkylemeramines, quaternary ammonium surfactants, pyridine and imidazoline surfactants, polyoxyethylene alkylamine and alkyletheramine oxides, alkylbetaines, alkyl diamines and polyoxyethylene alkyl diamines. In other embodiments, the surfactant is selected from ethoxylated alcohols, ethoxylated alcohols, ethoxylated fatty esters, ethoxylated castor oil, alkoxylated glycols, ethoxylated fatty acids, carboxylated alcohols, carboxylic acids, fatty acids, ethoxlylated alkylphenols, fatty esters, lignins, blocked copolymers, EO/PO copolymers, octadecanoic acid, ammonium salt, 9-Octadecenoic acid (9Z) or potassium salt. In one embodiment, the surfactant is selected from sulfated polyoxyethylenated straight chain alcohol, polyoxyethylenated straight chain alcohol, or a sulfate of a linear primary alcohol.

### VIII. Combinations and Method of Use

In some embodiments, the composition comprises micronutrients. In some embodiments, micronutrient is selected from copper, zinc, iron, boron, manganese, molybdenum, or chlorine.

In one embodiment, the composition comprises boron or a boron source. In some embodiments, the agricultural composition is applied at a rate to provide about 10 lbs. elemental boron to about 300 lbs. elemental boron per acre of land, or any value and subranges there between. In one embodiment, the agricultural composition is applied at a rate to provide average of about 10 lbs to about 160 lbs. elemental boron. In some embodiments, the agricultural composition is applied to control weeds at a rate of about 40 lb. elemental boron to about 120 lbs. elemental boron per acre of land. In some embodiments, the agricultural composition is applied to control weeds at a rate of about 40 lb. elemental boron to about 100 lbs. elemental boron per acre of land.

In one embodiment, the composition comprises boron or a boron source.

In some embodiments, the agricultural composition comprises macronutrients. In some embodiments, macronutrient is selected from nitrogen, phosphorous, or potassium.

In one embodiment, the agricultural composition comprises nitrogen or a nitrogen source. In some embodiments, the agricultural composition is applied at a rate to provide about 10 lbs. elemental nitrogen to about 150 lbs. elemental boron per acre of land, or any value and subranges there between. In one embodiment, the agricultural composition is applied at a rate to provide average of about 10 lbs. to about 150 lbs. elemental nitrogen. In some embodiments, the agricultural composition is applied to restore grasses under stressed condition at a rate of about 40 lb. elemental nitrogen to about 120 lbs. elemental nitrogen per acre of land.

In some embodiments, the agricultural composition is applied to restore grasses under stressed condition at a rate of about 40 lb. elemental nitrogen to about 80 lbs. elemental boron per acre of land. In some embodiments, the agricultural composition is applied to restore grasses under stressed condition at a rate of about 60 lb. elemental nitrogen to about 70 lbs. elemental boron per acre of land. In some embodiments, the agricultural composition is applied to restore grasses under stressed condition at a rate of about 60 lb. elemental nitrogen to about 60 lbs. elemental boron per acre of land.

In one embodiment, the composition comprises at least one micronutrient and at least one macronutrient.

In one embodiment, the composition is a multi-element fertilizer. In one embodiment, the multi-element fertilizer comprises micronutrients and macronutrients. In some embodiments, the multi-element fertilizer comprises nitrogen, phosphorous, and potassium and at least one micronutrients selected from copper, zinc, iron, boron, manganese, molybdenum, or chlorine. In some embodiments, the multi-element fertilizer comprises nitrogen, phosphorous, potassium, copper, zinc, iron, boron, manganese, and molybdenum.

In one embodiment, the composition comprising micronutrient and/or macronutrient is an organic fertilizer or an inorganic fertilizer. In some embodiments, the organic fertilizer or the inorganic fertilizer comprises calcium, magnesium, sulfur, carbon, hydrogen or oxygen elements.

In some embodiments, the composition comprising micronutrients and macronutrients has about 1:10 to about 100:1 ratio of a phytotoxic micronutrient and a macronutrient and any value and subranges there between. In some embodiments, the composition comprising boron and macronutrients has about 1:3, about 1:2, about 1:1, about 2:1, about 3:1 about 4:1, about 5:1, about 6:1, about 7:1, about 8:1, about 9:1, about 10:1, about 15:1, about 20:1, about 30:1, about 40:1, about 50:1, about 60:1, about 70:1, about 80:1, about 90:1, ratio or about 100:1 ratio of an elemental boron and an elemental nitrogen.

In some embodiments, B+N formulations can be 50% B and 50% N (about 1:1 ratio), but up to 90% B and 10% N (about 9:1 ratio) which inhibit growth of invasive species. In other embodiments, B+N formulations can be 49% B and 51% N (about 1:1 ratio), but up to 25% B and 75% N (about 1:3 ratio), which inhibit growth of invasive species. In further embodiments, B+N formulations can be 99% B and 1% N (about 99:1 ratio), which inhibit growth of invasive species.

Current techniques used for invasive plant species control are largely limited in their effectiveness as they are indiscriminately harmful to all existing vegetation to which they are applied (i.e. glyphosate), or are harmful to non-target species to which they are applied of the same life form as the invasive species (i.e. collateral damage to forbs with 2,4-D application). The fertilizer and weed control industries are multi-billion dollar entities. Invasive plant management is a pervasive problem on as much as 100 million acres in the U.S., with only marginally effective control methods. The methods of the subject disclosure offer a new means to address invasive plant invasion and the associated economic losses due to diminished land productivity, yet without collateral damage to the environment.

The disclosure of combining application of a phytotoxic micronutrients and another agricultural composition provides a significant new tool and method for land managers to effectively control or eradicate invasive species over a wide variety of acreages and may be modified to suit site conditions, including specific plant communities.

In one embodiment, the application of a combination of a phytotoxic micronutrients and another agricultural composition provides synergistic control or synergistic eradication of invasive species over a wide variety of acreages and may be modified to suit site conditions, including specific plant communities. In one embodiment, synergistic control or synergistic eradication of invasive species means that the control or the eradication of invasive species with the combination is superior over methods involving the application of the phytotoxic micronutrients alone (as used in the combination) or the other agricultural composition alone (as used in the combination).

According to the present disclosure, any micronutrient fertilizer can be used, applied alone or in combination with other micronutrients, or even in combination with macronutrients such as nitrogen, phosphorous, and potassium.

The methods of the present disclosure use a combination of at least one phytotoxic micronutrient and another agricultural composition to selectively control invasive plant species. The micronutrients required in small amounts by most vascular plants can be a chemical agent against invasive plant species when applied in a phytotoxic amount. The phytotoxic micronutrients effectively cause the inhibition of live plant, seedlings, or seeds of invasive plant species, when the soluble trace element comes in contact with germinating seed or are taken up by the roots of live plants. Similarly, the phytotoxic micronutrients effectively inhibit the seedlings of invasive plant species, when the trace element comes in contact with the emerging seedlings. Relatively low concentrations of the micronutrients are required to be phytotoxic to invasive species but do not result in harm to desirable native species, or at least are less harmful over a spectrum of desirable native species.

The exact soil solution concentration that will result from any of the formulation disclosed herein is unknown because it depends on the soil and whether it is a sand, silt, or clay and how much water it holds. It is not unusual for an acre of dry soil to contain 2 million pounds of dry soil in the upper 6 inches plus 20% gravimetric water content. (400,000 pounds or ˜50,000 gallons). While the dry soil mass would not vary a great deal the amount of water in the soil might range from 10,000 to 100,000 gallons per acre. Therefore, with a 10× variation in soil water content addition of a given amount of fertilizer might result in a solution concentration that varied 10 times. Therefore, it is difficult to predict with certainty how the soil solution concentration (existing patent basis) will change in response to pragmatic applications of any one of compositions and combinations disclosed herein to control invasive plant species. Furthermore, as soon as the phytotoxic micronutrients and or the agricultural composition is added to the soil, the components of the phytotoxic micronutrients and or the agricultural composition are subject to crop uptake and leaching, plus the soil has preexisting amounts of soil nutrients. The addition of soil nutrients may also stimulate the activity of soil organisms likewise resulting in respiration of gasses to the atmosphere and mobilization of elemental inorganic constituents in the mineral soil from the solid phase to the solution phase.

In one embodiment, the present disclosure relates to a composition comprising a phytotoxic micronutrient and an agricultural composition.

In one embodiment, the present disclosure relates to a composition comprising a phytotoxic micronutrient. In one embodiment of any one of the composition disclosed herein, the composition further comprises one or more ingredients selected from: a) a micronutrient; b) a macronutrient; c) an adjuvant; d) a biological compound or a related carbon-based organic compound; e) an inorganic compound; or f) a seed, a seed coating, or a seed inoculant.

In one embodiment of any one of the composition disclosed herein, the composition further comprises a) a micronutrient and/or b) a macronutrient.

In one embodiment of any one of the composition disclosed herein, the phytotoxic micronutrient comprises boron or a copper. In one embodiment, the phytotoxic micronutrient comprises boron. In one embodiment, the phytotoxic micronutrient comprises boron in about 5% to about 99.9% by weight, about 15% to about 95% by weight, or about 25% to about 90% by weight of the composition.

In one embodiment of any one of the compositions disclosed herein, the micronutrient is selected from copper, zinc, iron, boron, manganese, molybdenum, or chlorine. In one embodiment of any one of the compositions disclosed herein, the macronutrient is selected from nitrogen, phosphorous, or potassium.

In one embodiment of anyone of the composition disclosed herein, the composition further comprises an organic fertilizer or an inorganic fertilizer. In one embodiment, the fertilizer comprises calcium, magnesium, sulfur, carbon, hydrogen or oxygen elements.

In one embodiment of any one of the composition disclosed herein, the adjuvant is selected from a wetting agent, an activator, a crop oil concentrate, a buffer, a marker dye or a surfactant.

In one embodiment of any one of the composition disclosed herein, the biological compound and related carbon-based organic compound is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal.

In one embodiment of any one of the composition disclosed herein, the inorganic compound is selected from lime, silica, aluminosilicate, gypsum, or sulfur compound. In one embodiment, the inorganic compound is selected from calcium carbonate, calcium magnesium carbonate, calcium oxide, calcium hydroxide, cementitious waste product, or calcium sulfate.

In one embodiment of any one of the composition disclosed herein, the composition is in a dry granular form. In one embodiment, the composition comprises the adjuvant and the composition is a liquid.

In one embodiment of any one of the composition disclosed herein, the composition comprises the micronutrient. In one embodiment, the composition comprises the macronutrient. In one embodiment, the composition comprises the biological compound or related carbon-based organic compound. In one embodiment, the composition comprises the inorganic compound. In one embodiment, the composition comprises the seed, the seed coating, or the seed inoculant.

In one embodiment, the present disclosure relates to an agricultural combination comprising: (i) a phytotoxic micronutrient; and (ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant.

In one embodiment of any one of the agricultural combination disclosed herein, the agricultural composition is a liquid formulation further comprising an adjuvant.

In one embodiment of any one of the agricultural combination disclosed herein, the phytotoxic micronutrient comprises boron.

In one embodiment, the present disclosure relates to a composition or a combination of the phytotoxic micronutrients and an agricultural composition. In one embodiment, the present disclosure relates to a composition or a combination of the phytotoxic micronutrients and an agricultural composition comprising a macronutrient. In one embodiment, the present disclosure relates to a composition or a combination of the phytotoxic micronutrients comprising a boron source and an agricultural composition comprising a macronutrient such as nitrogen, phosphorous, and/or potassium. In one embodiment, the present disclosure relates to a composition or a combination of the phytotoxic micronutrients comprising a boron source and an agricultural composition comprising a micronutrient, wherein the agricultural composition can further comprise one or more of micronutrients, macronutrients, biological compounds and/or related carbon-based organic compounds, inorganic compounds, or seed, seed coating, and/or seed inoculant. In one embodiment, the present disclosure relates to a composition or a combination of the phytotoxic micronutrients comprising a boron source and an agricultural composition comprising a macronutrient, wherein the agricultural composition can further comprise one or more of micronutrients, macronutrients, biological compounds and/or related carbon-based organic compounds, inorganic compounds, seed, seed coating, and/or seed inoculant, or an adjuvant.

In one embodiment of any one of the agricultural combination disclosed herein, the combination comprises a phytotoxic micronutrient and a macronutrient. In some embodiments, the macronutrient is nitrogen, phosphorous, and/or potassium.

In one embodiment of any one of the agricultural combination as disclosed herein, the combination can be in a form of granular form or a coated granular form. In one embodiment, the agricultural composition can be in a granular form and the phytotoxic micronutrient can be applied as a coating to the granular agricultural composition. In one embodiment, the agricultural composition comprising nitrogen, phosphorous, and potassium can be in a granular form and the phytotoxic micronutrient can be applied as a coating to the granular form to provide the combination.

In one embodiment of any one of the agricultural combination as disclosed herein, the combination can be in a form of granular form or a coated granular form such that the release of the composition in the granular form may be delayed or modified by the coating.

In one embodiment, the phytotoxic micronutrients provide protection to the desirable plants and the desirable seeds.

In one embodiment, the phytotoxic micronutrient and the agricultural composition are both in a dry formulation, but provided separately. In one embodiment, the phytotoxic micronutrient and the agricultural composition are both in a dry formulation in a single composition.

In one embodiment, the phytotoxic micronutrient and the agricultural composition are both in a liquid formulation, but provided separately. In one embodiment, the phytotoxic micronutrient and the agricultural composition are both in a liquid formulation in a single composition.

In one embodiment, the phytotoxic micronutrient and the agricultural composition are applied together as a single composition to the soil or to the plant requiring treatment. In one embodiment, the phytotoxic micronutrient and the agricultural composition are tank-mixing partners.

In one embodiment, the phytotoxic micronutrient and the agricultural composition are applied simultaneously but as a separate formulation to the soil or to the plant requiring treatment. In one embodiment, the phytotoxic micronutrient and the agricultural composition are applied sequentially as a separate formulation to the soil or to the plant requiring treatment. In some embodiments, the sequential application can be separated by hours, days, or months, depending on the need for treatment.

In some embodiments, the phytotoxic micronutrient and the agricultural composition comprising a macronutrient are applied sequentially, wherein the phytotoxic micronutrient is applied in the fall and the agricultural composition is applied as directed by the product label and/or user guides.

The rates of the phytotoxic micronutrients and the agricultural composition can be applied at any one of the rates as disclosed herein as appropriate for the soil condition in the area requiring a treatment.

The phytotoxic micronutrient alone can be used for selective control of invasive plant species. See WO 2014/113475, the disclosure of which is hereby incorporated by reference in its entirety.

The present disclosure, in one embodiment, relates to a method of controlling invasive plant species by applying the phytotoxic micronutrient and the agricultural composition. In one embodiment, the present disclosure relates to a method of selectively controlling invasive plant species while maintaining desirable plant species by applying the phytotoxic micronutrient and the agricultural composition. In one embodiment, the phytotoxic micronutrient is phytotoxic to the invasive species but not phytotoxic to the desirable plant species.

The present disclosure, in one embodiment, relates to a method of controlling invasive plant species existing in a perennial grass plant community by applying the phytotoxic micronutrient and the agricultural composition. In one embodiment, the perennial grass plant community comprises bluebunch wheatgrass, Western wheatgrass, slender wheatgrass, Idaho fescue, sheep fescue, orchard grass, smooth brome, timothy and/or Kentucky bluegrass. In one embodiment, the perennial grass plant community comprises bluebunch wheatgrass, Idaho fescue, western wheatgrass and/or Kentucky bluegrass.

The present disclosure, in one embodiment, relates to a method of controlling invasive plant species existing in a perennial grass plant community by applying the phytotoxic micronutrient and the agricultural composition. The present disclosure, in one embodiment, relates to a method of controlling invasive plant species existing in a perennial grass community rangeland or pastureland by applying the phytotoxic micronutrient and the agricultural composition. In one embodiment, the perennial grass community rangeland or pastureland comprises bluebunch wheatgrass, Western wheatgrass, slender wheatgrass, Idaho fescue, sheep fescue, orchard grass, smooth brome, timothy and/or Kentucky bluegrass. In one embodiment, the perennial grass plant community comprises bluebunch wheatgrass, Idaho fescue, western wheatgrass and/or Kentucky bluegrass.

The present disclosure, in one embodiment, relates to a method of controlling invasive plant species existing in a perennial grass plant community by applying the phytotoxic micronutrient and the agricultural composition.

In one embodiment, the present disclosure relates to a method of selectively controlling cheatgrass, dandelion, Canadian thistle, kochia, knotweed, poison ivy and/or spotted knapweed while maintaining desirable plant species by applying the phytotoxic micronutrient and the agricultural composition.

The present invention provides a method of selectively controlling the growth of at least one invasive plant species. In one embodiment, the method provides controlling the growth of at least one invasive plant species in a perennial grass plant community or a perennial grass community rangeland or pastureland. In one embodiment, the method disclosed herein uses compositions and combinations comprising a phytotoxic micronutrient and an agricultural composition comprising a micronutrient, a macronutrient, a biological compound or a related carbon-based organic compound, an inorganic compound, or a seed, a seed coating, or a seed inoculant.

In one embodiment, the present disclosure relates to methods for selectively controlling the growth of at least one invasive plant species existing in a perennial grass plant community, the methods comprising applying: (i) a phytotoxic micronutrient; and (ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant.

In one embodiment, the present disclosure relates to methods for negatively impacting the growth of at least one invasive plant species, including the selective control of the invasive plant species, existing in a perennial grass plant community, while preserving the perennial grass plant community species, the methods comprising applying: (i) a phytotoxic micronutrient; and (ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant.

In one embodiment of any one of the methods disclosed herein, the phytotoxic micronutrient comprises boron or a copper. In one embodiment, the phytotoxic micronutrient comprises boron. In one embodiment of any one of the methods disclosed herein, the phytotoxic micronutrient is applied to achieve a water soluble boron concentration in the soil of the perennial grass plant community from about 3 milligrams per liter to about 50 milligrams per liter. In one embodiment, the phytotoxic micronutrient is applied at a rate of about 1 pound of elemental boron per one acre to about 160 pounds of elemental boron per one acre. In other embodiments, the phytotoxic micronutrient is applied at a rate of about 5, about 10, about 15, about 25, about 50, about 75, about 100, about 125, about 150 or about 160 pounds of elemental boron per one acre.

In one embodiment of any one of the methods disclosed herein, the phytotoxic micronutrient comprises boron, wherein the boron in the phytotoxic micronutrient is phytotoxic to the at least one invasive plant species while maintaining or increasing the growth and vigor of the perennial grass. Maintaining the growth and vigor of the perennial grass can mean that the perennial grass is not harmed by the treatment but not necessary mean that resulted in increased growth and vigor.

In one embodiment of any one of the methods disclosed herein, the at least one invasive species is selected from the group consisting of cheatgrass, dandelion, Canadian thistle, kochia, knotweed, poison ivy and spotted knapweed. In one embodiment of any one of the methods disclosed herein, the perennial grass plant community comprises bluebunch wheatgrass, Western wheatgrass, slender wheatgrass, Idaho fescue, sheep fescue, orchard grass, smooth brome, timothy or Kentucky bluegrass.

In one embodiment of any one of the methods disclosed herein, the micronutrient in the agricultural composition is selected from copper, zinc, iron, boron, manganese, molybdenum, or chlorine.

In one embodiment of any one of the methods disclosed herein, the macronutrient in the agricultural composition is selected from nitrogen, phosphorous, or potassium.

In one embodiment of any one of the methods disclosed herein, the agricultural composition further comprises an organic fertilizer or an inorganic fertilizer.

In one embodiment of any one of the methods disclosed herein, the organic fertilizer or the inorganic fertilizer comprises calcium, magnesium, sulfur, carbon, hydrogen or oxygen elements.

In one embodiment of any one of the methods disclosed herein, the adjuvant in the agricultural composition is selected from a wetting agent, an activator, a crop oil concentrate, a buffer, a marker dye or a surfactant.

In one embodiment of any one of the methods disclosed herein, the biological compound and related carbon-based organic compound in the agricultural composition is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal.

In one embodiment of any one of the methods disclosed herein, the inorganic compound in the agricultural composition is selected from lime, silica, aluminosilicate, gypsum, or sulfur compound.

In one embodiment of any one of the methods disclosed herein, the inorganic compound in the agricultural composition is selected from calcium carbonate, calcium magnesium carbonate, calcium oxide, calcium hydroxide, cementitious waste product, or calcium sulfate.

In one embodiment of anyone of the methods disclosed herein, the phytotoxic micronutrient and the agricultural composition is in a dry granular formulation or in a liquid formulation.

In one embodiment of any one of the methods disclosed herein, the agricultural composition comprises an adjuvant and the agricultural composition is in a liquid formulation.

In one embodiment of any one of the methods disclosed herein, the agricultural composition comprises the micronutrient. In one embodiment, the agricultural composition comprises the macronutrient. In one embodiment, the agricultural composition comprises the biological compound or related carbon-based organic compound. In one embodiment, the agricultural composition comprises the inorganic compound. In one embodiment, the agricultural composition comprises the seed, the seed coating, or the seed inoculant.

In one embodiment of any one of the methods disclosed herein, the phytotoxic micronutrient and the agricultural composition are applied simultaneously or sequentially.

In one embodiment, the present disclosure relates to methods for selectively controlling the growth of at least one invasive plant species existing in a perennial grass plant community, the methods comprising applying an composition comprising: i) a phytotoxic micronutrient; and ii) a macronutrient.

In one embodiment, the present disclosure relates to methods for negatively impacting the growth of at least one invasive plant species, including the selective control of the invasive plant species, existing in a perennial grass plant community, while preserving the perennial grass plant community species, the methods comprising applying an composition comprising: i) a phytotoxic micronutrient; and ii) a macronutrient.

In one embodiment of any one of the methods disclosed herein, the composition further comprises one or more ingredients selected from: a) a micronutrient; b) a macronutrient; c) a biological compound or a related carbon-based organic compound; d) an inorganic compound; or e) a seed, a seed coating, or a seed inoculant.

In one embodiment of any one of the methods disclosed herein, the phytotoxic micronutrient comprises boron or a copper. In one embodiment, the phytotoxic micronutrient comprises boron. In one embodiment, the phytotoxic micronutrient comprises boron in about 5% to about 20%, about 10% to about 30%, or about 15% to about 50% by weight. In one embodiment, the phytotoxic micronutrient is applied to achieve a water soluble boron concentration in the soil of the perennial grass plant community from about 3 milligrams per liter to about 50 milligrams per liter. In one embodiment, the phytotoxic micronutrient is applied at a rate of about 1 pound of elemental boron per one acre to about 160 pounds of elemental boron per one acre. In other embodiments, the phytotoxic micronutrient is applied at a rate of about 5, about 10, about 15, about 25, about 50, about 75, about 100, about 125, about 150 or about 160 pounds of elemental boron per one acre.

In one embodiment of any one of the methods disclosed herein, the boron in the phytotoxic micronutrient is phytotoxic to the at least one invasive plant species while maintaining or increasing the growth and vigor of the perennial grass.

In one embodiment of any one of the methods disclosed herein, the at least one invasive species is selected from the group consisting of cheatgrass, dandelion, Canadian thistle, kochia, knotweed, poison ivy and spotted knapweed. In one embodiment of any one of the methods disclosed herein, the perennial grass plant community comprises bluebunch wheatgrass, Western wheatgrass, slender wheatgrass, Idaho fescue, sheep fescue, orchard grass, smooth brome, timothy or Kentucky bluegrass.

In one embodiment of any one of the methods disclosed herein, the micronutrient is selected from copper, zinc, iron, boron, manganese, molybdenum, or chlorine.

In one embodiment of any one of the methods disclosed herein, the macronutrient is selected from nitrogen, phosphorous, or potassium.

In one embodiment of any one of the methods disclosed herein, the composition further comprises an organic fertilizer or an inorganic fertilizer. In one embodiment, the organic fertilizer or the inorganic fertilizer comprises calcium, magnesium, sulfur, carbon, hydrogen or oxygen elements.

In one embodiment of any one of the methods disclosed herein, the adjuvant is selected from a wetting agent, an activator, a crop oil concentrate, a buffer, a marker dye or a surfactant.

In one embodiment of any one of the methods disclosed herein, the biological compound and related carbon-based organic compound is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal.

In one embodiment of any one of the methods disclosed herein, the inorganic compound is selected from lime, silica, aluminosilicate, gypsum, or sulfur compound. In one embodiment, the inorganic compound is selected from calcium carbonate, calcium magnesium carbonate, calcium oxide, calcium hydroxide, cementitious waste product, or calcium sulfate.

In one embodiment of any one of the methods disclosed herein, the composition is in a dry granular formulation. In one embodiment, the composition comprises an adjuvant and the agricultural composition is in a liquid formulation.

In one embodiment of any one of the methods disclosed herein, the composition comprises the micronutrient. In one embodiment, the composition comprises the macronutrient. In one embodiment, the composition comprises the biological compound or related carbon-based organic compound. In one embodiment, the composition comprises the inorganic compound. In one embodiment, the composition comprises the seed, the seed coating, or the seed inoculant.

In one embodiment of any one of the methods disclosed herein, the phytotoxic micronutrient is in a dry granular form or in a liquid form.

In one embodiment, the phytotoxic micronutrient and the agricultural composition at least one macronutrient are both in a dry formulation, but provided separately. In one embodiment, the phytotoxic micronutrient and the agricultural composition are both in a dry formulation in a single composition. In one embodiment, the phytotoxic micronutrient and the agricultural composition are applied together as a single composition and/or applied separately to the soil (e.g. granular application) requiring treatment.

In one embodiment, the phytotoxic micronutrient and the agricultural composition comprising at least one macronutrient are both in a liquid formulation, but provided separately. In one embodiment, the phytotoxic micronutrient and the agricultural composition are both in a liquid formulation in a single composition. In one embodiment, the phytotoxic micronutrient and the agricultural composition are applied together as a single composition and/or applied separately to the plant (e.g. foliar application) requiring treatment.

In some embodiments, the phytotoxic micronutrient and the agricultural composition comprising at least one macronutrient are applied simultaneously, wherein the phytotoxic micronutrient and macronutrient are applied at the same time. In some embodiments, the phytotoxic micronutrient and the agricultural composition comprising at least one macronutrient are applied sequentially, wherein the phytotoxic micronutrient is applied first and the macronutrient is applied later. In some embodiments, the phytotoxic micronutrient and the agricultural composition comprising at least one macronutrient are applied sequentially, wherein the phytotoxic macronutrient is applied first and the micronutrient is applied later.

### IX. Non-Selective Phytotoxicity (NSP)

The present disclosure teaches a “kill all” vegetation approach that shows a similar weed control effect of a glyphosate-based herbicide known as a brand name Roundup®. While the Roundup herbicide is highly effective in killing all plants, however it is a very short-term effect. For example, Roundup treated turf plots were 100% effective about 30 days after treatment, however these same plots have become infested by weeds next year with more weedy (˜75% weed cover) than pre-treatment (˜50% weed cover). The present disclosure teaches the micronutrient-based weed control approach allows grass species to be most tolerant of micronutrients, thus a “kill all” effect requires a high rate of application which can be performed by either granular or liquid or in combination so as to achieve the desired effect.

Severe restriction of growth of all plant species, including grasses, by application of high rates of phytotoxic micronutrient compounds can be accomplished resulting in non-selective phytotoxicity (NSP).

The term “non-selective phytotoxicity” (NSP) can be interchangeably used with “roundup-like”, “glyphosate-like”, or grass-inhibition” phytotoxicity.

Each plant has a unique sensitivity to each micronutrient and increasing amounts may exceed beneficial amounts leading to toxicity and NSP. The utility of non-selective control of all plants has been shown by glyphosate where for a variety of management reasons the presence of any vegetation is undesirable. While glyphosate is a synthetic formulation, the present disclosure teaches that NSP can be accomplished by the micronutrient treatment, either in dry/granular or liquid form. The effects may be long-lasting since the soil may retain the phytotoxic signature of added micronutrients for an extended duration as controlled by application rate, rainfall and soil characteristics such as texture, organic matter content and cation exchange capacity.

In order to achieve the intended NSP effect, at least one phytotoxic micronutrient is used. In one embodiments, the phytotoxic micronutrient for the NSP effect comprises boron or copper. In another embodiments, the phytotoxic micronutrient for the NSP effect comprises boron.

For the NSP to any plant disclosed herein, the present disclosure teaches that the micronutrient is applied at a rate of about 100 pound of elemental boron per one acre to about 500 pounds of elemental boron per one acre. In some embodiments, the macronutrient is applied at a rate of about 150, about 175, about 200, about 225, about 250, or about 300 pounds of elemental boron per one acre. In some embodiments, the micronutrient is applied at a rate of about 100 about 125, about 150, or about 160 pounds of elemental boron per one acre.

In some embodiments, nitrogen can be used for an NSP effect. In some embodiments, nitrogen can be very effective in controlling many plants at high concentrations. The present disclosure teaches killing turf grass with both boron and nitrogen by inadvertent spills of high concentrations. In crop systems, N can be applied at high rates when invasive plants are small with a beneficial result short term results (such as killing weeds) and beneficial long term result (such as crop fertility). In some embodiments, the macronutrient is applied at a rate of about 10 about to about 200 pounds of elemental nitrogen per one acre. In some embodiments, adding N in can kill plants with the NSP effect and/or inhibit growth of invasive species. The present disclosure teaches control of clover in turf with B+N compared to B alone, likewise with Cu+N and Zn+N.

For the NSP to any plant disclosed herein, the present disclosure teaches the macronutrient is applied at a rate of about 50, about 60, about 70, about 80, about 90, about 100, about 125, about 150, or about 175 pounds of elemental nitrogen per one acre.

The present disclosure teaches a method for inducing non-selective phytotoxicity (NSP) in a plant. In some embodiments, the method comprising: applying a phytotoxic micronutrient to the plant. In some embodiments, the phytotoxic micronutrient comprises boron. In some embodiments, the phytotoxic micronutrient is applied at a rate of about 100 pounds to about 200 pounds of elemental boron per one acre In some embodiments, the phytotoxic micronutrient is absorbed systemically by the plant, thereby resulting in non-selective phytotoxicity in the plant. In some embodiments, the phytotoxic micronutrient is applied at a rate of about 100 pounds to about 160 pounds of elemental boron per one acre. In some embodiments, the phytotoxic micronutrient in a dry formulation. In some embodiments, the phytotoxic micronutrient in a liquid formulation.

### X. Products

In some embodiments, the phytotoxic micronutrient is boron In one embodiment, boron is applied at rates from 12 to 100 pounds per acrein granular form to achieve dissimilar responses in plants. In other embodiments, B1300 is applied to the foliage of a target plant in liquid form.

The present disclosure provides exemplary products designed for controlling weeds described herein:

(1) Product B1300: This is a foliar B product comprised of a high rate of water soluble Boron (1300 grams 20.5% B fertilizer (such as Solubor®) dissolved into 4 gallons of water), which is applicable to foliar spray on noxious and nuisance weeds. In some embodiments, high rates (such as more than 120 lbs. Boron/acre) can lead to glyphosate-like outcomes. It is highly effective as a spot spray on weedy species, inexpensive, easy to apply and can achieve a Round-Up™ outcome at high application rates.

(2) Product NB 60/60: This product contains both B and N at rates that result in stimulation of turf grass and control of weeds. It is a granular product comprised of 60 pounds of boron and 60 pounds of nitrogen per acre that can be applied at any time of the year, preferably late in the summer, followed by use of foliar B1300 or NB 700/700 spray to spot control weeds during the following growing season.

(3) Product NB 700/700: This foliar product is based on a roughly 50/50 split of B and Nitrogen and is primarily intended for spot spray in turf. It is dissimilar from B1300 which is B-only and intended for weed control only. Its primary use is envisioned in turf grass, but has significant potential in rangeland, pasture and crop land settings.

(4) Granular Boron with trace amounts of additional micronutrients and macro nutrients: Granular fertilizer (14.3% to 15% Boron) applied at varying rates, but typically 87 to 350 bulk pounds of fertilizer per acre (12-50 pounds B per acre), which is applicable to turf applications rangeland applications and noxious or nuisance weed applications. In some embodiments, higher rates (such as more than 200 lbs. Boron/acre) can lead to glyphosate-like outcomes.

In one embodiment, the present disclosure relates to an agricultural kit comprising: (i) a phytotoxic micronutrient; and (ii) an agricultural composition comprising one or more ingredients selected from a) a micronutrient; b) a macronutrient; c) a biological compound or a related carbon-based organic compound; d) an inorganic compound; or f) a seed, a seed coating, or a seed inoculant.

In one embodiment of any one of the agricultural kit disclosed herein, the agricultural composition is a liquid formulation further comprising an adjuvant. In one embodiment of any one of the agricultural kit disclosed herein, the phytotoxic micronutrient comprises boron.

In one embodiment, the present disclosure relates to an agricultural combination comprising: (i) a phytotoxic micronutrient; and (ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant.

In one embodiment of any one of the agricultural combination disclosed herein, the agricultural composition is a liquid formulation further comprising an adjuvant. In one embodiment of any one of the agricultural combination disclosed herein, the phytotoxic micronutrient comprises boron.

In some embodiments, a composition comprises a phytotoxic micronutrient and an agricultural composition. In some embodiments, the agricultural composition comprises one or more ingredients selected from: a) a micronutrient; b) a macronutrient; c) an adjuvant; d) a biological compound or a related carbon-based organic compound; e) an inorganic compound; or f) a seed, a seed coating, or a seed inoculant. In some embodiments, the phytotoxic micronutrient comprises boron or a copper. In some embodiments, the phytotoxic micronutrient comprises boron. In some embodiments, the phytotoxic micronutrient comprises boron in about 25% to about 90% by weight of the composition. In some embodiments, the micronutrient in the agricultural composition is selected from boron, copper, zinc, iron, manganese, molybdenum, or chlorine. In some embodiments, the macronutrient in the agricultural composition is selected from nitrogen, phosphorous, or potassium. In some embodiments, the composition further comprises an organic fertilizer or an inorganic fertilizer. In some embodiments, the organic fertilizer or the inorganic fertilizer comprises calcium, magnesium, sulfur, carbon, hydrogen or oxygen elements. In some embodiments, the adjuvant in the agricultural composition is selected from a wetting agent, an activator, a crop oil concentrate, a buffer, a marker dye or a surfactant. In some embodiments, the biological compound and related carbon-based organic compound is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal. In some embodiments, the inorganic compound in the agricultural composition is selected from lime, silica, aluminosilicate, gypsum, or sulfur compound. In some embodiments, the inorganic compound is selected from calcium carbonate, calcium magnesium carbonate, calcium oxide, calcium hydroxide, cementitious waste product, or calcium sulfate. In some embodiments, the composition is in a dry formulation or in a liquid formulation.

### XI. Method for Controlling Plant Growth

The present disclosure teaches a method for controlling at least one invasive plant growth in a perennial grass plant community. In some embodiments, the method comprises applying (i) a phytotoxic micronutrient and/or (ii) an agricultural composition comprising one or more ingredients selected from a) a micronutrient; b) a macronutrient; c) a biological compound or a related carbon-based organic compound; d) an inorganic compound; or e) a seed, a seed coating, or a seed inoculant. In some embodiments, the phytotoxic micronutrient is selected from the group consisting of boron, copper, iron, chlorine, manganese, molybdenum and zinc. In some embodiments, wherein the phytotoxic micronutrient is absorbed systemically by the plant, thereby inducing systemic phytotoxicity in the plant. In some embodiments, the phytotoxic micronutrient comprises boron. In some embodiments, the phytotoxic micronutrient is applied at a rate of about 10 pounds to about 150 pounds of elemental boron per one acre. In some embodiments, the phytotoxic micronutrient is applied at a rate of about 20 pounds to about 100 pounds of elemental boron per one acre. In some embodiments, the boron in the phytotoxic micronutrient is phytotoxic to the at least one invasive plant species while maintaining or increasing the growth and vigor of the perennial grass. In some embodiments, the at least one invasive species is listed in Tables 1 and 2. In some embodiments, the at least one invasive species is selected from the group consisting of cheatgrass, dandelion, Canadian thistle, kochia, knotweed, poison ivy and spotted knapweed. In some embodiments, said perennial grass plant community comprises bluebunch wheatgrass, Western wheatgrass, slender wheatgrass, Idaho fescue, sheep fescue, orchard grass, smooth brome, timothy or Kentucky bluegrass. In some embodiments, the micronutrient in the agricultural composition is selected from boron, copper, zinc, iron, manganese, molybdenum, or chlorine. In some embodiments, the macronutrient in the agricultural composition is selected from nitrogen, phosphorous, or potassium. In some embodiments, the biological compound and related carbon-based organic compound in the agricultural composition is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal. In some embodiments, the inorganic compound in the agricultural composition is selected from lime, silica, aluminosilicate, gypsum, or sulfur compound. In some embodiments, the inorganic compound in the agricultural composition is selected from calcium carbonate, calcium magnesium carbonate, calcium oxide, calcium hydroxide, cementitious waste product, or calcium sulfate. In some embodiments, the agricultural composition further comprises an organic fertilizer or an inorganic fertilizer. In some embodiments, the organic fertilizer or the inorganic fertilizer comprises calcium, magnesium, sulfur, carbon, hydrogen or oxygen elements. In some embodiments, the agricultural composition further comprises an adjuvant. In some embodiments, the adjuvant is selected from a wetting agent, an activator, a crop oil concentrate, a buffer, a marker dye or a surfactant. In some embodiments, the phytotoxic micronutrient and the agricultural composition is in a dry formulation. In some embodiments, the phytotoxic micronutrient and the agricultural composition is in a liquid formulation. In some embodiments, the phytotoxic micronutrient is in a dry formulation and the agricultural composition is in a liquid formulation. In some embodiments, the phytotoxic micronutrient is in a liquid formulation and the agricultural composition is in a dry formulation. In some embodiments, the phytotoxic micronutrient and the agricultural composition are applied simultaneously or sequentially. In some embodiments, applying the phytotoxic micronutrient and the agricultural composition provides a synergistic effect in controlling the growth of at least one invasive plant, compared to when the phototoxic micronutrient or the agricultural composition is applied alone.

The present disclosure also teaches a method for controlling at least one invasive plant growth in a perennial grass plant community. In some embodiments, the method comprises applying a composition comprising: (i) a phytotoxic micronutrient and (ii) a macronutrient. In some embodiments, the phytotoxic micronutrient is selected from the group consisting of boron, copper, iron, chlorine, manganese, molybdenum and zinc. In some embodiments, the phytotoxic micronutrient is absorbed systemically by the plant, thereby inducing systemic phytotoxicity in the plant. In some embodiments, the composition further comprises one or more ingredients selected from: an agricultural composition comprising one or more ingredients selected from a) a micronutrient; b) a biological compound or a related carbon-based organic compound; c) an inorganic compound; or d) a seed, a seed coating, or a seed inoculant. In some embodiments, the phytotoxic micronutrient comprises boron. In some embodiments, the phytotoxic micronutrient is applied at a rate of about 10 pounds to about 150 pounds of elemental boron per one acre. In some embodiments, the phytotoxic micronutrient is applied at a rate of about 20 pounds to about 100 pounds of elemental boron per one acre. In some embodiments, the boron in the phytotoxic micronutrient is phytotoxic to the at least one invasive plant species while maintaining or increasing the growth and vigor of the perennial grass. In some embodiments, the at least one invasive species is listed in Tables 1 and 2. In some embodiments, the at least one invasive species is selected from the group consisting of cheatgrass, dandelion, Canadian thistle, kochia, knotweed, poison ivy and spotted knapweed. In some embodiments, said perennial grass plant community comprises bluebunch wheatgrass, Western wheatgrass, slender wheatgrass, Idaho fescue, sheep fescue, orchard grass, smooth brome, timothy or Kentucky bluegrass. In some embodiments, the micronutrient in the agricultural composition is selected from boron, copper, zinc, iron, manganese, molybdenum, or chlorine. In some embodiments, the macronutrient in the agricultural composition is selected from nitrogen, phosphorous, or potassium. In some embodiments, the biological compound and related carbon-based organic compound in the agricultural composition is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal. In some embodiments, the inorganic compound in the agricultural composition is selected from lime, silica, aluminosilicate, gypsum, or sulfur compound. In some embodiments, the inorganic compound in the agricultural composition is selected from calcium carbonate, calcium magnesium carbonate, calcium oxide, calcium hydroxide, cementitious waste product, or calcium sulfate. In some embodiments, the agricultural composition further comprises an organic fertilizer or an inorganic fertilizer. In some embodiments, the organic fertilizer or the inorganic fertilizer comprises calcium, magnesium, sulfur, carbon, hydrogen or oxygen elements. In some embodiments, the agricultural composition further comprises an adjuvant. In some embodiments, the adjuvant is selected from a wetting agent, an activator, a crop oil concentrate, a buffer, a marker dye or a surfactant. In some embodiments, the phytotoxic micronutrient and the macronutrient is in a dry formulation. In some embodiments, the phytotoxic micronutrient and the macronutrient is in a liquid formulation. In some embodiments, the phytotoxic micronutrient is in a dry formulation and the macronutrient is in a liquid formulation. In some embodiments, the phytotoxic micronutrient is in a liquid formulation and the macronutrient is in a dry formulation. In some embodiments, the phytotoxic micronutrient and the macronutrient are applied simultaneously or sequentially. In some embodiments, applying the phytotoxic micronutrient and the macronutrient provides a synergistic effect in controlling the growth of at least one invasive plant, compared to when the phototoxic micronutrient or the agricultural composition is applied alone.

The present disclosure provides a method for inducing phytotoxicity in a plant. In some embodiments, the method comprises applying boron in a liquid formulation to foliar portions of the plant, the liquid formulation comprising about 14.0 g of boron per liter to about 20.0 g of boron per liter, wherein the liquid formulation is absorbed systemically by the plant, thereby inducing systemic phytotoxicity in the plant. In some embodiments, the liquid formulation is applied at a rate of about 10 pounds to about 150 pounds of elemental boron per one acre. In some embodiments, the plant is listed in Tables 1 and 2. In some embodiments, the plant is selected from the group consisting of cheatgrass, dandelion, Canadian thistle, kochia, knotweed, poison ivy and spotted knapweed. In some embodiments, the plant is selected from the group consisting of bluebunch wheatgrass, Western wheatgrass, slender wheatgrass, Idaho fescue, sheep fescue, orchard grass, smooth brome, timothy or Kentucky bluegrass.

### EXAMPLES

The present disclosure will now be illustrated in greater detail by reference to the specific embodiments described in the following examples. The examples are intended to be purely illustrative of the disclosure and are not intended to limit its scope in any way.

The examples presents application rates of Boron fertilizer addition either as a liquid or granular form required to achieve invasive species control.

### Example 1. Phytotoxic Effect of Liquid Boron Application

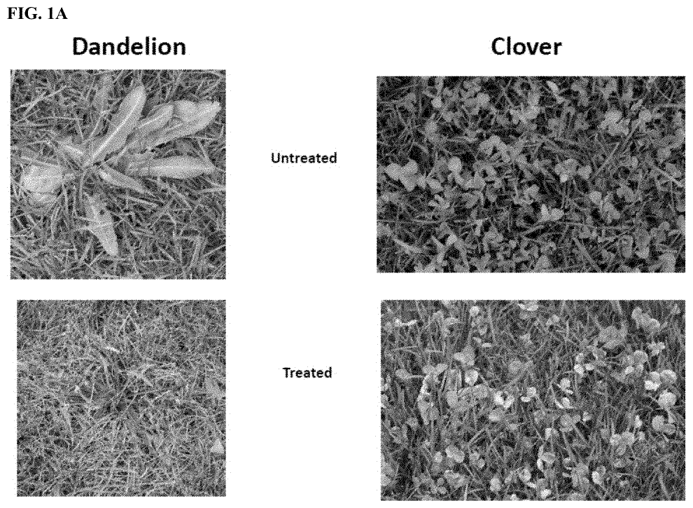

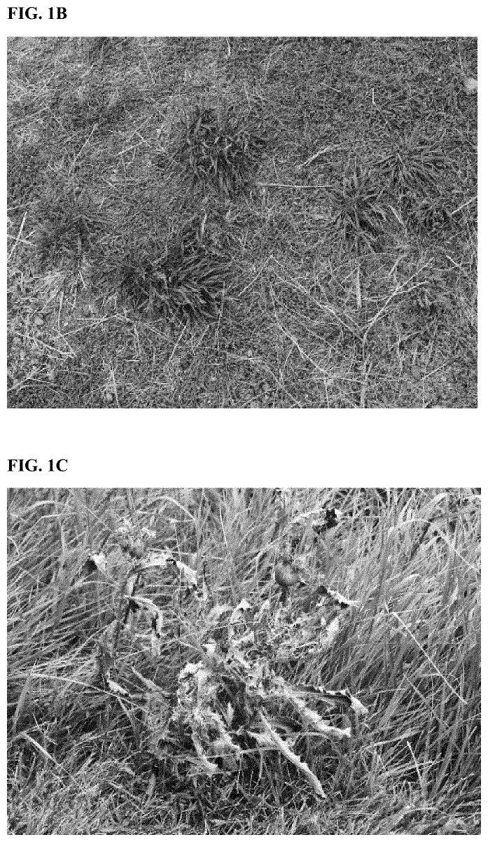

In this example, liquid B1300 product was formulated by dissolving 1300 grams of 20.5% Boron (Solubor®) into 4 gallons of water for a foliar spray to target plants, either with or without ‘drizzle down’ of the liquid into the roots. Also, liquid B1440 product was formulated by dissolving 1440 grams of 20.5% Boron (Solubor®) into 4 gallons of water. Many invasive plants are controlled by B1300 foliar spray as presented in FIGS. 1A-1C or B1440 foliar spray as presented in FIGS. 2A-2C. Annual invasive plant species are easily controlled by phytotoxic nutrient addition since they have to grow from seed every year and have the least reliance on well—developed/extensive root systems and/or taproots that store plant resources. Annual invasive plants also have to grow from near the soil surface every year where it is easiest to add phytotoxic micronutrients and change the soil chemistry to inhibit or control the annual plant's growth. Perennial invasive plants grow every year from the previous years roots and take generally two forms: tap root species and extensive well-developed root systems. In general, it is difficult to control these invasive perennial plants compared to annual plants due to roots with plant resources deep in the soil. The tap root perennial invasive plant species (i.e. dandelion and knapweed) may need root uptake of phytotoxic micronutrients with foliar liquid application for complete control as presented in FIG. 1A. Conversely, the deep/extensive root system species (i.e. Canadian thistle) seem to be well-controlled by foliar micronutrient solutions (e.g. B1300 as presented in FIGS. 1C and 4B, or B1440 as presented in 2C) that may or may not include a root irrigation component.

The selective control of invasive plant species growing intermixed with desirable perennial grass species by phytotoxic micronutrient compounds can be accomplished by liquid boron fertilizer application. Weed encroachment into perennial grass communities commonly occurs in turf, rangeland, natural areas and pasture settings. Using the disclosure disclosed herein the invasive species can be controlled or otherwise diminished or reduced by application of liquid boron fertilizer of various concentrations and at varying application rates all leading to phytotoxic outcomes for the invasive plant species. The maximum amount of boron (B) that can be dissolved into an aqueous water solution varies with water temperature. A convenient way to dissolve B into solution is through the use of 20.5% sodium borate (Na₂B₈O₁₃.4H₂O). A high boron solution concentration uses 86 grams of 20.5% B (17.6 g elemental boron) when dissolved into cold water per liter. Higher amounts can be dissolved in warmer water, but the solution described above (B1300) can be used effectively for control of invasive plant species. The B1300 foliar spray described above may be applied in low amounts where root uptake is minimal, but some amount of root uptake is likely in all application through the drizzle down of the solution onto the soil and into the roots. The best control of invasive plants may occur through the combined effect of foliar nutrient uptake through the leaves and stems and root uptake of the liquid solution from the soil.

Invasive plant families controlled by the method disclosed herein include annual grasses (i.e. Bromus tectorum and others), perennial forbs (i.e. broadleaf weeds such as dandelion (Taraxacum officiniale) and Canadian thistle (Circium arvense and others) and annual forbs (i.e. members of the spurge, mustard, pigweed and other families). Most species considered to be invasive that are not perennial grasses can be controlled by this method, but a list of the species tested is presented in Tables 1 and 2. Fertilizer may be applied by any spray method to achieve uniform distribution on the plant leaf tissue and/or soil surface. Surfactant may be used in the B1300 to aid in uniform cover of leaf tissue and marker dye may be used in the solution to show where spray has been applied. These adjuvants aid in the delivery of the phytotoxic micronutrient liquid solutions to the invasive plants but are not efficacious independently.

Then, multiple plots were installed in weedy turf for liquid boron fertilizer application. The plots listed in Table 4 were used for varying application rates of B1300 where the amount of liquid applied to each plot varied. The sprayer was weighed before and after each application and the application rate determined by calculation knowing the concentration of B1300 liquid applied. The results of foliar liquid applied in controlling invasive species is reported in FIG. 3 and compared to an untreated control. As presented in FIG. 3, the plots were monitored 1 month, 8 months and 10 months after four different application rates of liquid B1300 (47 pounds B/acre, 62 pounds B/acre, 75 pounds B/acre, and 93 pounds B/acre), which show the effectiveness of each rate in limiting the growth of invasive plant species. The weedy plants controlled included dandelion (Taraxacum officiniale), oxeye daisy (Chrysanthemum leucanthemum), black medic (Medicago lupulina), Canadian thistle (Circium arvense), and white clover (Trifolium repens). The desirable perennial grasses that were unharmed or stimulated included Kentucky bluegrass (Poa pratensis) and smooth brome (Bromus inermis). The effectiveness of relevant commercial products targeting control of invasive plant species are shown in FIG. 5C and include glyphosate, Natria FeHEDTA and 2-4 D.

Spot spraying of individual invasive weed plants with the B1300 formulation has been performed to assess the species-specific response to foliar micronutrient sprays. A list of invasive species affected, controlled or harmed by foliar spray B1300 is reported in Tables 1 and 2. Exemplary figures of invasive plant species controlled by phytotoxic micronutrients are shown in FIGS. 4A-4L.

Related to the methodology of invasive species control using phytotoxic micronutrient compounds, additional application strategy is required for the seasonality of plant growth and recognition of whether the plant is an annual, biennial or perennial weed. Annual weeds must grow to maturity each year and produce seeds to perpetuate the next generation of plants. As a result, annual plants are most susceptible to phytotoxic micronutrient compounds when plants are young and actively extracting nutrients from the soil. Commonly this condition occurs in the springtime, while some annuals may germinate in the fall of the year such as cheatgrass. The preferred time to apply phytotoxic micronutrients to annual weeds by granular products is in advance of seedling germination, typically in the early fall in North America. In environments absent of frozen ground, granular products can be applied throughout the winter and into the early spring as annual weed seeds germinate and establish. Likewise foliar phytotoxic micronutrient solutions can be applied to the young, growing annual weed leaf tissue in the fall or early spring. Efficacy of both granular and foliar application to mature annual weeds is less effective because plants of this age class have largely grown to maturity and produced seed. The preferred time to apply phytotoxic micronutrient compounds as either granular or foliar products to perennial weeds is in the late summer and fall as perennial plants recharge taproots or extensive underground root systems with nutrients and carbohydrates to support growth at the beginning of the following year. Transport of phytotoxic micronutrients into the root system by either foliar or root uptake is desired. Application of phytotoxic micronutrient compounds to perennial invasive plant species in the early or mid-summer timeframe can occur, but often will require reapplication later in the season. For example, Canadian thistle (Circium arvense) is a widespread invasive plant species that is negatively affected by foliar spray of phytotoxic micronutrient compounds. When perennial forb Canadian thistle is treated in the early summer with foliar B1300, the plant leaves and stem will often turn brown suggesting a phytotoxic response, yet within a short period of time the plant roots may establish new healthy stems in the immediate vicinity since resources are flowing from the roots to the shoots. Conversely, after the Canadian thistle flowers plant resources run in reverse from the leaves to the roots and provide a preferred foliar micronutrient spray opportunity. Biennial plants present a similar plant physiology opportunity for invasive species control when the plant should be sprayed in the first growing season when it is a rosette or young leaf tissue exists or the soil should be treated with granular phytotoxic micronutrient compounds prior to the second growing season when the biennial plant would grow to maturity absent of phytotoxic micronutrients in the soil. Applying granular or foliar phytotoxic micronutrients in the second growing season of the plant's lifecycle, likewise, is less successful. An example of a biennial invasive plant species is Houndstongue (Cynoglossum officinale) with grows from seed and flowers in the second growing season. Treatment of the invasive biennial plant species is more efficacious in the first growing season and prior to flowering.

Vines, trees and shrubs may or may not have a waxy leaf coating on the plant cuticle. The cuticle serves to prevent excess moisture loss from the leaves and to prevent entry of foreign material and plant diseases into the tissue. The entry of phytotoxic micronutrient compounds into the leaf may or may not be retarded by the cuticle coating. For example, in the instance of aspen (Populus tremuloides) trees, they reproduce aggressively by root sprouts that may occur in turf as a weed. Spray of phytotoxic micronutrient solutions such as B1300 on the leaf tissue has limited effect due to the protective cuticle, however if the sprouts are mowed in turf and the cuticle damaged by the mower blades exposing unprotected leaf tissue the leaves become vulnerable to foliar spray control. Likewise, excess application of foliar micronutrient solutions confers additional treatment effect when the excess liquid infiltrates into the soil and is taken up by the roots. Root sprouts or suckers may be controlled in turf by this method, yet without causing death of the parent tree. Small tree seedings and saplings lacking extensive root systems may experience phytotoxic responses to micronutrient solutions when soil irrigation occurs and a sufficient dose is delivered to the small plants. For invasive trees that reproduce primarily by seed (e.g. common buckthorn) a carpet of small seedlings may form underneath a parent tree from seeds dropped to the ground.

Table 4 lists the tested plots with various treatment using granular and/or liquid boron formulations alone, or in combination with another micronutrient Cu and/or macronutrients including N, P, K. FIG. 3 and FIGS. 5A-5E represent phytotoxicity effect on weed control by investigating coverage after the desired treatments from the test plots listed in Table 4. Also, FIGS. 9A-9D to FIGS. 25A-25D present actual vegetation conditions of each plot after the desired treatment described in Table 4.

### Example 2. Phytotoxic Effect of Granular and/or Liquid Boron Plus Nitrogen (B+N)

Granular and/or liquid Boron+Nitrogen (B+N) treatment have been tested for several years. After application of Boron to control invasive plant species in turf grass, the initial applications of Nitrogen occurred with the objective of restoring the vigor of yellowing turf grass that was under a stress condition. Granular and/or liquid Nitrogen fertilizers were applied several weeks following granular and/or liquid Boron application. Since all grasses have high N requirements, the N addition was successful in restoring the vigor of grasses. Surprisingly, the N addition to the previously B treated weedy turf showed additional efficacy in controlling invasive plants (e.g. clover). Also Cu+N and Zn+N showed improved clover control compared to Cu and Zn alone. B+N treatment can be added simultaneously (granular) to both (i) reduce turf grass stress from B treatment and (ii) control invasive turf weeds by B treatment. This simultaneous B+N can create a ‘push-pull’ effect in the soil where the desirable plant is stimulated (pushed ahead) and the invasive species is inhibited (pulled back). This simultaneous B+N treatment could be different in its effect when compared to sequential B+N treatment, that is B application first followed by N application weeks later after the turf stress has been observed. Essentially no turf stress is observed with B+N simultaneous application with granular formulation. On the other hand, B+N simultaneous application with liquid formulation as a spot spray for weeds in turf also produced good results like the granular B+N application.

TABLE 4
Effect of Boron (B) and Nitrogen (N) treatment on vegetation

| | | | | | Perennial Grass | | | Forbs (Weeds) | | |
|---|---|---|---|---|---|---|---|---|---|---|
| Plot | | Fertilizer | Boron | Nitrogen | 8 months | 10 months | 12 months | 8 months | 10 months | 12 months |
| No. | Treatment | type | (lbs/acre) | (lbs/acre) | (%) | (%) | (%) | (%) | (%) | (%) |
| 31 | Foliar Cu, N+B 60/60 | Both | 60 | 60 | 92 | 98 | 100 | 3 | 2 | 0 |
| 11 | B1300-0.60 rate | Foliar | 93 | 0 | 50 | 80 | 99 | 0 | 0 | 1 |
| 5 | N+B 60/75 | Granular | 75 | 60 | 78 | 91 | 97 | 0 | 0 | 3 |
| 3 | B at 100 lbs/ac | Granular | 100 | 0 | 60 | 91 | 96 | 7 | 5 | 4 |
| 30 | N+B 60/75 (Spring) | Granular | 75 | 60 | 67 | 73 | 96 | 28 | 27 | 4 |
| 4 | N+B 60/100 | Granular | 100 | 60 | 80 | 92 | 96 | 0 | 0 | 4 |
| 2 | B at 50 lbs/ac | Granular | 50 | 0 | 77 | 65 | 88 | 18 | 35 | 12 |
| 9 | B1300-0.48 rate | Foliar | 75 | 0 | 50 | 85 | 85 | 1 | 5 | 15 |
| 7 | B1300-0.30 rate | Foliar | 47 | 0 | 80 | 90 | 80 | 3 | 10 | 20 |
| 13 | B1300+NPK-0.60 rate | Foliar | 47 | 104 | 80 | 50 | 80 | 10 | 50 | 20 |
| 22 | 2-4D (S) | Foliar | 0 | 0 | 90 | 85 | 78 | 5 | 15 | 22 |
| 24 | control | None | 0 | 0 | 35 | 45 | 72 | 60 | 55 | 28 |
| 23 | N+B 700/700 | Foliar | 20 | 44 | 60 | 35 | 68 | 36 | 65 | 32 |
| 1 | N at 60 lbs/ac | Granular | 0 | 60 | 60 | 38 | 67 | 40 | 62 | 33 |
| 12 | B1300+NPK-0.29 rate | Foliar | 23 | 50 | 60 | 50 | 65 | 35 | 50 | 35 |
| 32 | Foliar Cu only | Foliar | 0 | 0 | 53 | 65 | 62 | 10 | 35 | 38 |
| 20 | Fe EDTA Natria | Foliar | 0 | 0 | 63 | 52 | 60 | 37 | 48 | 40 |
| 6 | Glyphosate (S) | Foliar | 0 | 0 | 0 | 0 | 0 | 10 | 95 | 90 |

| | | | | | 8-12 month | 8-12 month | Vegetation |
|---|---|---|---|---|---|---|---|
| Plot | | Fertilizer | Boron | Nitrogen | average grass | average weed | Ranking |
| No. | Treatment | type | (lbs/acre) | (lbs/acre) | cover (%) | cover (%) | Index* |
| 31 | Foliar Cu, N+B 60/60 | Both | 60 | 60 | 97 | 2 | 57 |
| 11 | B1300-0.60 rate | Foliar | 93 | 0 | 76 | 0 | 55 |
| 5 | N+B 60/75 | Granular | 75 | 60 | 89 | 1 | 51 |
| 3 | B at 100 lbs/ac | Granular | 100 | 0 | 82 | 5 | 49 |
| 30 | N+B 60/75 (Spring) | Granular | 75 | 60 | 79 | 20 | 49 |
| 4 | N+B 60/100 | Granular | 100 | 60 | 89 | 1 | 49 |
| 2 | B at 50 lbs/ac | Granular | 50 | 0 | 77 | 22 | 33 |
| 9 | B1300-0.48 rate | Foliar | 75 | 0 | 73 | 7 | 27 |
| 7 | B1300-0.30 rate | Foliar | 47 | 0 | 83 | 11 | 17 |
| 13 | B1300+NPK-0.60 rate | Foliar | 47 | 104 | 70 | 27 | 17 |
| 22 | 2-4D (S) | Foliar | 0 | 0 | 84 | 14 | 13 |
| 24 | control | None | 0 | 0 | 51 | 48 | 0 |
| 23 | N+B 700/700 | Foliar | 20 | 44 | 54 | 44 | −7 |
| 1 | N at 60 lbs/ac | Granular | 0 | 60 | 55 | 45 | −10 |
| 12 | B1300+NPK-0.29 rate | Foliar | 23 | 50 | 58 | 40 | −13 |
| 32 | Foliar Cu only | Foliar | 0 | 0 | 60 | 28 | −20 |
| 20 | Fe EDTA Natria | Foliar | 0 | 0 | 58 | 42 | −23 |
| 6 | Glyphosate (S) | Foliar | 0 | 0 | 0 | 65 | −133 |

*Vegetation Ranking index: Calculated by multiplying healthy perennial grass cover by 3.5 subtracting 2.5 times the amount of stressed/unhealthy grass minus weed cover

The selective control of invasive plant species growing intermixed with desirable perennial grass species by phytotoxic micronutrient compounds can be accomplished by dry granular boron fertilizer application. Weed encroachment into perennial grass communities commonly occurs in turf, rangeland, natural areas and pasture settings. Using the disclosure disclosed herein the invasive species may be controlled or otherwise diminished or reduced by application of dry granular boron fertilizer commonly 10-30% boron by weight. Applying 100-300 pounds of boron fertilizer with a purity of 15% boron results in a net application of 15-45 pounds of boron per acre. Invasive plant families controlled by this method include annual grasses (i.e. Bromus tectorum and others), perennial forbs (i.e. broadleaf weeds such as dandelion (Taraxacum officiniale) and Canadian thistle (Circium arvense and others) and annual forbs (i.e. members of the spurge, mustard, pigweed and other families). Most species considered to be invasive that are not perennial grasses may be controlled by this method, but a complete list is not known. A list of invasive plant species known to be affected by phytotoxic micronutrient compounds is provided in Tables 1 and 2, yet it is noted that the list is incomplete since many invasive species are known and not all have been tested. Dry granular fertilizer may be spread by any method to achieve uniform distribution on the soil surface prior to dissolution by rainfall, snowmelt or irrigation.

The results of dry granular boron fertilizer application to turf grass laden with invasive species is shown in FIG. 5A. In this example the fertilizer was applied to weedy turf grass in September with approximately 50% invasive plant cover and then monitored again one, eight and ten months after initial application. At this North American field site snow covered the ground from approximately December through March. The weedy plants controlled included dandelion (Taraxacum officiniale), oxeye daisy (Chrysanthemum leucanthemum), black medic (Medicago lupulina), Canadian thistle (Circium arvense), and white clover (Trifolium repens). The desirable perennial grasses that were unharmed or stimulated included Kentucky bluegrass (Poa pratensis) and smooth brome (Bromus inermis). The trend in perennial grass cover is shown in FIG. 5B. Perennial grasses were unharmed and/or stimulated at the 50 pounds/acre of the granular boron treatment. Smooth brome became the dominant grass species at the highest application rate of 100 pounds per acre of the granular boron treatment, suggesting higher tolerance of the applied boron.

When comparing the granular boron application disclosed herein to conventional approaches (i.e. commercial herbicides such as glyphosate, Natria's FeHEDTA, and 2-4 D) to control of invasive weeds, FIG. 5C shows the performance of the 100 pound per acre of granular boron treatment compared to glyphosate, Natria's FeHEDTA, 2-4 D and the untreated control. Glyphosate (a.k.a Roundup®) is the world's leading herbicide, which is non-selective. Natria's FeHEDTA is a non-synthetic innovative broadleaf herbicide marketed by Bayer and represents the best known non-synthetic broadleaf herbicide in the market. The dominant broadleaf herbicide used in turf applications in the U.S. is 2-4 D (2,4-Dichlorophenoxyacetic acid) which has been commercially available for decades and is used in 1500 different commercial herbicide products.

Of the dry granular boron treatments, the highest rate of 100 pounds per acre was superior to the 50 pound per acre rate in controlling invasive plant species (FIG. 5A), as well as in maintaining and/or improving perennial grass (FIG. 5B).

However, at both the 50 and 100 pound per acre of the granular boron application rate, stressed condition was observed in the perennial grasses through yellowing or chlorosis and finer turf grasses, such as Kentucky bluegrass, which diminished while wider blade (coarser) pasture grasses such as smooth brome tended to increase. To diminish turf stress and maintain control of invasive plant species, formulations of boron and nitrogen (B+N) were added in trials (FIG. 5D). In the B+N treatment, 75 pounds of boron per acre and 60 pounds of nitrogen per acre were applied to the test plots. The treatment was superior to both 50 and 100 pounds of boron per acre alone in terms of invasive plant control and minimizing stress to perennial grasses (FIG. 5D). The desirable rates in FIG. 5D appear to be about 60-75 pound B per acre range with about 60-75 pounds of nitrogen fertilizer.

Recognizing the superior performance of B+N granular B+N implemented in Fall, the same granular treatment was repeated in Spring to show the efficacy of a springtime application. The Fall and Spring applications are shown in FIG. 5E. In addition to the seasonal comparison of B+N, another additional treatment variant was added in application of foliar copper spray, also shown in FIG. 5E. The B+N treatment plus foliar copper was implemented and compared to granular B+N alone and foliar copper alone. The foliar copper treatment is very fast acting on invasive broadleaf weeds and can often negatively impact the leaf tissue within 48 hours of application. The granular B+N implemented in the fall showed the best efficacy compared to spring application, however the granular B+N supplemented with foliar copper showed excellent spring application results. The spring B+N treatment with added copper can be another intended practice of the present disclosure since much of the emphasis on weed control occurs early in the growing season. However, the fall application timeframe shows excellent control without added foliar copper.

The granular and/or liquid Boron Plus Nitrogen (B+N) treatment as well as a single boron treatment can be applied to control growth of weeds and/or invasive plant species related to a cropping system in a cultivated land where grains and field crops grows, such as (i) cereals: Triticum aestivum (wheat), Hordeum vulgare (Barley), Avena sativa (Oat), Secale cereale (Rye), Triticosecale spp. (Triticale), Zea mays (Maize, Corn), Sorghum spp. (Forage, Grain and Broomcorn), Digitaria, Echinochloa, Eleusine, Panicum, Setaria, Pennisetum, spp. (Various Millets), Phalaris canariensis (Canary Seed), Oryza, Zizania, spp. (Rice), Eragrostis Poa) abyssinica (Teff), Coix lacryma-jobi (Job's Tears), (ii) Oilseeds: Glycine spp. (Soybean), Arachis hypogaea (Peanut), Brassica spp. (Canola, Mustard), Helianthus annuus (Sunflower), Carthamus spp. (Safflower), Linum spp. (Flax), (iii) Pulses: Phaseolus vulgaris (Navy Beans, Dark and Light Red Kidney Beans, Black Beans, Cranberry, Brown, Yellow Eye), Pink and Small Red Pinto Beans), Phaseolus lunatus (Lima Bean), Phaseolus mung (Mungo Bean), Phaseolus angularis (Adzuki Bean), Cicer arietinum (Chickpea), Pisum spp. (Field, Green and Yellow Peas), Lens spp. (Lentil), Vicia faba (Faba Bean), Dolichos, Cajanus, Vigna, Pachyrhizus, Tetragonolobus, spp. (Others), (iv) Hay and Pasture: 1) Grasses, lopecurus pratensis (Meadow Foxtail), Bromus spp. (Brome), Dactylis glomerata (Orchard Grass), Festuca spp. (Fescue), Lolium spp. (Rye Grass Annual and Perennial), Phalaris arundinacea (Reed Canary Grass), Poa pratensis (Kentucky Blue Grass), Phleum pratense (Timothy), Agropyron spp. (Redtop), and 2) Legumes: Medicago spp. (Alfalfa, Yellow Trefoil), Trifolium spp. (White, Red and Alsike Clovers), Lotus corniculatus (Birdsfoot Trefoil), Vicia spp. (Vetch), (v) Others: Fagopyrum esculentum (Buckwheat), Nicotiana tabacum (Tobacco), Cannabis sativa (Hemp), Beta vulgaris var. altissima (Sugar Beet). Also, B+N treatment descried above with foliar Cu may have importance in cropping systems.

Furthermore, FIG. 6 presents B1300 at 47 pounds per acre, compared to B1300+NPK at 47 pounds per acre where the added NPK results in the more rapid return of weeds. The benefit is that the added NPK results in less turf stress. It is suggested that the added NPK and B treatment can be better applied to control weeds with perennial grasses well protected when using granular methods. On the other hand, the foliar B and B+N will be beneficial for spot applications. The B1300 alone applied as a spot spray to turf weeds is efficacious in controlling weeds but results in stressed yellow turf polka dots. Thus, B+N has less turf stress comparatively as a spot spray.

From the tested plots, plot no. 12 (FIGS. 18A-18D) showed optimum amounts of foliar B plus N for controlling invasive plants through 8 months after treatment. Also, plot Nos. 4 (FIGS. 11A-11D) and 5 (FIGS. 12B-12D) using B+N combination treatment also showed similarly excellent vegetation responses however persisting into 10 months post-treatment.

### Example 3. High Application Rates of Micronutrients for Non-Selective Phytotoxicity

Within the grass family, there is variation in sensitivity to increasing concentrations of phytotoxic micronutrients. From-least-to-most-sensitive invasive plant species would include range from fescues (most sensitive) to blue grass (turf), to pasture grasses like smooth brome to hardly rangeland plants like Western wheatgrass that would be least sensitive to increasing boron. The range of B treatment associated with the grasses starts at around 50 pounds B/acre and extends into the 200 pounds B/acre range. The grasses with the finest leaf blades seem to be most sensitive.

The severe restriction of growth of all plant species, including grasses, by application of high rates of phytotoxic micronutrients can be accomplished by resulting in non-selective phytotoxicity (NSP). Each plant has a unique sensitivity to each micronutrient and increasing amounts may exceed beneficial amounts leading to toxicity and NSP. The utility of non-selective control of all plants has been shown by glyphosate where the presence of any vegetation is undesirable for the reason of vegetation management. While glyphosate is a synthetic formulation, NSP can be accomplished by non-synthetic micronutrient treatment, either in granular or liquid form. The effects may be long-lasting since the soil may retain the phytotoxic signature of added micronutrients for an extended duration as controlled by application rates, rainfall and soil characteristics such as texture, organic matter content and cation exchange capacity.

The foliar and granular control of invasive plant species described in this disclosure shows that invasive plant species are generally controlled or experience phytotoxic responses due to addition of micronutrient fertilizers and especially boron. Many common invasive plant species are controlled by Boron levels less than 50 pounds of boron per acre and boron measured in soil and ranged up to 50 mg/L of boron in the soil solution. The data described in Examples 1 and 2 show higher boron application with the assumption that the soil levels are in the same range of up to 50 mg/L of boron in the soil solution. The exact amount of soil solution micronutrient will vary depending on the soil water content, texture, pH, water holding capacity, etc. There are 1 million pounds of soil in an acre 3 inches deep, which is the primary target of micronutrient addition, thereby adding one pound per acre is essentially one part-per-million. The perennial grass species are stimulated or unharmed by modest amounts of Boron fertilization such as 50 pounds boron per acre. With increasing micronutrient concentrations, sensitive grasses experience phytotoxicity such as the response shown by Kentucky bluegrass at 100 pounds Boron per acre. At higher rates only extremely boron tolerant plants will survive such as salt grass and salt bush. In a laboratory setting, native perennial grasses and the forb silky lupine were grown in solutions of varying boron concentration (Munshower et al. 2006) along with salt tolerant shrubs. The resulting survival, plant height, plant weight, tissue boron concentration and injury index were measured and the results are presented in FIG. 7. An overall performance index was calculated by compiling the survival, plant height and plant health (injury) measurements (FIG. 8).

In performing field research to confirm the NSP of common rangeland plants, liquid and granular fertilizer were applied at high rates to demonstrate the feasibility of accomplishing a bare ground outcome. Since forbs are more sensitive to added boron than grasses, the emphasis was on NSP effects to grasses. Liquid rates were not quantified, however granular rates of 40-160 pounds of B/acre were applied to test plots to assess whether phytotoxic responses were observed. After three growing seasons, the NSP effect was still evident at the 160 lbs B/acre rate.

FIGS. 26A-26C show the NSP effect of liquid B1300 formulation sprayed to plant species including turf grasses and knotweeds, which were used as examples. The high rate/concentration of liquid B1300 resulted in the Roundup-like NSP outcome. Also, FIG. 26C presents that B1300 even worked faster to kill knotweeds than the Roundup®.

In an earlier test, the same plots were put out 3 hours before a heavy rain (˜1.0″). In the rain affected test (not shown), the Roundup was highly effective but not the B1300 formulation. This indicates that the micronutrient boron was washed off the leaf surfaces into the soil, but the washed boron in the soil was not at sufficient levels to cause injury/phytotoxicity to the plants.

FIG. 27 illustrates healthy perennial grass coverage in plot Nos. 7, 8, 9, 11, 21 (Table 4) by foliar application, which shows the decline in healthy grass with increasing rates of foliar B treatment. At some point all plants can be harmed through application of increasing amounts of boron, either as a foliar liquid or as a granular fertilizer. FIG. 27 and Table 4 indicate that a foliar rate of ˜128 pounds B per acre can harm even the hardiest grasses. Granular limits (not shown) appear to be similar. Weeds are dead within the range of points shown. The point at 128 pounds B/acre is essentially vegetation glyphosate outcome, that is NSP. FIG. 28 also displays the NSP outcome from a hypothetical modeled application rate of 128 pounds B/acre using liquid B1300 treatment where differential responses to increasing concentration are shown by cheatgrass, dandelion and perennial grasses. For example, an application of 20 pounds boron per acre would eliminate cheatgrass and be harmful to 40% of dandelion plants but only 15% of perennial grass plants. An application rate of 60 pounds per acre would eliminate both cheatgrass and dandelion but only be harmful to 50% of perennial grasses.

### Example 4. Efficacy of Phytotoxic Response to Invasive Plant Species by Delivery Methods

In terms of efficacy of phytotoxic responses to invasive plant species, the method of delivery of phytotoxic micronutrient solutions to the plant is potentially most effective when applied to the leaf tissue compared to root uptake. Dry granular fertilizer applied to the soil surface may be the longest lasting approach of changing soil chemistry to support later successional desirable species, but applications of granular fertilizer to the soil are subject to significant dilution. One acre of dry soil 3 inches deep weighs approximately one million pounds and the soil water content contained may commonly be in the range of 20% water or 200,000 pounds of water (27,000 gallons). Addition of 4 pounds of fertilizer per acre with a purity of 25% would result in one pound of elemental nutrients added per million pounds of dry soil (˜1 ppm) dry weight basis. Root uptake of the element would therefore be subject to dissolution of the granular fertilizer by rainfall or irrigation and uptake by the roots. Converting this to a boron equivalent, effective control of many invasive species occurs with an application of 350 pounds of 14.3% pure boron fertilizer resulting in 50 pounds of elemental B added to the soil. Using the assumption from above the 50 pounds of elemental B would be dissolved into 200,000 pounds of water or 27,000 gallons or 100,000 liters based on the one-acre 3 inch deep assumption. Fifty pounds of B is the equivalent of 22.7 kg or 22,700 grams per acre or 224 mg/L once dissolved in solution. This would be a maximum concentration possible. Field monitoring 6 months after application suggest levels are about 10% of the maximum or 22 mg/L after dissolution, leaching, plant uptake and related soil processes. In comparison, the foliar application of B1300 (1300 grams of 20.5% B fertilizer dissolved in 4 gallons of water) is equivalent to a solution concentration of 17 grams per liter or 17,600 mg/L. A comparison of granular and foliar B application to the plant is shown in Table 5.

TABLE 5
Phytotoxic control of invasive plant species by boron
addition, a comparison of solutions strength.

| | | | Liquid | Speed of phytotoxic |
|---|---|---|---|---|
| Boron | Name of | | concentration | effect on invasive |
| application type | product | Plant uptake target | (approximate) | plant species |
| Granular | B50 | Roots | 20-220 mg/L in | Slow |
| (phytotoxicity | | | soil solution | (days/weeks/months) |
| through root | | | | Long term effect |
| uptake) | | | | |
| Foliar | B1300 | Shoots (roots at high | 17,600 mg/L | Fast (hours/days) |
| (phytotoxicity | | application rates where | | Short term effect |
| through shoot | | ‘drizzle down’ of | | |
| uptake and root | | solution occurs) | | |
| uptake at high | | | | |
| application rates) | | | | |

The concentration of the foliar spray is clearly much higher than the root uptake of boron through dissolution of the granular fertilizer primarily due to the comparatively large volume of water comprising the soil solution in the upper 3 inches of soil (˜100,000 L). In contrast, the amount of liquid added by B1300 is 88 gallons/acre (334 L/acre). Comparing the amount of B added per acre as elemental B by two methods, the granular B50 method adds 50 pounds per acre while the B1300 adds 13 pounds per acre. In field observations the granular B50 appears to be longer lasting compared to the foliar B1300, potentially due to higher application rate. However as noted above the foliar application is faster acting on invasive plant species. Also the B1300 foliar application induces higher stress in desirable species such as perennial grasses compared to the granular application. The granular application stress to perennial grasses is further reduced by co-application with nitrogen in the B+N formulation as previously described.

### Example 5. Control of Invasive Weeds in Coffee Plantations

Coffee is produced in tropical latitudes and in the U.S., much of the coffee production occurs on the island of Hawaii where volcanic soils provide superior growing conditions for premium coffee such as Kona Coffee. It is one of the most expensive coffees in the world. One of the unique ecological problems observed in Hawaii has been the invasion of non-native birds, mammals and especially plants. Much of the island has been colonized by plant species from around the world and coffee producers are challenged to control diverse and aggressive invasive plants in the understory of the region's coffee plantations. Glyphosate has been used as the primary method used to control invasive plants, but consumers are demanding making a change to non-synthetic ‘organic’ methods of coffee production. Wholesale coffee buyers are even performing chemical analysis of coffee beans to confirm the absence of trace residues of herbicides and pesticides. Coffee producers are anxious to find alternative methods of managing invasive plants.

Invasive plants grow where soils provide the edaphic conditions conducive to establishment, growth, maturation and reproduction. Weedy species thrive on the island of Hawaii due to the favorable climate and nutrient depleted soil. Nitrogen fertilizers added to stimulate the growth of coffee plants further exacerbate the invasive plant problem by stimulating their growth. The compositions and methods of the present invention aid in restoring soil health by emphasizing micronutrient fertilization based on the discoveries reported on herein that invasive plant species are intolerant of the elevated micronutrient levels associated with healthy undisturbed soil. In the acidic soils of Hawaii, many essential micronutrients are naturally plant available such as iron, manganese, molybdenum, copper and zinc. Boron is often deficient. Boron is also an important micronutrient in the growth of coffee and adequate soil boron levels have been shown herein to limit the invasion of weedy species.

To mutually promote the growth of coffee and create healthy soil, dry granular boron will be applied at a rate of 100 to 300 pounds per acre of 14.3% pure fertilizer resulting in 14.3 to 42.9 elemental pounds of boron per acre. Invasive species would be discouraged or inhibited or disrupted while coffee plants would be beneficially fertilized. Boron slowly dissolves in response to rainfall and will be taken up by plant roots at trace concentrations.

Optionally, residual invasive plants could be sprayed with foliar boron solution prepared using 20.5% dry powdered fertilizer mixed at an application rate 86 grams of dry fertilizer per liter of water resulting in a solution concentration of 17.6 grams boron per liter. The resulting solution could be applied as a spot spray to individual invasive plants as a foliar leaf spray or could be delivered to field scale as a liquid fertilizer by applying 59 to 509 gallons per acre resulting in 8.7 to 75 pounds elemental boron per acre. Lower application rates would be preferred for healthy soils where prevention of invasion was emphasized and higher application rates would be prescribed for infestations of invasive plants where soils were highly depleted of boron. The outcome of the treatment described would be healthy coffee plants without trace residues of herbicides and healthy soil inhibitory to colonization by invasive plants.

### Example 6. Wild Horse Island Annual Grass Control Research

Wild Horse Island is the largest island on Flathead Lake, the largest freshwater lake in Montana. Wild Horse Island is well known for its iconic bighorn sheep population and as a tourist destination at Flathead Lake. Less well known is the health of rangeland on the island and in particular the trend in annual grass cover. This research was initiated by Montana Fish Wildlife and Parks (FWP) and Wild Sheep Foundation (WSF) to explore the applicability of innovative treatments for control of annual grasses (i.e. cheatgrass) using non-synthetic micronutrient formulations to reduce the cover of undesirable species and improve grazing conditions on the island.

A field assessment of annual grasses on Wild Horse Island was conducted in July and research sites were selected based on habitats of concern for annual grass colonization. Three different habitat types were identified for this study. A ‘Disturbed’ site was selected where previous land use as a homestead led to heavy colonization by annual grasses. The ‘Eagle Cove’ site is a south-facing slope dominated by native forbs (primarily Arrowleaf balsamroot) and thin soils where annual grasses have become well established. The ‘Ponderosa Pine’ site is highest in elevation and dominated by rough fescue in the understory of an open ponderosa pine community with low levels of annual grasses.

Experimental design. At each of the three sites (Disturbed, Eagle Cove and Ponderosa Pine), four 1600 square foot plots were established in September by marking the corners of each plot with wooden stakes. The plots were sited adjacent to each other at a location representative of the entire site and the treatment applied to each site was randomly selected. The four treatments were: 1) an untreated control (‘Baseline’ or “control”); 2) a high fertilizer application rate at 75 pounds Boron per acre (‘High’); 3) a medium fertilizer application rate at 50 pounds Boron per acre (‘Medium’); and, 4) a low fertilizer application rate at 25 pounds per acre (‘Low’).

Plot installation. GPS points were collected for the center of each plot. A string line was stretched around the plot perimeter to define the plot boundary. Granular fertilizer was subsequently applied at the rates specified above. The innermost foot of the plot was spread by hand to prevent spreading of the fertilizer outside the plot and to define the plot edge. The remainder of the plot was spread using a broadcast fertilizer spreader. Fertilizer had been previously weighed into Ziploc® bags marked as High/Medium/Low and uniformly spread across each plot in multiple perpendicular passes. Photographs of each plot were collected at the time of application. No supplemental irrigation, fencing, mowing, seeding or related management actions were performed.

Baseline Vegetation Monitoring. Vegetation cover by species was measured in each plot with randomly placed 20×50 cm frames. Eight frames were evaluated in each plot using Daubenmire range measurement protocols. Note that vegetation measurement in September may overestimate the cover of species that may have grown to maturity earlier in the season. In particular, it is difficult to tell annual grasses from the current year from overall decadent plant litter from previous years when the vegetation is senescent and cured out. The vegetation baseline is and will be used subsequently to document the changes within each plot occurring due to treatment. Additional comparisons can also be made comparing the treated plot to the control in subsequent years. At the time of the baseline vegetation assessment, all of the plots represent the pre-treatment conditions.

Results. Vegetation cover was reassessed in June of the following year by the same research team using the same methods (‘Year 1’). Vegetation condition was markedly different during the first monitoring event reflecting the phenology of the plant community and early spring (lush) condition.

TABLE 6
Overall, mean vegetation cover by life form comparing the Baseline
vegetation assessment in September to the first year of monitoring
in June. The Year 1 monitoring data are the grand means of eight
frames per plot × three treatment plots = 24 total frames measured.

| Site Name/ | Annual | Perennial | Desirable |
|---|---|---|---|
| Monitoring Period | Grass (%) | Grass (%) | Forbs (%) |
| Disturbed Site/Baseline | 91* | 3 | 2 |
| Disturbed Site/Year 1 | 5 | 10 | 3 |
| Eagle Cover/Baseline | 18* | 5 | 29 |
| Eagle Cove/Year 1 | 4 | 9 | 31 |
| Ponderosa Pine/Baseline | 7* | 39 | 8 |
| Ponderosa Pine/Year 1 | 2 | 23 | 7 |

*Annual grasses were difficult to tell from plant litter from the previous years in September and are likely overstated to some degree.

As presented in Table 6, annual grass cover was 91% at the Disturbed site in September, 18% at the Eagle Cove site and 7% at the Ponderosa Pine site while the amount of annual grasses present were appreciably reduced following treatment. At the Disturbed site, annual grasses were reduced from 91% to 5% following treatment. At the Eagle Cove site, annual grasses were reduced from 18% to 4% in the treated plots and at the Ponderosa Pine site from 7% to 2%. Concurrent with decrease in annual grasses, perennial grass cover generally increased with the exception of the Ponderosa Pine site where rough fescue was negatively affected in the highest application rate. Desirable (non-weedy) forb cover stayed relatively constant at all sites after treatment. Detailed results for Year 1 monitoring are presented in Table 7.

The date of monitoring for Year 1 was selected to show the annual grasses at their maximum cover during the year, but perhaps was a little too early partly due to the cool, wet spring and partly due to the presence of soft brome that had not grown to maturity. There are three annual grasses present at Wild Horse Island: downy brome (Bromus tectorum), Japanese brome (Bromus Japonicus) and soft brome (Bromus hordeaceous). Both the downy brome and Japanese brome are widespread and well-known annual invaders in the Western U.S., however the soft brome while not uncommon, is less epidemic in its regional distribution. It also appears to be later maturing than the other annual grasses. As are result annual grass cover in September was probably overestimated at a mean of 91% (Disturbed site) due to not being able to split out the preexisting plant litter category; and, annual grass cover was probably overestimated at the same site in June at 45% due to the under-maturity of the soft brome. Regardless, the results show that annual grass cover was reduced sharply by the applied treatments. At the lowest treatment rate at the Disturbed Site annual grasses were 9% cover, a strong improvement over the control at 45%. However, the Medium rate at the same site further reduced annual grasses to 3% while perennial grasses increased to 13%. The High rate was intermediate in effect at the Disturbed site. Desirable forbs were relatively unchanged and weedy forbs were slightly increased compared to the control. At the Eagle Cove site, annual grasses were reduced from 15% in the control plot to the 2-5% range in the treatments. Perennial grass cover was lowest in the control, Baseline plot (2%) and highest in the Medium treatment (15%). Desirable and undesirable forbs were relatively unchanged by treatment. At the Ponderosa Pine site, the control plot had a relatively low amount of annual grasses to begin with at 9% cover and treatment further reduced that to 1-3%. Perennial grasses were reduced from 30% to 16% in the High treatment rate and similarly desirable forbs were reduced in both the Medium and High rates.

TABLE 7
Vegetation cover (N = 8) measured in June showing the effect of treatments at all sites.

| | Site | | | | | | | | | | | |
|---|---|---|---|---|---|---|---|---|---|---|---|---|
| | Disturbed | | | | Eagle Cove | | | | Ponderosa | | | |
| | Low | Medium | High | Control | Low | Medium | High | Control | Low | Medium | High | Control |
| Treatment | (%) | (%) | (%) | (%) | (%) | (%) | (%) | (%) | (%) | (%) | (%) | (%) |
| Annual | 9 | 3 | 5 | 45 | 5 | 2 | 5 | 15 | 3 | 1 | 2 | 9 |
| Grasses | | | | | | | | | | | | |
| Perennial | 9 | 13 | 7 | 5 | 4 | 15 | 9 | 2 | 31 | 23 | 16 | 30 |
| Grasses | | | | | | | | | | | | |
| Forbs | 3 | 5 | 2 | 6 | 22 | 38 | 33 | 30 | 12 | 4 | 4 | 21 |
| (non- | | | | | | | | | | | | |
| weedy) | | | | | | | | | | | | |
| Forbs | 10 | 16 | 14 | 7 | 2 | 1 | 3 | 1 | 1 | 0 | 1 | 3 |
| (weedy) | | | | | | | | | | | | |
| Plant | 58 | 57 | 64 | 35 | 36 | 41 | 43 | 44 | 47 | 67 | 58 | 36 |
| litter | | | | | | | | | | | | |
| Bare | 12 | 6 | 9 | 2 | 33 | 4 | 7 | 9 | 7 | 4 | 19 | 1 |
| ground | | | | | | | | | | | | |

In comparing the responses of the three sites to treatment, these initial observations indicate that both the Disturbed and Eagle Cove sites would benefit from either the Low or Medium applications rates while the High rate provided essentially no incremental additional benefit. The Ponderosa Pine site would benefit from the Low application rate, but both the Medium and High rates suggested undesirable plant community changes would result. In designing a future project it is likely the Ponderosa Pine site would not have been selected for treatment at all since it had <10% cheatgrass in the first place, but the Low rate would have been helpful in reducing the already low amount of annual grasses.

In addition to the reductions in cheatgrass cover through treatment, the improvement in the perennial grass cover is a notable observation as well. It is not known whether the improvement in the perennial grass cover is an ecological ‘release’ of nutrients and soil resources to the perennials once the annuals are gone or whether the nutrients added to inhibit the annual grasses also stimulate growth. Regardless, either the trend is in the right direction at the Disturbed and Eagle Cove sites and in the wrong direction at the Ponderosa pine (rough fescue dominated) site.

The data collected during the initial phases of this on-going project shows the site-specific benefit of reducing annual grass cover through treatment. This result is consistent with the other experimental results provided elsewhere herein. A useful strategy for the control of annual grasses on Wild Horse Island may include aerial application of dry granular fertilizer using a helicopter preferably occurring in the early fall prior to cheatgrass germination. Future monitoring of the research plots will provide more information of the longer-term plant community changes resulting from the treatments.

Unless defined otherwise, all technical and scientific terms herein have the same meaning as commonly understood by one of ordinary skill in the art to which this disclosure belongs. Although any methods and materials, similar or equivalent to those described herein, can be used in the practice or testing of the present disclosure, the preferred methods and materials are described herein.

It is understood that there are other embodiments of the disclosure other than that described herein, which is provided to explain the disclosure to those skilled in the state of the art and should not be construed as limiting the claims made below.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not, be taken as an acknowledgment or any form of suggestion that they constitute valid prior art or form part of the common general knowledge in any country in the world.

### ADDITIONAL REFERENCES

U.S. Pat. No. 6,972,273B2
U.S. Ser. No. 10/182,572B2
Bangsund, D. A., and Leistritz, F. L. 1991. Economic impacts of leafy spurge on grazing lands in the northern Great Plains. NDSU Agriculture Economic Report No. 275-S.
Choi, Jong-Myung, Pak, Chun-Ho, and Lee, Chiwon W., 1996. Micro-nutrient toxicity in French marigold. J. Plant Nut. 19(6): 901-916.
Elliott, G. C. and P. V., Nelson. 1981. Acute boron toxicity in Begonia×hiemalis Schwabenland Red.' Commun. Soil Sci. Plant Annu. 12(8):775-783.
Gogue, G. J. and K. C. Sanderson. 1973. Boron toxicity of Chrysanthemum. HortScience 8:473-475.
Hammer, P. A. and D. A. Bailey. 1987. Poinsettia tolerance of molybdenum. HortScience 22: 1284-1285.
Heap I. 2006. The International Survey of Herbicide Resistant Weeds. Available from URL: http://www.weedscience.com.
Kabata-Pendias, A. and H. Pendias. 2001. Trace Elements in Soils and Plants, Third Edition. CRC Press.
Keren R and Bingham F T 1985 Boron in water, soils, and plants. Adv. Soil Sci. 1,230-276.
Lee, Chiwon W., Choi, Jong-Myung Choi, and Pak, Chun-Ho. 1996. Micronutrient Toxicity in Seed Geranium (Pelargonium×hortorum Bailey). J. Amer. Soc. Hort. Sci. 121(1):77-82.
Marousky, F. J. 1981. Symptomology of fluoride and boron injury in Lilium longiflorum Thunb. J. Amer. Soc. Hort. Sci. 106:341-344.
Maxwell B. D., Roush M. L. and Radosevich S. R. 1990. Predicting the evolution and dynamics of herbicide resistance in weed populations. Weed Technol. 4, 2-13.
Mohammadkhani, N, Servati, M, 2017. Nutrient concentration in wheat and soil under allelopathy treatments. J Plant Res. 131(1):143-155.
Munshower, F. F., D. R. Neuman and M. J. Spry. 2006. Relative Boron Tolerance of Some Western Revegetation Species. Proceedings of the American Society of Mining and Reclamation Annual Meeting. St. Louis, Mo.
Pimentel, D., McNair, S., Janecka, J., Wightman, J., Simmonds, C., O'Connell, C., Wong, E., Russel, L., Zern, J., Aquino, T. and Tsomondo, T. 2001. Economic and environmental threats of alien plant, animal, and microbe invasions. Agriculture, Ecosystems and Environment 84: 1-20
Pimentel, D., Zuniga, R., and Morrison, D. 2005. Update on the environmental and economic costs associated with alien-invasive species in the United States. Ecological Economics. 52: 273-288.
Yamada, T., R. J. Kremer, P. R. de Camargo e Castro, and B. W. Wood. 2009. Glyphosate Interactions with physiology, nutrition, and diseases of plants: Threat to agricultural sustainability? Europ. J. Agron. 31:111-113.
Yang, Y., Tilman, D., Furey, G. et al. 2019. Soil carbon sequestration accelerated by restoration of grassland biodiversity. Nat. Commun 10:718.

1. A method for controlling at least one invasive plant growth in a perennial grass plant community, the method comprising applying
(i) a phytotoxic micronutrient and/or
(ii) an agricultural composition comprising one or more ingredients selected from
a) a micronutrient;
b) a macronutrient;
c) a biological compound or a related carbon-based organic compound;
d) an inorganic compound; or
e) a seed, a seed coating, or a seed inoculant;
wherein the phytotoxic micronutrient is selected from the group consisting of boron, copper, iron, chlorine, manganese, molybdenum and zinc; and
wherein the phytotoxic micronutrient is absorbed systemically by the plant, thereby inducing systemic phytotoxicity in the plant.

2. The method of claim 1, wherein the phytotoxic micronutrient comprises boron.

3. The method of claim 1, wherein the phytotoxic micronutrient is applied at a rate of about 10 pounds to about 150 pounds of elemental boron per one acre.

4. The method of claim 1, wherein the phytotoxic micronutrient is applied at a rate of about 20 pounds to about 100 pounds of elemental boron per one acre.

5. The method of claim 1, wherein the boron in the phytotoxic micronutrient is phytotoxic to the at least one invasive plant species while maintaining or increasing the growth and vigor of the perennial grass.

6. The method of claim 1, wherein the at least one invasive species is listed in Tables 1 and 2.

7. The method of claim 1, wherein the at least one invasive species is selected from the group consisting of cheatgrass, dandelion, Canadian thistle, kochia, knotweed, poison ivy and spotted knapweed.

8. The method of claim 1, wherein said perennial grass plant community comprises bluebunch wheatgrass, Western wheatgrass, slender wheatgrass, Idaho fescue, sheep fescue, orchard grass, smooth brome, timothy or Kentucky bluegrass.

9. The method of claim 1, wherein the micronutrient in the agricultural composition is selected from boron, copper, zinc, iron, manganese, molybdenum, or chlorine.

10. The method of claim 1, wherein the macronutrient in the agricultural composition is selected from nitrogen, phosphorous, or potassium.

11. The method of claim 1, wherein the biological compound and related carbon-based organic compound in the agricultural composition is selected from fungus, spores, bacteria, soluble carbon-based solids or liquids (including sugar), organic matter, mycorrhizae, biochar, hydromulch, hydraulic mulch, waste products such as sawdust, manure, straw, corn stover, shells, hulls, or meal.

12. The method of claim 1, wherein the inorganic compound in the agricultural composition is selected from lime, silica, aluminosilicate, gypsum, or sulfur compound.

13. The method of claim 1, wherein the inorganic compound in the agricultural composition is selected from calcium carbonate, calcium magnesium carbonate, calcium oxide, calcium hydroxide, cementitious waste product, or calcium sulfate.

14. The method of claim 1, wherein the agricultural composition further comprises an organic fertilizer or an inorganic fertilizer.

15. The method of claim 14, wherein the organic fertilizer or the inorganic fertilizer comprises calcium, magnesium, sulfur, carbon, hydrogen or oxygen elements.

16. The method of claim 1, wherein the agricultural composition further comprises an adjuvant.

17. The method of claim 16, wherein the adjuvant is selected from a wetting agent, an activator, a crop oil concentrate, a buffer, a marker dye or a surfactant.

18. The method of claim 1, wherein the phytotoxic micronutrient and the agricultural composition is in a dry formulation.

19. The method of claim 1, wherein the phytotoxic micronutrient and the agricultural composition is in a liquid formulation.

20. The method of claim 1, wherein the phytotoxic micronutrient is in a dry formulation and the agricultural composition is in a liquid formulation.

21. The method of claim 1, wherein the phytotoxic micronutrient is in a liquid formulation and the agricultural composition is in a dry formulation.

22. The method of claim 1, wherein the phytotoxic micronutrient and the agricultural composition are applied simultaneously or sequentially.

23. The method of claim 1, wherein applying the phytotoxic micronutrient and the agricultural composition provides a synergistic effect in controlling the growth of at least one invasive plant, compared to when the phototoxic micronutrient or the agricultural composition is applied alone.

24.-69. (canceled)
